(19) United States
(12) Patent Application Publication
(10) Pub. No.: US 2016/0001187 A1
(43) Pub. Date: Jan. 7, 2016

(54) MULTI-PLATFORM SYSTEM AND METHODS

(71) Applicants: BRYS SEPULVEDA, Gainesville, FL (US); DWAYNE KNIGHT, Gainesville, FL (US); DAVID SLEEPER, Newberry, FL (US); MOSTAFA HAFEZ, Heliopolis (EG); JEREMY STIEGLITZ, Gainesville, FL (US); BRIAN DENAGON, Gainesville, FL (US); JAMES LOGSTON, Gainesville, FL (US); PHILIP ASHER, Gainesville, FL (US)

(72) Inventors: BRYS SEPULVEDA, Gainesville, FL (US); DWAYNE KNIGHT, Gainesville, FL (US); DAVID SLEEPER, Newberry, FL (US); MOSTAFA HAFEZ, Heliopolis (EG); JEREMY STIEGLITZ, Gainesville, FL (US); BRIAN DENAGON, Gainesville, FL (US); JAMES LOGSTON, Gainesville, FL (US); PHILIP ASHER, Gainesville, FL (US)

(73) Assignee: TRENDY ENTERTAINMENT, GAINESVILLE, FL (US)

(21) Appl. No.: 14/751,661

(22) Filed: Jun. 26, 2015

Related U.S. Application Data
(63) Continuation-in-part of application No. 14/750,424, filed on Jun. 25, 2015.
(60) Provisional application No. 62/021,072, filed on Jul. 4, 2014.
(60) Provisional application No. 62/060,128, filed on Oct. 6, 2014.

(51) Int. Cl. A63F 13/87; A63F 13/24; A63F 13/46; A63F 13/77

(52) U.S. Cl. CPC A63F 13/87; A63F 13/77; A63F 13/24; A63F 13/46

(57) ABSTRACT

Examples disclosed herein relate to a system, device, and/or method that utilize a first gaming platform, a second gaming platform, and an interface module which allows for an implementation of a game via the first gaming platform and the second gaming platform.

### CROSS-REFERENCE TO RELATED PATENT APPLICATION

This application claims priority to Provisional Patent Application No. 62/021,072 entitled “CROSS-PLATFORM DIGITAL DISTRIBUTATION AND GAME SERVER HOSTING SYSTEM”, filed on Jul. 4, 2014, and this application claims priority to Provisional Patent Application No. 62/060,128 entitled “INFLUENCE SYSTEM AND METHODS”, filed on Oct. 6, 2014, which are incorporated herein by reference in their entireties.

### BACKGROUND

### Field

The subject matter disclosed herein relates to systems, devices, and/or methods that can be utilized in a multi-platform environment which may allow game play over various platforms.

### BRIEF DESCRIPTION OF THE FIGURES

Non-limiting and non-exhaustive examples will be described with reference to the following figures, wherein like reference numerals refer to like parts throughout the various figures.

FIG. 1 is a flow diagram, according to one embodiment.

FIG. 2A is a flow diagram, according to one embodiment.

FIG. 2B is a flow diagram, according to one embodiment.

FIG. 3 is a flow diagram, according to one embodiment.

FIG. 4A is a flow diagram, according to one embodiment.

FIG. 4B is a flow diagram, according to one embodiment.

FIG. 4C is a flow diagram, according to one embodiment.

FIG. 4D is a flow diagram, according to one embodiment.

FIG. 4E is a flow diagram, according to one embodiment.

FIG. 4F is a screen illustration, according to one embodiment.

FIG. 5A is a flow diagram, according to one embodiment.

FIG. 5B is a flow diagram, according to one embodiment.

FIG. 5C is a flow diagram, according to one embodiment.

FIG. 6A is a mobile device illustration, according to one embodiment.

FIG. 6B is a mobile device illustration, according to one embodiment.

FIG. 6C is a mobile device illustration, according to one embodiment.

FIG. 6D is a mobile device illustration, according to one embodiment.

FIG. 7 is a block diagram, according to one embodiment.

FIG. 8 is a flow diagram, according to one embodiment.

FIG. 9A is an illustration of a display screen, according to one embodiment.

FIG. 9B is another illustration of a display screen, according to one embodiment.

FIG. 9C is another illustration of a display screen, according to one embodiment.

FIG. 9D is another illustration of a display screen, according to one embodiment.

FIG. 9E is another illustration of a display screen, according to one embodiment.

FIG. 9F is another illustration of a display screen, according to one embodiment.

FIG. 9G is another illustration of a display screen, according to one embodiment.

FIG. 9H is another illustration of a display screen, according to one embodiment.

FIG. 9J is another illustration of a display screen, according to one embodiment.

FIG. 9K is another illustration of a display screen, according to one embodiment.

FIG. 9L is another illustration of a display screen, according to one embodiment.

FIG. 9M is another illustration of a display screen, according to one embodiment.

FIG. 9N is another illustration of a display screen, according to one embodiment.

FIG. 9P is another illustration of a display screen, according to one embodiment.

FIG. 9Q is another illustration of a display screen, according to one embodiment.

FIG. 9R is another illustration of a display screen, according to one embodiment.

FIG. 9S is another illustration of a display screen, according to one embodiment.

FIG. 9T is another illustration of a display screen, according to one embodiment.

FIG. 10A is a block illustration, according to one embodiment.

FIG. 10B is another block illustration, according to one embodiment.

FIG. 11 is a block illustration, according to one embodiment.

FIG. 12A is a multi-platform image, according to one embodiment.

FIG. 12B is a multi-platform flow diagram, according to one embodiment.

FIG. 12C is another multi-platform flow diagram, according to one embodiment.

FIG. 13A is a multi-platform image, according to one embodiment.

FIG. 13B is another multi-platform image, according to one embodiment.

FIG. 13C is another multi-platform image, according to one embodiment.

FIG. 14A is a multi-platform image, according to one embodiment.

FIG. 14B is another multi-platform image, according to one embodiment.

FIG. 15A is another multi-platform image, according to one embodiment.

FIG. 15B is a multi-platform flow diagram, according to one embodiment.

FIG. 16A is a multi-platform image, according to one embodiment.

FIG. 16B is another multi-platform image, according to one embodiment.

FIG. 16C is another multi-platform image, according to one embodiment.

FIG. 16D is another multi-platform image, according to one embodiment.

FIG. 17A is a multi-platform image, according to one embodiment.

FIG. 17B is another multi-platform image, according to one embodiment.

FIG. 17C is another multi-platform image, according to one embodiment.

FIG. 17D is another multi-platform image, according to one embodiment.

FIG. 18A is an illustration of the electronic gaming device, according to one embodiment.

FIG. 18B is an illustration of another electronic gaming device, according to one embodiment.

FIG. 18C is an illustration of another electronic gaming device, according to one embodiment.

FIG. 18D is an illustration of another electronic gaming device, according to one embodiment.

FIG. 19 is an illustration of an electronic gaming system, according to one embodiment.

FIG. 20 is a block diagram of the electronic gaming device, according to one embodiment.

FIG. 21 is another block diagram of the electronic gaming device, according to one embodiment.

FIG. 22A is an illustration of game play on a gaming device, according to one embodiment.

FIG. 22B is an illustration of an influence procedure for a product, according to one embodiment.

FIG. 22C is an illustration of an influence procedure for a product, according to one embodiment.

FIG. 23A is another illustration of an influence procedure on a gaming device, according to one embodiment.

FIG. 23B is another illustration of an influence procedure for a product, according to one embodiment.

FIG. 23C is another illustration of an influence procedure for a product, according to one embodiment.

FIG. 23D is another illustration of an influence procedure for a product, according to one embodiment.

FIG. 24A is another illustration of an influence procedure and/or funding procedure for a product, according to one embodiment.

FIG. 24B is another illustration of an influence procedure and/or funding procedure for a product, according to one embodiment.

FIG. 24C is another illustration of an influence procedure and/or funding procedure for a product, according to one embodiment.

FIG. 24D is another illustration of an influence procedure and/or funding procedure for a product, according to one embodiment.

FIG. 25A is another illustration of an influence procedure for a product, according to one embodiment.

FIG. 25B is another illustration of an influence procedure for a product, according to one embodiment.

FIG. 25C is another illustration of an influence procedure for a product, according to one embodiment.

FIG. 26 is a flow diagram, according to one embodiment.

FIG. 27A is an illustration of earning votes and/or influence criteria, according to one embodiment.

FIG. 27B is another illustration of earning votes and/or influence criteria, according to one embodiment.

FIG. 27C is another illustration of earning votes and/or influence criteria, according to one embodiment.

FIG. 28 is a flow diagram, according to one embodiment.

FIG. 29 is a flow diagram, according to one embodiment.

FIG. 30 is a flow diagram, according to one embodiment.

FIG. 31 is a flow diagram, according to one embodiment.

FIG. 32A is another illustration of a funding procedure for a product, according to one embodiment.

FIG. 32B is another illustration of a funding procedure for a product, according to one embodiment.

FIG. 32C is another illustration of a funding procedure for a product, according to one embodiment.

FIG. 33 is a flow diagram, according to one embodiment.

FIG. 34 is a flow diagram, according to one embodiment.

FIG. 35 is a flow diagram, according to one embodiment.

FIG. 36 is a flow diagram, according to one embodiment.

FIG. 37 is a flow diagram, according to one embodiment.

FIG. 38 is a flow diagram, according to one embodiment.

FIG. 39 is a flow diagram, according to one embodiment.

FIG. 40 is a flow diagram, according to one embodiment.

### DETAILED DESCRIPTION

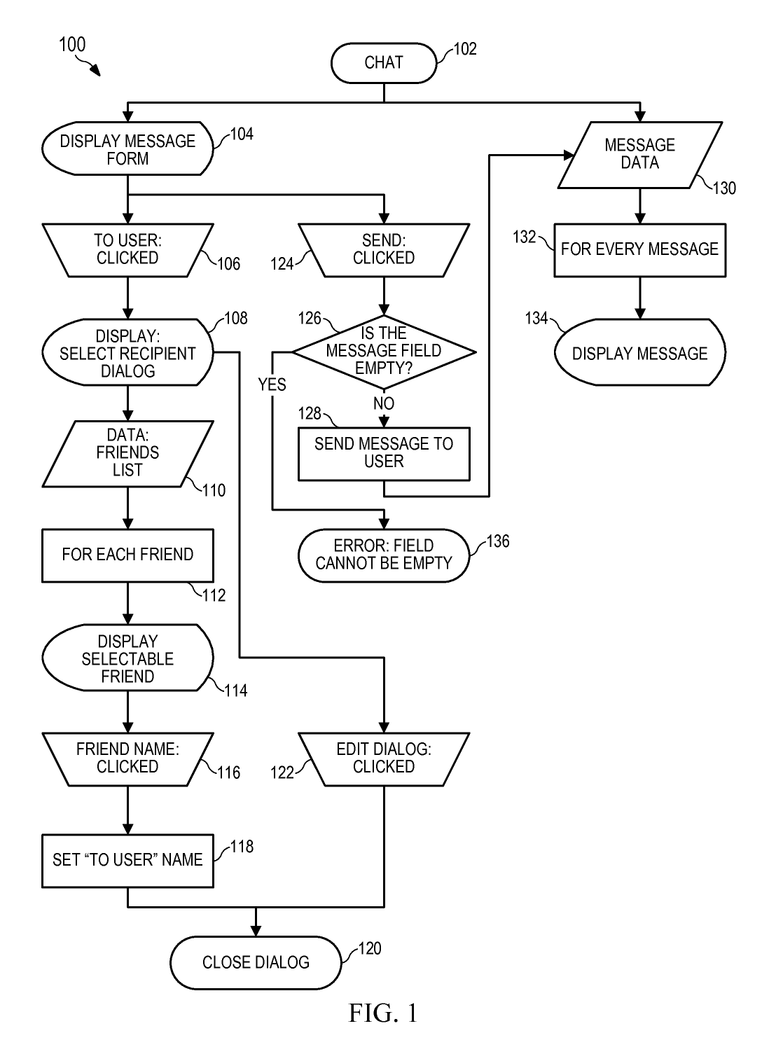

In FIG. 1, a flow diagram is shown, according to one embodiment. A method 100 may include enabling/allowing/initiating/implementing a chat function (step 102). The method 100 may include displaying a message form (step 104). The method 100 may include user clicked function (step 106). The method 100 may include a send clicked function (step 124). If step 106 is utilized, then the method 100 may include a display the selected recipient dialog function (step 108). Based on utilizing step 108, the method 100 may include an edit dialog clicked function (step 122) and/or a data friends list function (step 110). After step 122, the method 100 may include a close dialog function (step 120). Further, the method 100 may include a for each friend function (step 112) which may include a display selectable friend function (step 114). The method 100 may include a friend name clicked function (step 116). The method 100 may include a set to user name function (step 118) and then a close dialog function (step 120). In addition, if step 124 is utilized, then the method 100 may include one or more processors determining whether the message field is empty (step 126). If the message field is empty, then the method 100 may include a send message to user function (step 128). If the message field is not empty, then the method 100 may initiate an error message based on the message field not being empty (step 136). If step 128 is utilized, then the method may include a message data function (step 130) which can also be implemented right after step 102. In addition, the method may include a for every message function (step 132) and a display message function (step 134). In various examples, these chat functions may be implemented in a multi-platform environments. In one example, a first player on a first platform may chat with a second player on a second platform. In this example, the first player may be on a first platform and playing a first game while a second player may be on a second platform and playing a second game. In this example, the first player and the second player may be friends which was based on both the first player and the second player requesting and/or accepting a friend's request. Further, both the first player and the second player may know via a status update that each other is online at the same time. For example, a friend status field on the second player's game may show that the first player is online and playing a first game on a first platform. Further, a friend status field on the first player's game may show that the second player is online and playing a second game on a second gaming platform. Therefore, the first player may send one or more messages to second player and vice versa. The platforms and/or gaming platforms are gaming environments with distinct operating systems which are typically not compatible with each other. For example, a first game purchased on a first platform will not run on a second platform, a third platform, . . . , an Nth platform. Likewise, a first game purchased on a second platform will not run on a first platform, a third platform, . . . , an Nth platform. In addition, typically a first player playing a first game on a first platform cannot interact with a second player playing the first game on a second platform. However, with this disclosure, a new environment is created which allows the first player to play a first game on a first platform with a second player playing the first game on the second platform. Further, a first player may play a first game on a first platform with a second player playing the first game on a second platform with an Nth player playing the first game on an Nth platform. Therefore, there may be N number of players on N number of platforms playing the same game (e.g., a first game, a second game, . . . , an Nth game). Also, these players may play the same game and/or different games on the same platform and/or different platforms while being able to interact with each other (e.g., chat, send messages, invite to party, invite to game, trade with each other, etc.). In addition, with the layer functionality of this disclosure, a game may be created using one or more tool functions which will work on 1 to N platforms. For example, a first tool function may be creating a new character which allows the user to develop one or more new characters for a new game which will be compatible with one or more platforms (from 1 to N). Further, a second tool function may be creating a new weapon which allows the user to develop one or more new weapons for a new game which will be compatible with one or more platforms (from 1 to N). Further, an Nth tool function may be creating one or more levels and/or paths for a new game which will be compatible with one or more platforms (from 1 to N). In various examples, one or more of these tool functions can be utilized to create a new game. Further, a layering functionality may allow a game developed for a first platform to interact and/or be compatible with a second platform, a third platform, . . . , an Nth platform. The layering functionality may utilize the inputs and outputs of the game and convert them from a first platform format to a second platform format, a third platform format, . . . , and/or an Nth platform format.

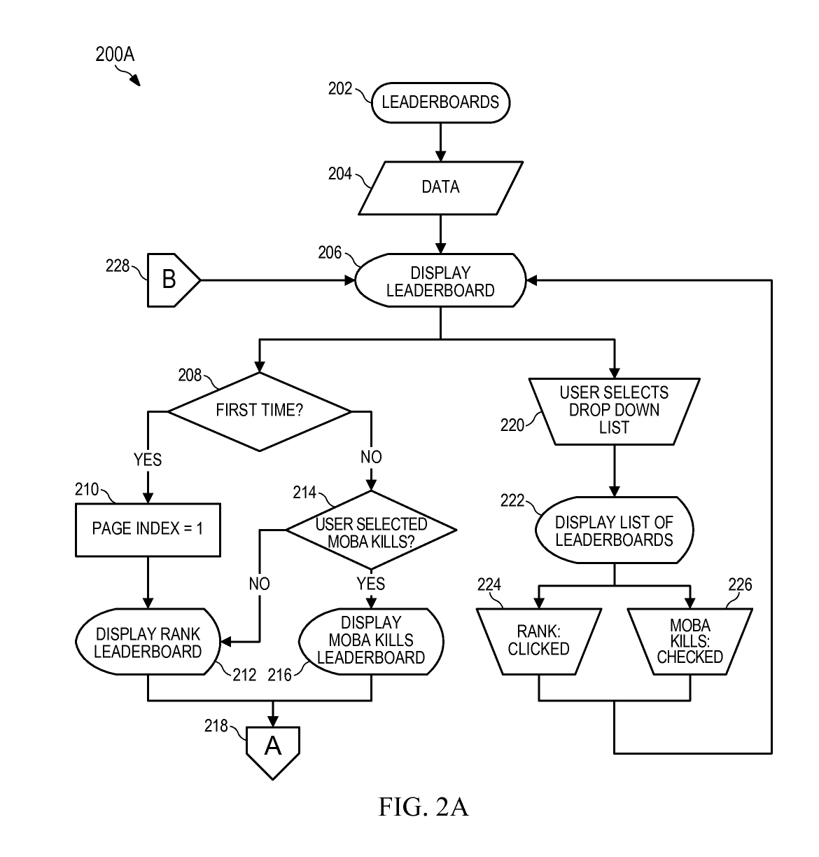

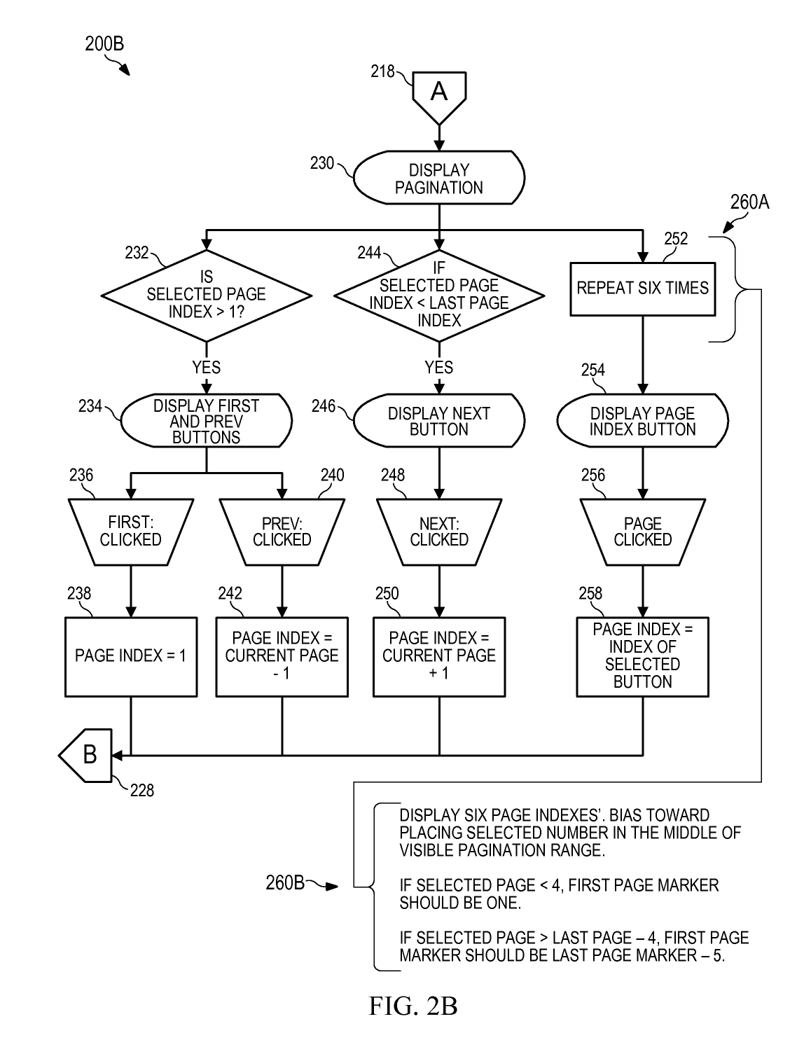

In FIG. 2A, a first portion of a flow diagram is shown, according to one embodiment. In one example, the method 200A may include a leadership board function (step 202). The method 200A may include a data function (e.g., compiling, receiving, transmitting, etc.) (step 204). The method 200A may include a displaying leaderboard function (step 206). The method 200A may include a first time function (step 208) and/or a user selects drop down list function (step 220). If step 208 is utilized, then one or more processors may determine whether this a first time for the user. If this is the first time for the user, then the method 200A may include a page index=1 function (step 210). The method 200A may include a display rank leaderboard function (step 212) and move 218 to the steps shown on FIG. 2B. If this is not a first time for the user, then the method 200A may include one or more processors determining whether the user selected MOBA (Multi-player online battle arena) kills function should be initiated (step 214). If the MOBA kills function should not be initiated, then the method 200A moves to step 212. If the MOBA kills function should be initiated, then the method 200A may include a display the MOBA kills leaderboard function (step 216) and moves 218 to functions on FIG. 2B.

If step 220 is utilized, then the method 200A may include a display a list of leaderboards function (step 222). The method 200A may include a rank clicked function (step 224) and/or a MOBA kills checked function (step 226) and then the method 200A moves back to step 206.

In FIG. 2B, a second portion of a flow diagram is shown, according to one embodiment. A second portion of the method 200B may include a display pagination function (step 230). The method 200B may include one or more processors determining whether the selected page is indexed to greater than the number 1 (step 232). The method 200B may include one or more processors determining whether the selected page index is less than the last page index (step 244). The method 200B may include a repeat six times function (step 252).

If step 232 is selected, then the method 200B may include a display first and previous buttons function (step 234) which includes steps 236 and 240. If step 236 is utilized, then the method 200B may include a page index=1 function (step 238). If step 240 is utilized, then the method 200B may include a page index=current page−1 function (step 242).

If step 244 is selected, then the method 200B may include a display next button function (step 246). The method 200B may include a next clicked function (step 248). The method 200B may include a page index=current page+1 function (step 250).

If step 252 is utilized, then the method 200B may include a display page index button function (step 254). The method 200B may include a page clicked function (step 256). The method 200B may include a page index=index of selected button function (step 258). Further, step 252 may include (reference numbers 260A and 260B) a display six page indexes′. Bais toward placing selected number in the middle of visible pagination range function and if selected page<4, first page marker should be one, and if selected page>last page−4, then first page marker should be last page marker−5.

After one or more of steps 238, 242, 250, and 258 are completed, the method 200B may move back 228 to the steps in FIG. 2A. In one example, a multi-player online battle arena (“MOBA”) may include various teams. In this example, a first team may be made up of four players where two of the players are playing on a first platform, one of the players is playing on a fifth platform, and one or the players is playing on an Nth platform while a second team may be made up of five players where two of the players are playing on a second platform, one of the players is playing on a fourth platform, one of the players is playing on a tenth platform, and one of the players is playing on an N−1 platform. In another example, a multi-platform leaderboard may be utilized with a platform leaderboard. In one example, a first platform leaderboard may compile, transmit, and/or display a ranking of all (and/or a portion) of the players for one or more games. For example, Bob S. may be the best player and/or has the highest score for a first combat game on a first platform leaderboard while Joe B. may have the 100^{th} highest score for the first combat game on a first platform leaderboard. However, Bob S. may have the 10^{th} highest score for the first combat game on the multi-platform leaderboard while Joe B. may have the 1000^{th} highest score for the first combat game on the multi-platform leaderboard. In another example, the layering functionality may combine one or more leaderboards and show it as only the first combat game leaderboard for one or more platforms.

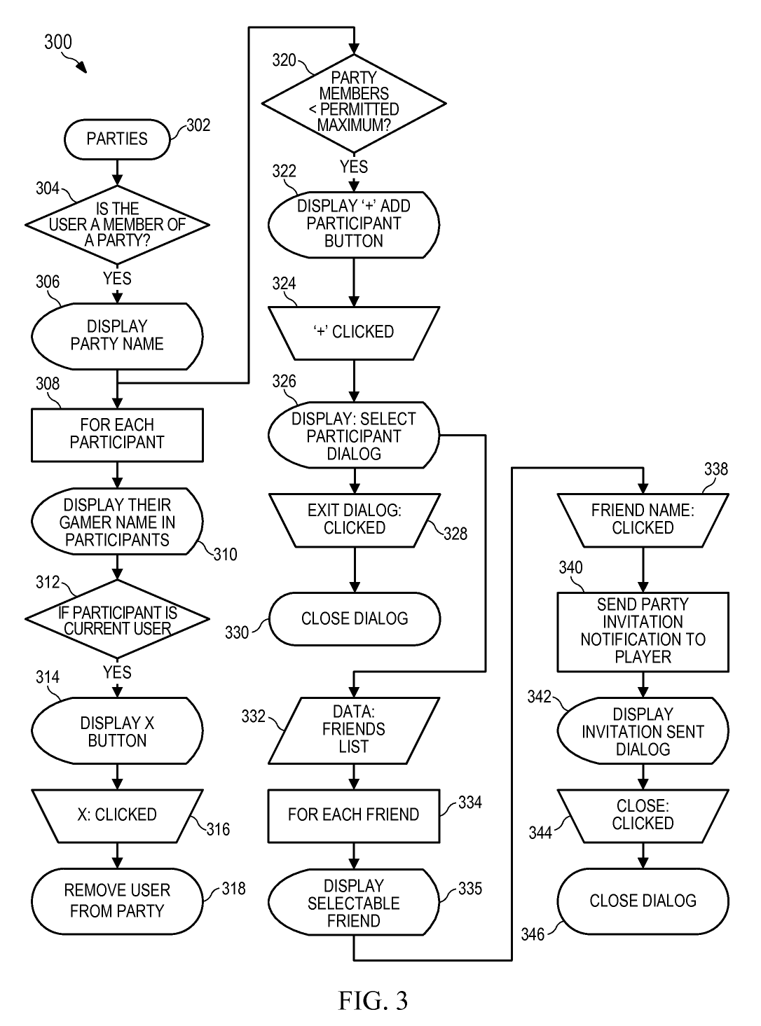

In FIG. 3, a flow diagram is shown, according to one embodiment. In one example, a method 300 may include a parties function (step 302). The method 300 may include one or more processors determining whether the user is a member of a party (step 304). If the user is not a member of the party, the method 300 may initiate a new member sign-up procedure. If the user is a member of the party, the method 300 may include a display party name function (step 306). After step 306, the method may either initiate step 308 and/or step 320. If step 308 is selected, then the method 300 may include that for each participant a display their gamer name in participants function (step 310). The method 300 may include one or more processors determining whether the participant is a current user (step 312). If the participant is not a current user, then the method 300 may initiate a new user sign-up procedure. If the participant is a current user, then the method 300 may include a display X button function (step 314). The method may include a X clicked function (step 316) and a remove the user from the party function (step 318).

If step 320 is selected, then the method 300 may include one or more processors determining whether a party members is greater than a permitted maximum party members. If the party members is greater than a permitted maximum party members, a denial message may be transmitted to one or more party members. If the party members is not greater than a permitted maximum party members, then the method 300 may include a display ‘+’ add participant button function (step 322). The method 300 may include a ‘+’ clicked function (step 324). The method 300 may include a display select participant dialog function (step 326). The method may include an exit dialog clicked function (step 328) and/or a data friends list function (step 332) after step 326. If step 328 is utilized, then the method 300 may include a close dialog function (step 330). If step 332 is selected, then the method may include for each friend (334) a display selectable friend function (step 335); a friend name clicked function (step 338); a send party invitation notification to player function (step 340); a display invitation sent dialog function (step 342); a close clicked function (step 344); and/or a close dialog function (step 346). In one example, a first player on a first platform may transmit a game invite request and/or friend request to a second player on a second platform. In addition for the game invite request, the system, method, and/or device may create a layering functionality to allow the first player and the second player to play a first game together even though the first player is utilizing a first platform structure while the second player is utilizing a second platform structure.

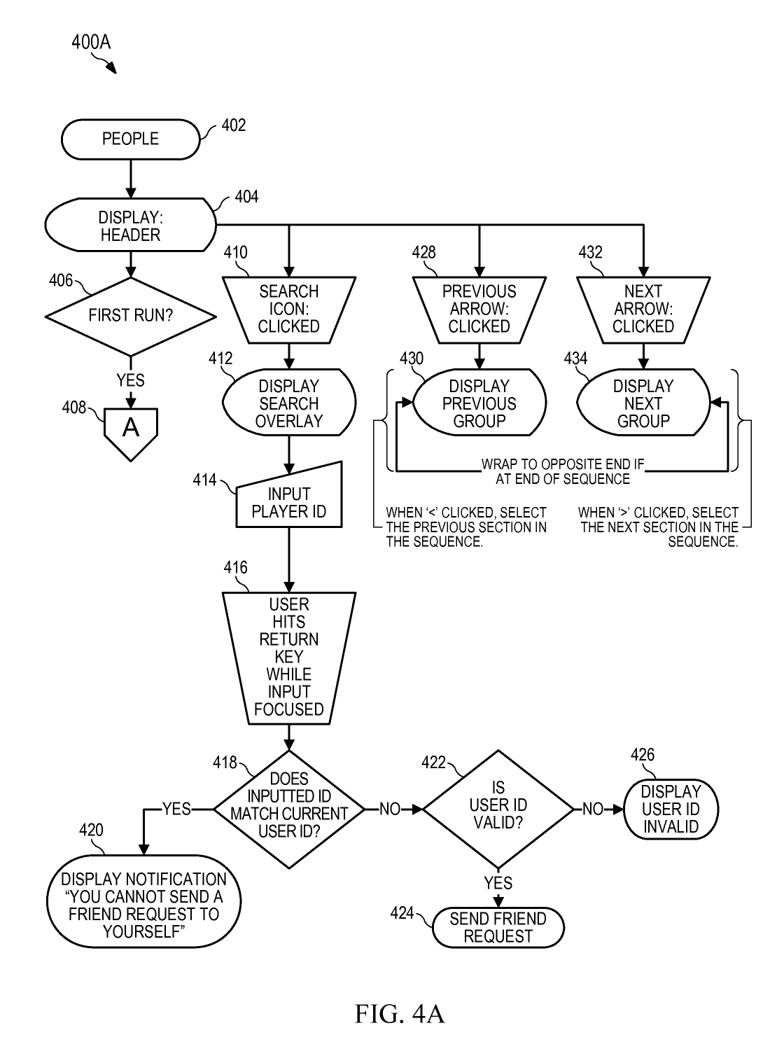

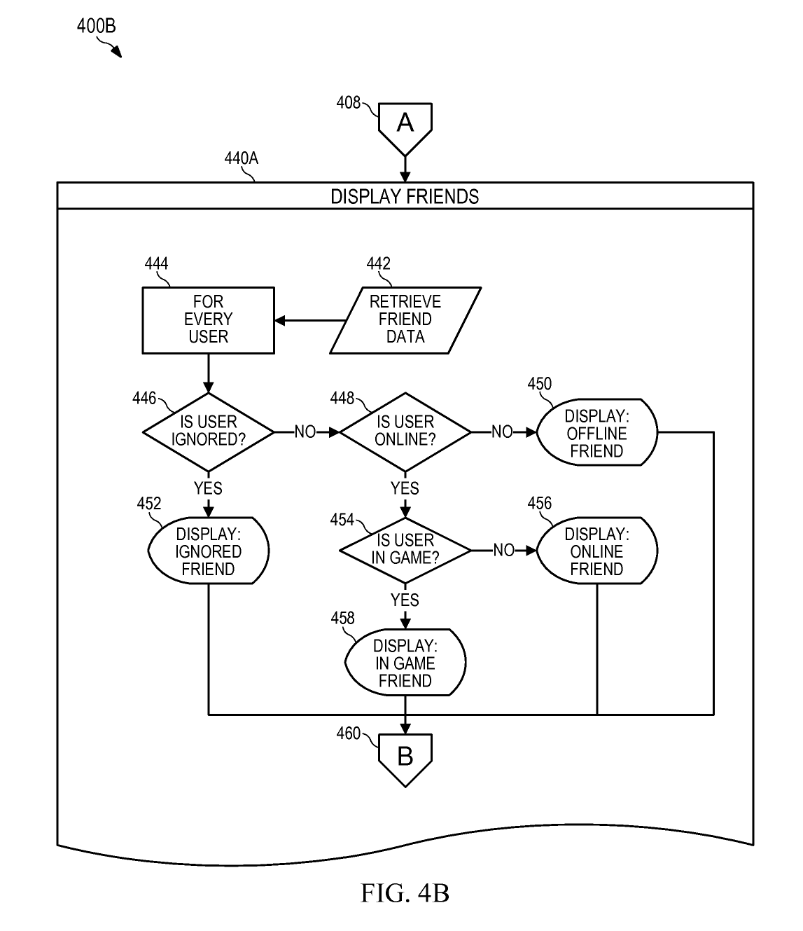

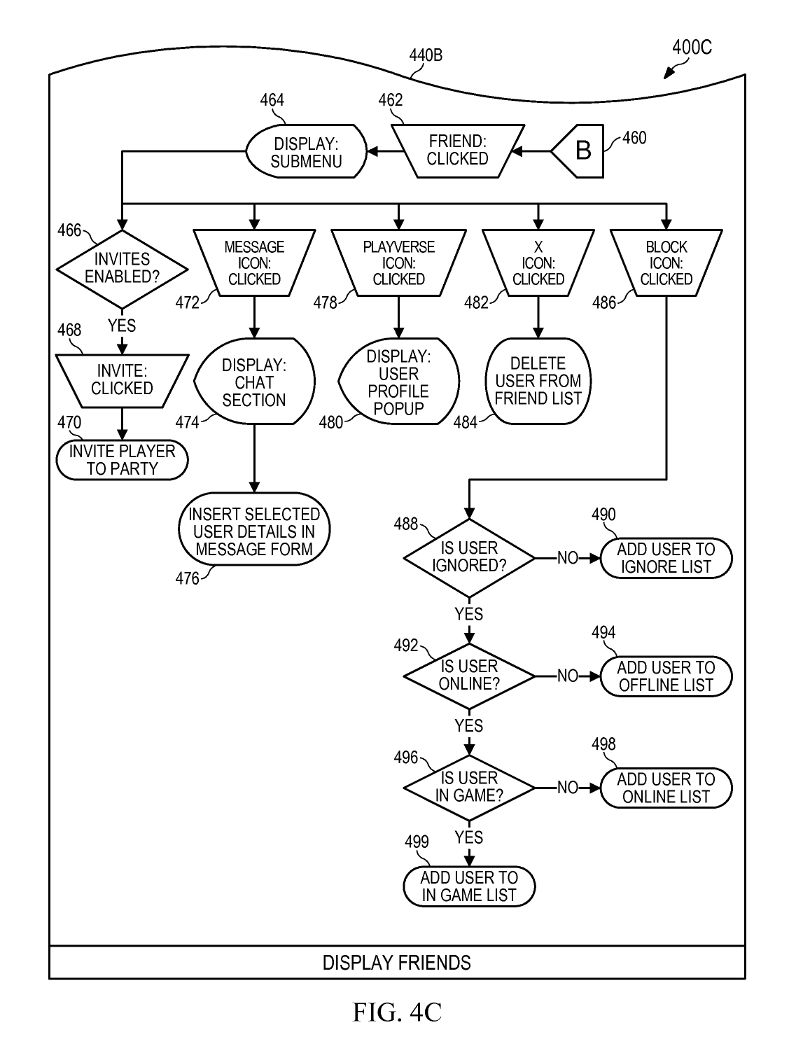

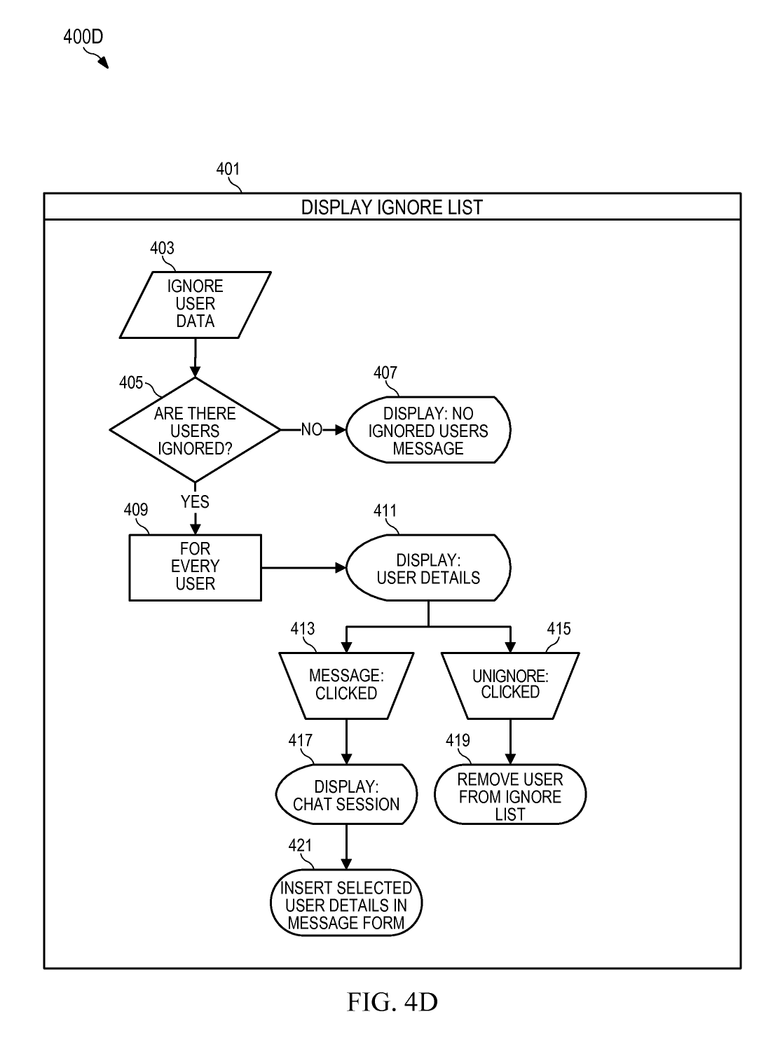

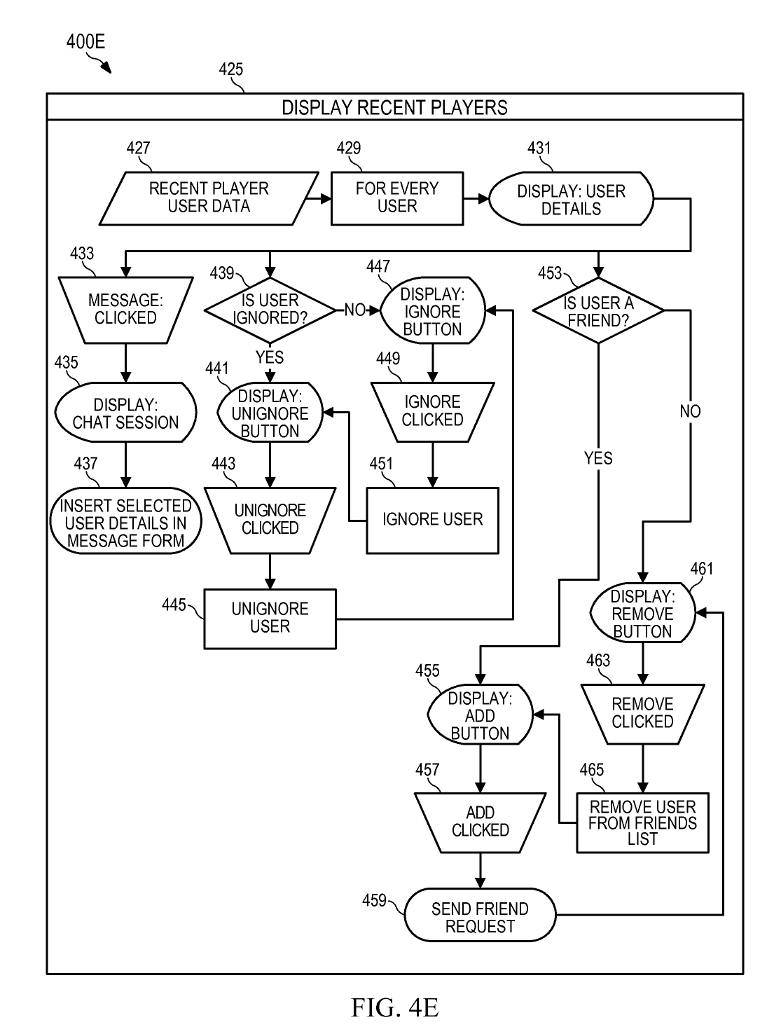

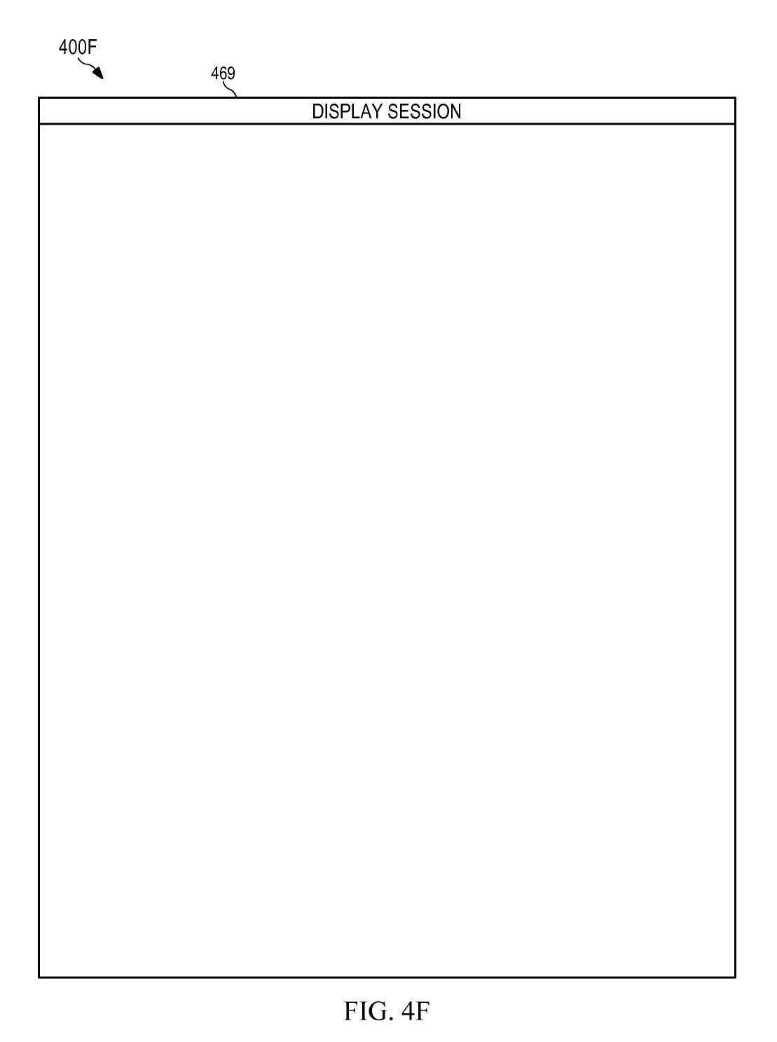

In FIG. 4A, a first part of a flow diagram is shown, according to one embodiment. A method 400A may include one or more processors determining whether one or more players are playing (step 402). The method 400A may include a display header function (step 404) which may lead to one or more of a determining a first run step (step 406), a search icon clicked function (step 410), a previous arrow clicked function (step 428), and/or a next arrow clicked function (step 432). If the determining a first run step 406 is utilized, then the method 400A may include moving 408 to FIG. 4B. If the search icon clicked function step 410 is utilized, then the method 400A may include a display search overlay function (step 412). The method may then include an input player identification function (step 414), a user hits return key while input focused function (step 416), and a determining inputted identification match current user identification function (step 418). If the player identification matches the current user identification, then the method 400A may display notification that you cannot send a friend request to yourself (step 420). If the player identification does not match the current user identification, then the method 400A may determine via one or more processors whether the user identification is valid (step 422). If the user identification is valid, then the method 400A may send a friend request (step 424). If the user identification is invalid, then the method 400A may display a user identification is invalid message (step 426). If the previous arrow clicked function step 428 is utilized, then the method 400A may include a display previous group function (step 430). If the next arrow clicked function step 432 is utilized, then the method 400A may include a display next group function (step 434). In one example, these two functions (step 430 and 434) may be wrapped to opposite ends if at the end of a sequence. Further, when < clicked, select the previous section in the sequence. Further, when > clicked, select the next section in the sequence.

In FIG. 4B, a second part of a flow diagram is shown, according to one embodiment. The method 400B (which is part of the total method 400A, 400B, 400C, 400D, 400E, and 400F) may include after the first run determination is made that a display friends function (step 440A) is utilized. The display friends function 440A may include that for each user 444 a retrieve friends data is implemented (step 442). Further, the method may include one or more processors determining whether the user should be ignored (step 446). If the use should be ignored, then the method may include display ignored friend function (step 452) and then moves 460 to FIG. 4C. If the user should not be ignored, then the method may include is the user online determination (step 448). If the user is not online, then the method may include displaying an offline friend status (step 450) and then moves 460 to FIG. 4C. If the user is online, then the method may determine whether the use is in the game (step 454). If the user is not in the game, then the method may display online friend status (step 456) and then moves 460 to FIG. 4C. If the user is in the game, then the method may display in game friend status (step 458) and then moves 460 to FIG. 4C. In one example, a first player is playing a first game on a first platform and searches for his friends where a first friend is playing a second game on a third platform and an Nth friend is playing an Nth game on an Nth platform. The first player transmits a third game invitation to the first friend and the Nth friend. Once one or more of the friends (e.g., first friend and Nth friend) accept the game invitation, the game starts with the first player utilizing a first platform, a first friend utilizing a third platform, and/or an Nth friend utilizing an Nth platform to play the third game which may be implemented via a layering functionality and/or compatibility filtering system, method, and/or device.

In FIG. 4C, a third part of a flow diagram is shown, according to one embodiment. The method 400C may include a friend clicked function (step 462); a display submenu function (step 464); a determining of invites enabled function (step 466); a message icon clicked function (step 472); a playverse icon clicked function (step 478); an X icon clicked function (step 482); and/or a block icon clicked function (step 486). If the determination of invites enabled function step 466 is utilized, then the method may include an invite clicked function (step 468) and an invite player to party function (step 470). If the message icon clicked function step 472 is utilized, then the method may include a display chat section function (step 474) and an insert selected user details in message form function (step 476). If the playverse icon clicked function step 478 is utilized, then the method may include a display user profile popup function (step 480). If the X icon clicked function step 482 is utilized, then the method may include a delete user from friend list function (step 484). In addition, if the block icon clicked function step 486 is utilized, then the method may include a determination of a user to be ignored function (step 488) and if the user is to be ignored, then the method may include an add user to ignore list function (step 490). If the user is not to be ignored but the method determines that the user is offline (step 492), then the method may include an add the user to an offline list (step 494). If the user is online but the method determines that the user is not in the game (step 496), then the method may include an add user to online list (step 498). If the user is in the game, the method may include an add user to in game list (step 499). In another example, a first player may have a first profile while a second player may have a second profile while an Nth player may have an Nth profile. The first profile may have a first game on a first platform, a second game on a second platform, and an Nth game on an Nth platform. Further, the first profile may have that the player's preferred language is English and how the first player prefers to display one or more games. In addition, the second profile may have the player's preferred language is French and how the second player prefers to display one or more games. In another example, the first profile may have that the first player is a member of platform 1, 2, and Nth but not platform 3.

In FIG. 4D, a fourth part of a flow diagram is shown, according to one embodiment. The method may include a display ignore list function 401. The method may include an ignore user data function (step 403) and a determination of whether there are users being ignored (step 405). If no users are being ignored, then the method may include a display no ignored uses message (step 407). If there are users that are being ignored, then the method may include for every user 409, a display user details function (step 411). The method may include one or more of a message clicked function (step 413) and/or a unignore clicked function (step 415). If step 413 is selected, then the method may include a display chat session function (step 417) and an insert selected user details in message form function (step 421). If step 415 is utilized, then the method may include a remove user from ignore list function (step 419).

In FIG. 4E, a fifth part of a flow diagram is shown, according to one embodiment. The method 400E may include a display recent players function 425. The method may include for recent player user data 427 and/or for every user 429 a display user details function (step 431). Further, the method may include one or more of a message clicked function (step 433); a determining to ignore a user function (step 439); and/or a determining a user is a friend function (step 453). If the message clicked function step 433 is utilized, then the method may include a display chat session function (step 435) and/or an insert selected user details in message form (step 437). If the determining to ignore a user function step 439 is utilized, then the method may include a display ignore button function (step 447) when the user should be ignored and a display an unignore button (step 441) when the user should not be ignored. If step 447 is utilized, then the method may include an ignore clicked function (step 449) and/or an ignore user function (step 451) which then goes back to step 441. The method may include an unignore clicked function (step 443) and an unignore user function (step 445) which goes back to step 447. If a determining a user is a friend function step 453 is utilized, then the method may include a display remove button function (step 461); a remove clicked function (step 463); and/or a remove user from friends list function (step 465) based on the user not being a friend determination. Further, the method may include a display add button function based on the non-friend determination (step 455); an add clicked function (step 457); and a send friend request function based on the non-friend determination (step 459). In another example, a display session function 469 may display a screen with various details (see FIG. 4F). In one example, the system, method, and/or device may track a player's recent history. In this example, a first player may have played a first game on a first platform a day ago, a second game on a third platform 10 minutes ago, and is currently playing a third game on an Nth platform via one or more laying functionality (e.g., Playverse).

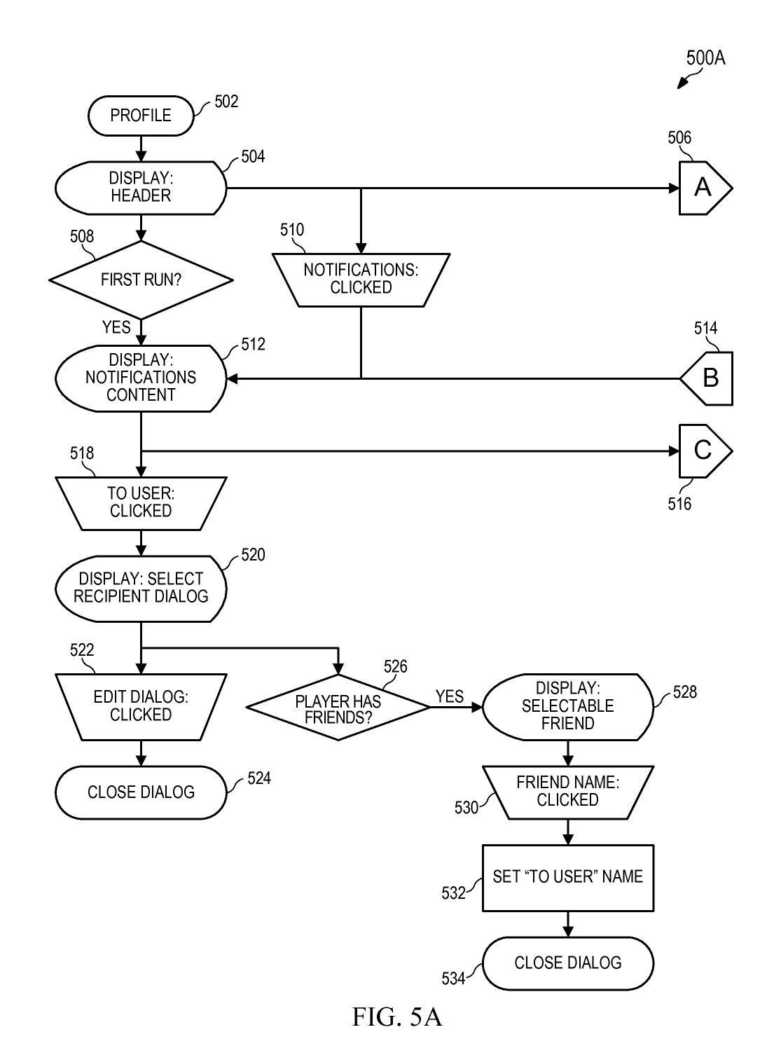

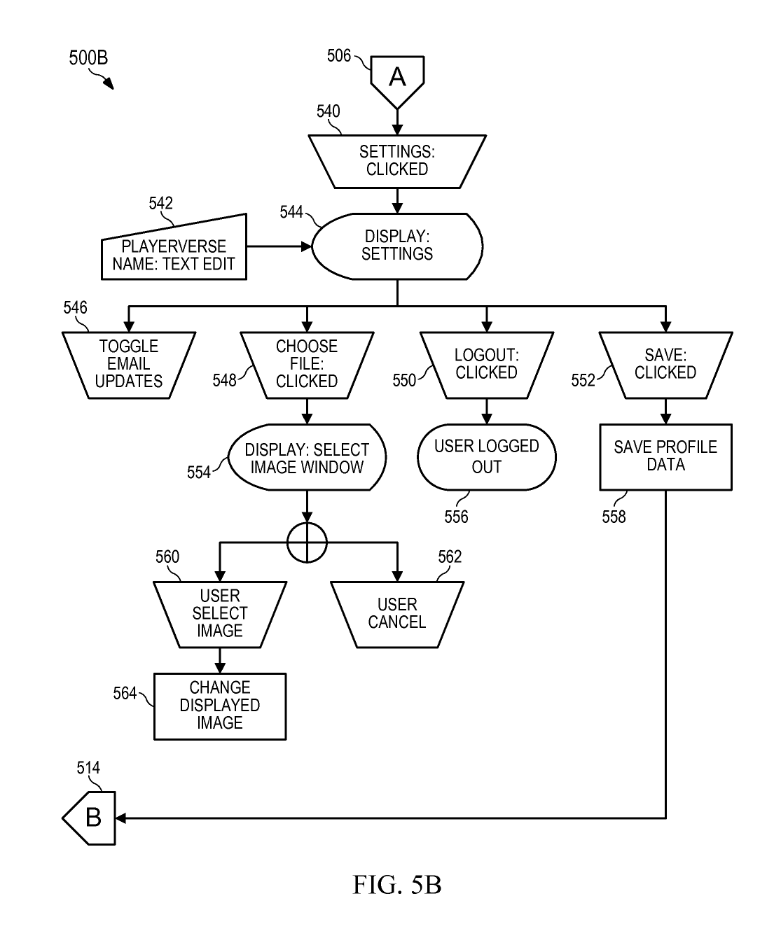

In FIG. 5A, a first portion of a flow diagram is shown, according to one embodiment. The method 500A (the entire method is 500A, 500B, and 500C) may include a profile function (step 502) and a display header function (step 504). The display header function step 504 may be followed by steps shown via a move 506 to FIG. 5B; a notifications clicked function (step 510); and/or a determining a first run function (step 508). If the first run function step 508 is utilized, then the method may include a display notifications content function (step 512) which is followed by either moving 516 to FIG. 5C (for steps shown on that figure) or a to user clicked function (step 518). After step 518, the method may include a display select recipient dialog function (step 520). The method may include an edit dialog clicked function (step 522) or a player has a friends determination (step 526). If step 522 is utilized, then the method may include a close dialog function (step 524). If step 526 is utilized, then the method may include a display selectable friend function (step 528) based on the player having friends which is followed by a friend name clicked function (step 530); a set to user name function (step 532); and/or a close dialog function (step 534).

In FIG. 5B, a second portion of a flow diagram is shown, according to one embodiment. The method 500B may include a settings clicked function (step 540) and a display settings function (step 544). In one example, the method may include a playerverse name text edit function (step 542) which feeds into (e.g., provides data to) step 544. After step 544, the method may include one or more of a toggle email updates function (step 546); a choose file clicked function (step 548); a logout clicked function (step 550); and/or a save clicked function (step 552). If step 548 is utilized, then the method may include a display select image window function (step 554); a user select image function (step 560); a change displayed image function (step 564); and/or a user cancel function (step 562). If step 550 is utilized, then the method may include a user logged out function (step 556). If step 552 is utilized, then the method may include a same profile data function (step 558) and then the method may move 514 back to FIG. 5A.

In FIG. 5C, a third portion of a flow diagram is shown, according to one embodiment. The method may include a notification of data received function (step 566) and a display notification function (step 568). The method may include one or more of a manage game item function 501; a friend request function 503; a party request function 505; and/or an invitation request function 507. During the manage game item function 501, the method may include a send to user clicked function (step 570); a determining of has the user been set function (step 572); and/or a send item to friend function (step 574). In addition, the manage game item function 501 may include a send to game clicked function (step 576) and/or a send item to game function (step 578). During the friend request function 503, the method may include a confirm clicked function (step 580) and/or an add contact to friend list function (step 582). In addition, the friend request function 503 may include a not now clicked function (step 584) and/or a deny request function (step 586). During the party request function 505, the method may include a confirm clicked function (step 588) and/or an add contact to party list function (step 590). In addition, the party request function 505 may include a not now clicked function (step 592) and/or a deny party invite function (step 594). During the invitation request function 507, the method may include a confirm clicked function (step 596), a not now clicked function (step 598), a send invitation function (step 597), and/or a don't send invitation function (step 599).

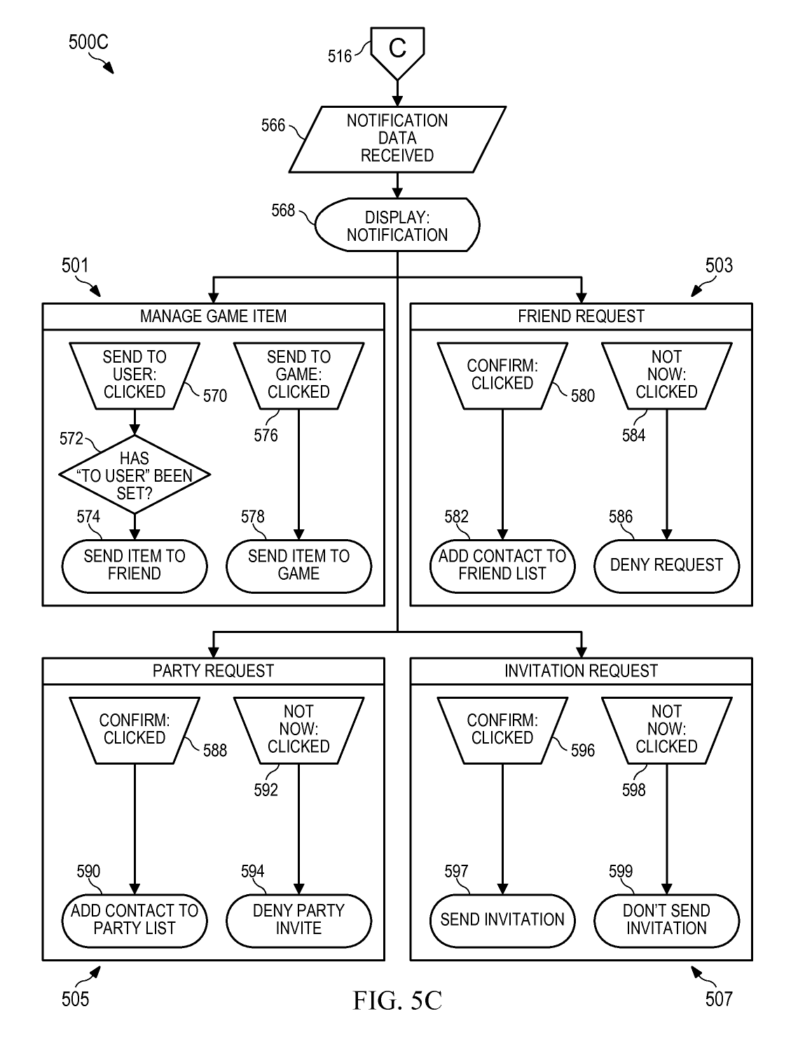

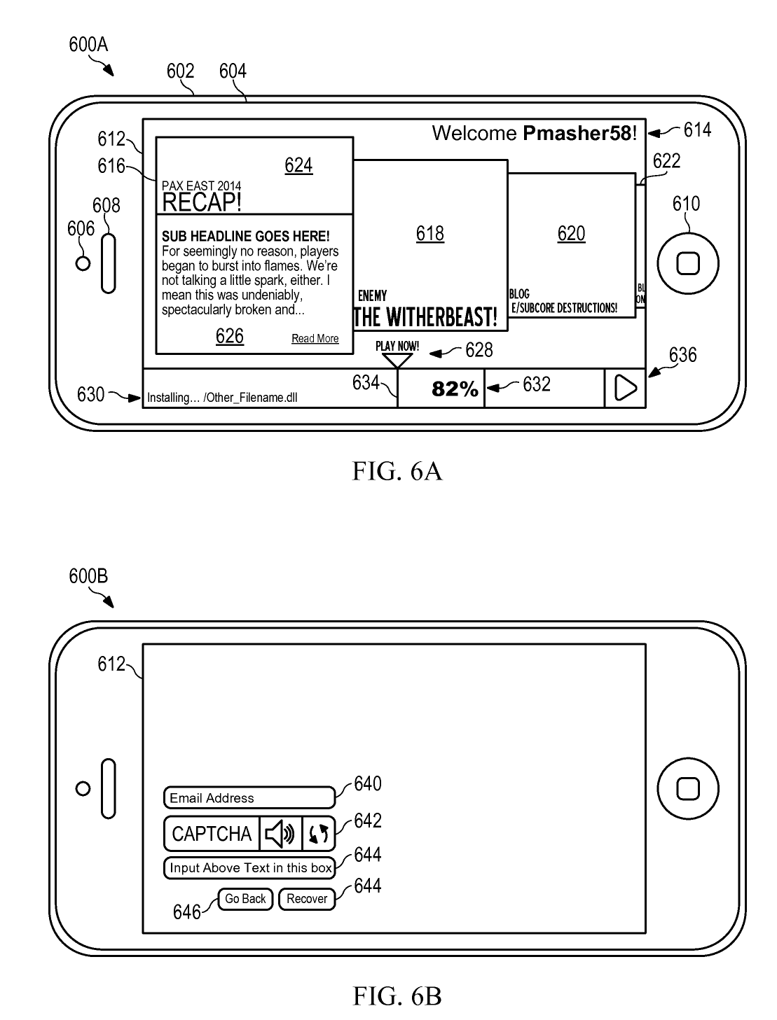

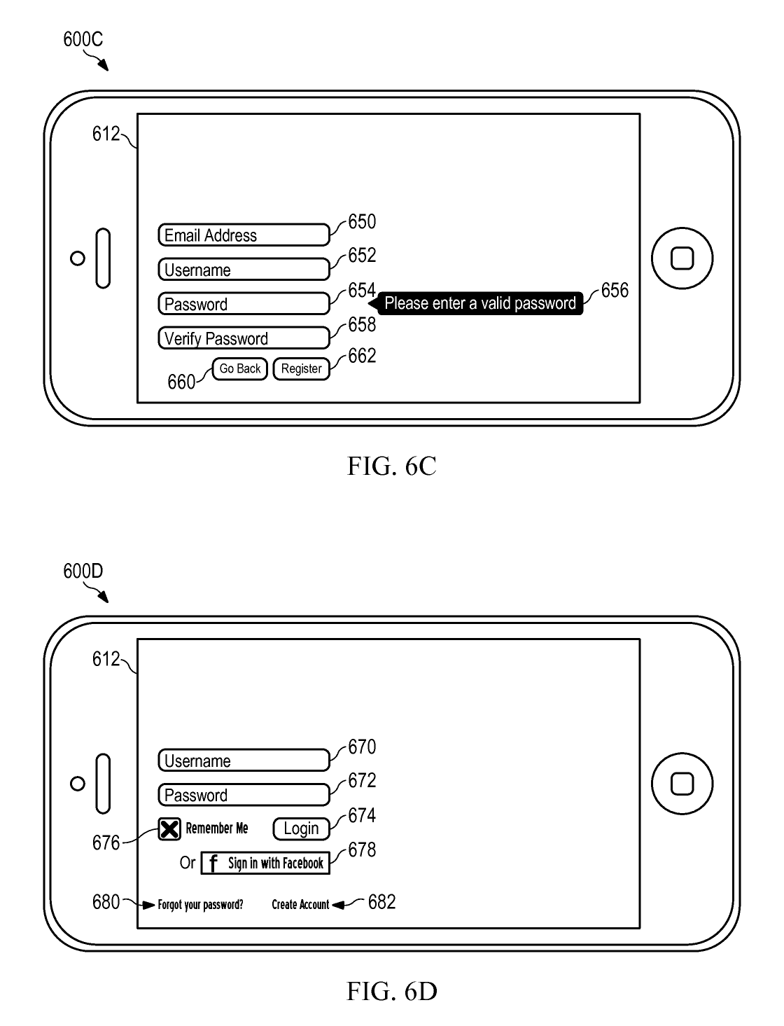

In FIG. 6A, a mobile device illustration is shown, according to one embodiment. A mobile device 602 may include a protective layer 604; a camera 606; a speaker 608; a power button 610; a display screen 612; a welcome message area 614; a status message 616; a game display area 618; a blog area 620; a friends area 622; a status area 624; a game notification area 626; a play now indicator 628; an installation area 630; an installation status indicator 634; an installation % measure 632; and/or a play button 636.

In FIG. 6B, a mobile device illustration is shown, according to one embodiment. The display screen 612 may include an email address area 640; a setting area 642, a text area 644, a go back button 646, and/or a recover button 644.

In FIG. 6C, a mobile device illustration is shown, according to one embodiment. The display screen 612 may include an email address area 650; a user name area 652; a password area 654; a verify password area 658; a please enter a valid a password message 656 (if a valid password is not entered); a go back button 660; and/or a register button 662.

In FIG. 6D, a mobile device illustration is shown, according to one embodiment. The display screen 612 may include a user name area 670; a password area 672; a login button 674; a remember me button 676 (to remember user name and/or password); one or more social media buttons 678; a forgot your password button 680; and/or a create a new account button 682. It should be noted that FIGS. 6A-6D can relate to any platform and/or any device (e.g., a desktop computer, a laptop computer, a first type of console, a second type of console, etc.).

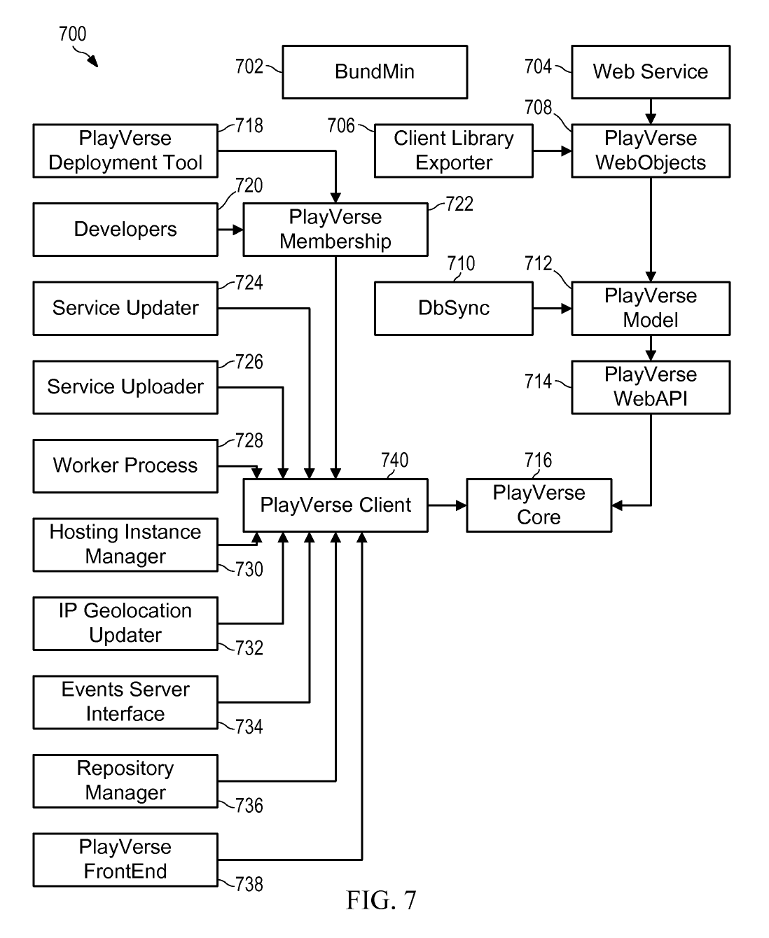

In FIG. 7, a block diagram is shown, according to one embodiment. A first block diagram 700 may include a BundMin module 702; a web service module 704; a client library exporter module 706; a playverse webobjects module 708; a DbSync module 710; a playverse model module 712; a playverse webAPI module 714; a playverse core module 716; a playverse deployment tool module 718; a developers module 720; a playverse membership module 722; a service updater module 724; a service uploader module 726; a worker process module 728; a hosting instance module 730; an IP geolocation updater module 732; an events server interface module 734; a repository manager module 736; a playverse frontend module 738; and a playverse client module 740. In various examples, one or more of these modules may be utilized with one or more overlaying functionalities (e.g., Playverse) and/or one or more gaming platforms.

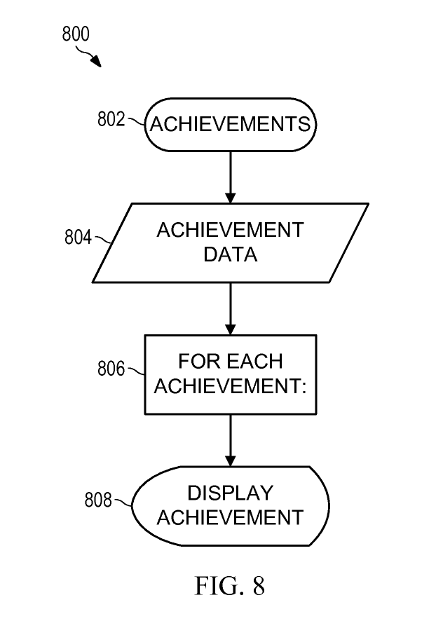

In FIG. 8, a flow diagram is shown, according to one embodiment. A method 800 may include an achievements function (step 802); an achievement data function (step 804); and/or a for each achievement function (step 806) displaying the achievement (step 808). In one example, an achievement may be completing a first level and/or completing a first task. Further, another achievement may be playing the game for a specific time period (e.g., 10 hours) and/or playing on consecutive days (e.g., 2 days in a row). Further, an achievement may be playing a first game from a first platform and playing a second game from a second platform which may be implemented via with one or more overlaying functionalities (e.g., Playverse). In other words, playing games on multiple platforms may be an achievement. In various examples, completing an achievement may provide a prize, a trophy, a player upgrade, and/or any other item to the player. In another example, the achievements of a player may be seen by other players on one or more platforms. Further, an achievement may identify which platform the achievement was completed on—a first player completed task X on platform Y.

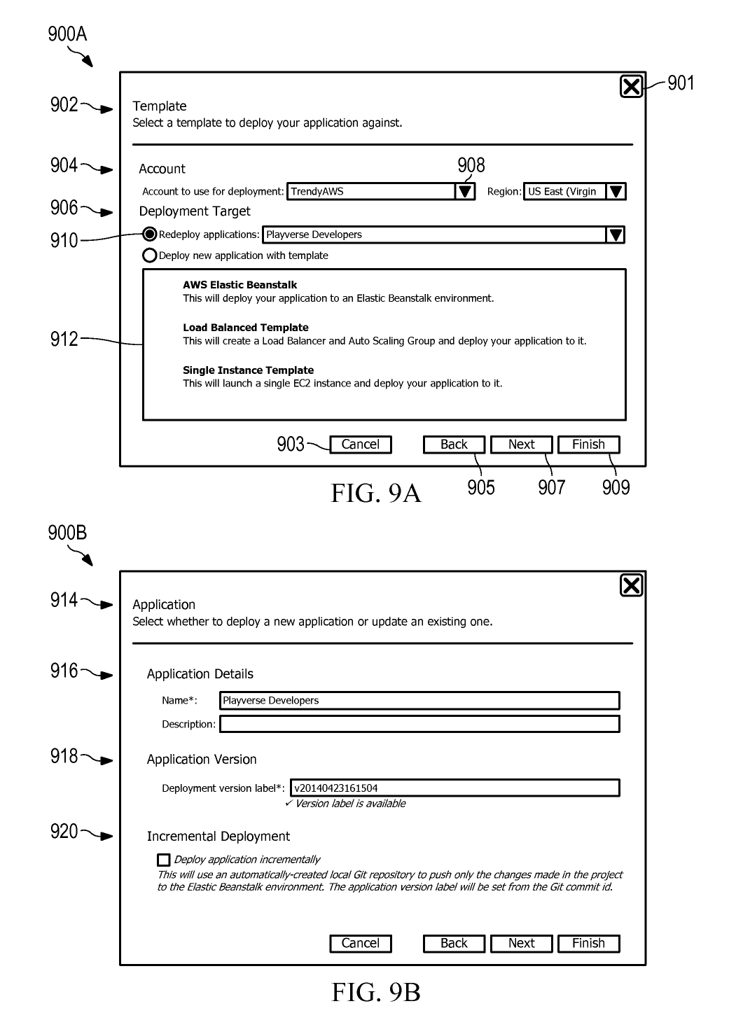

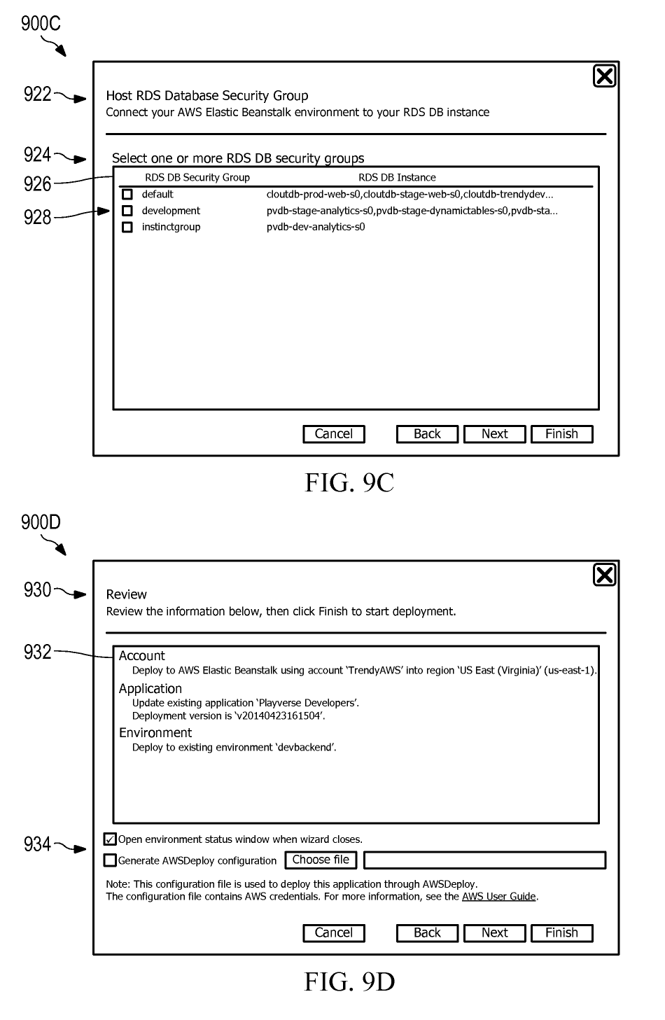

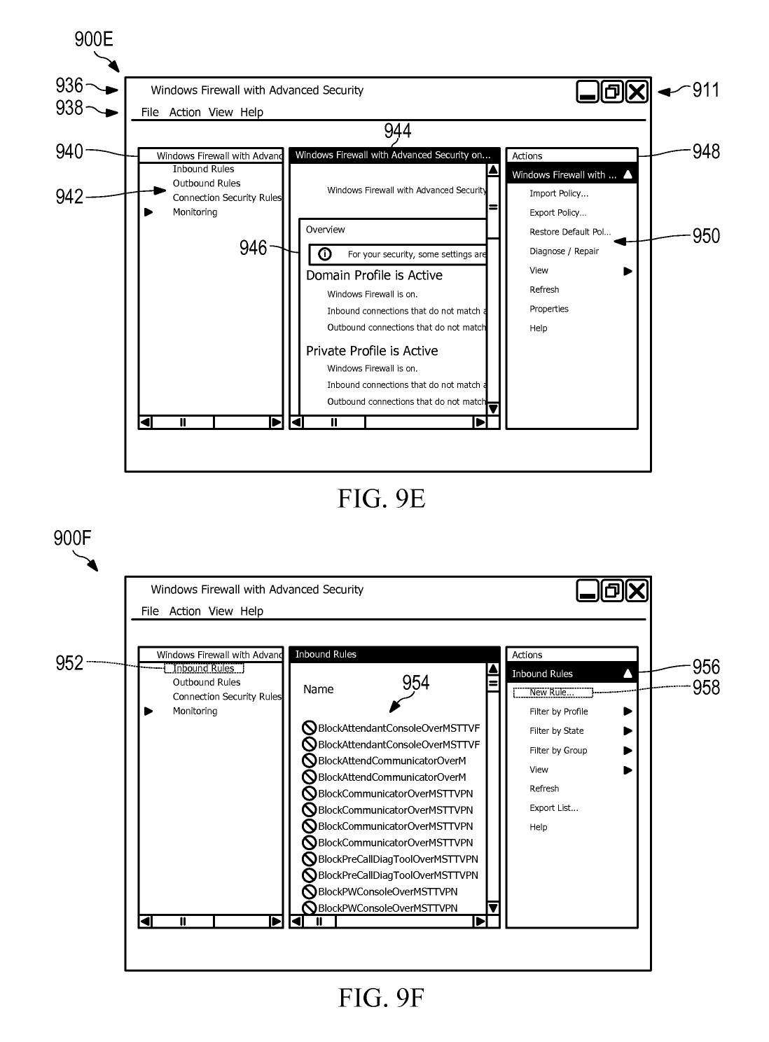

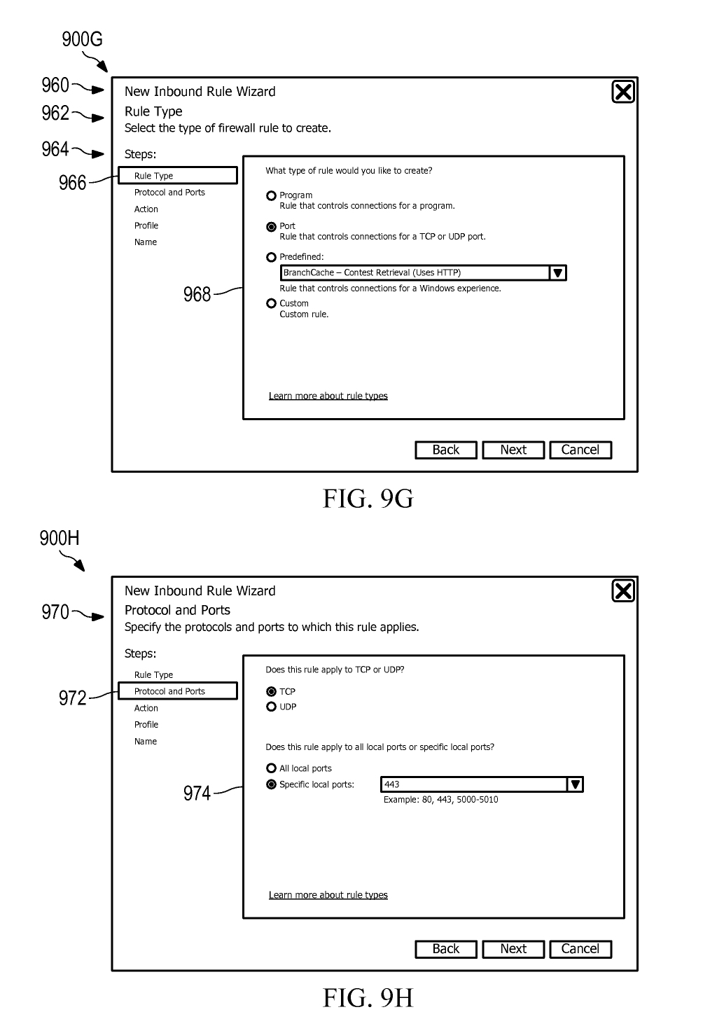

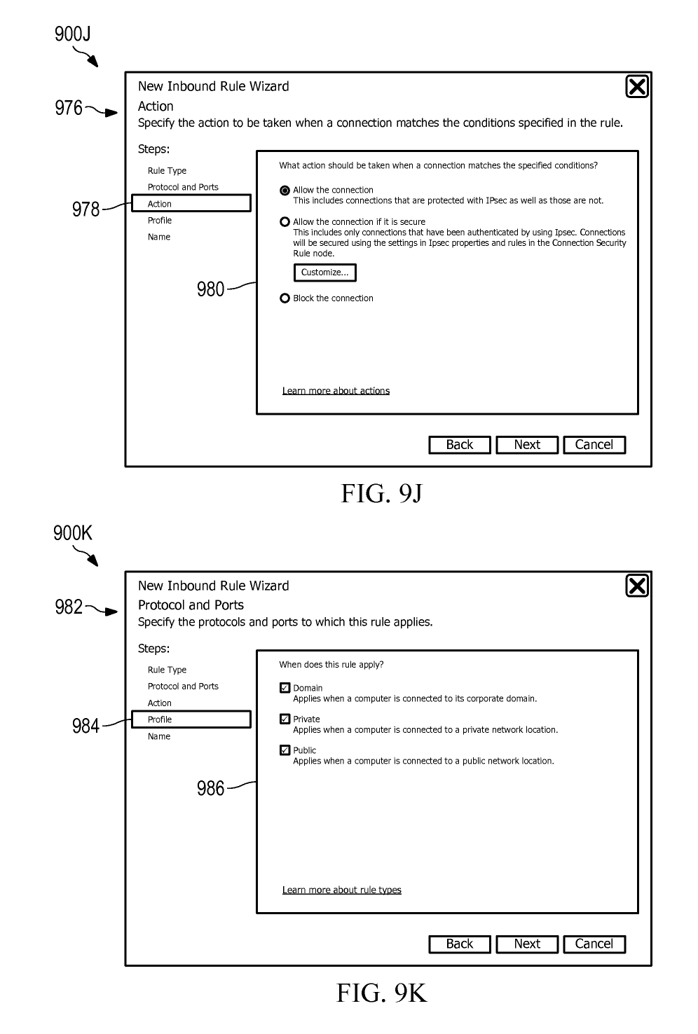

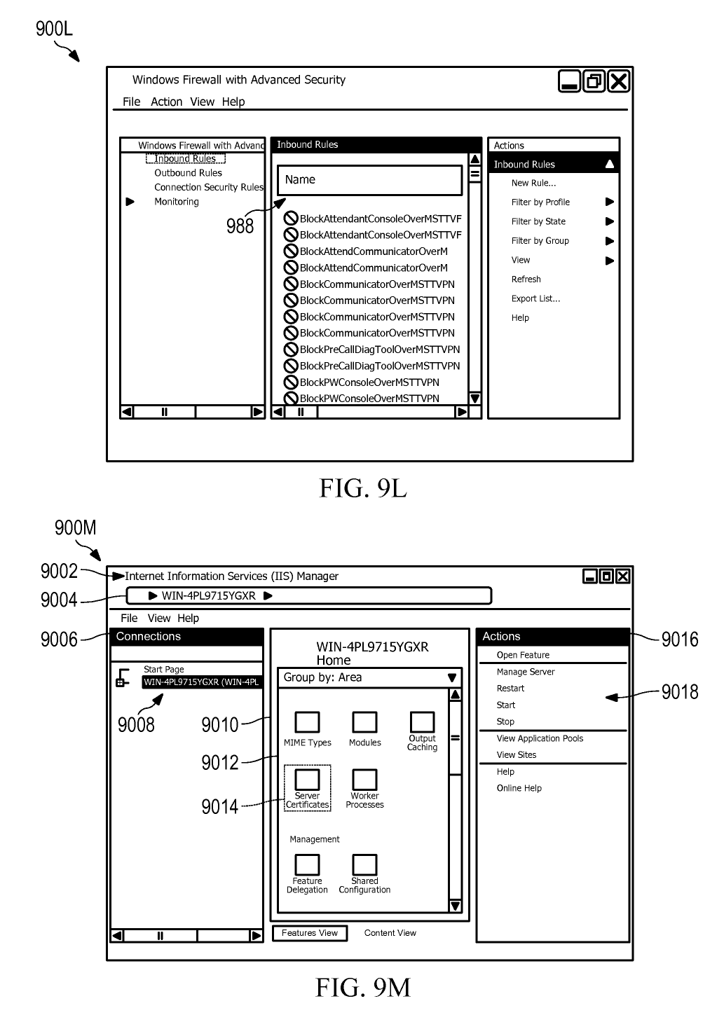

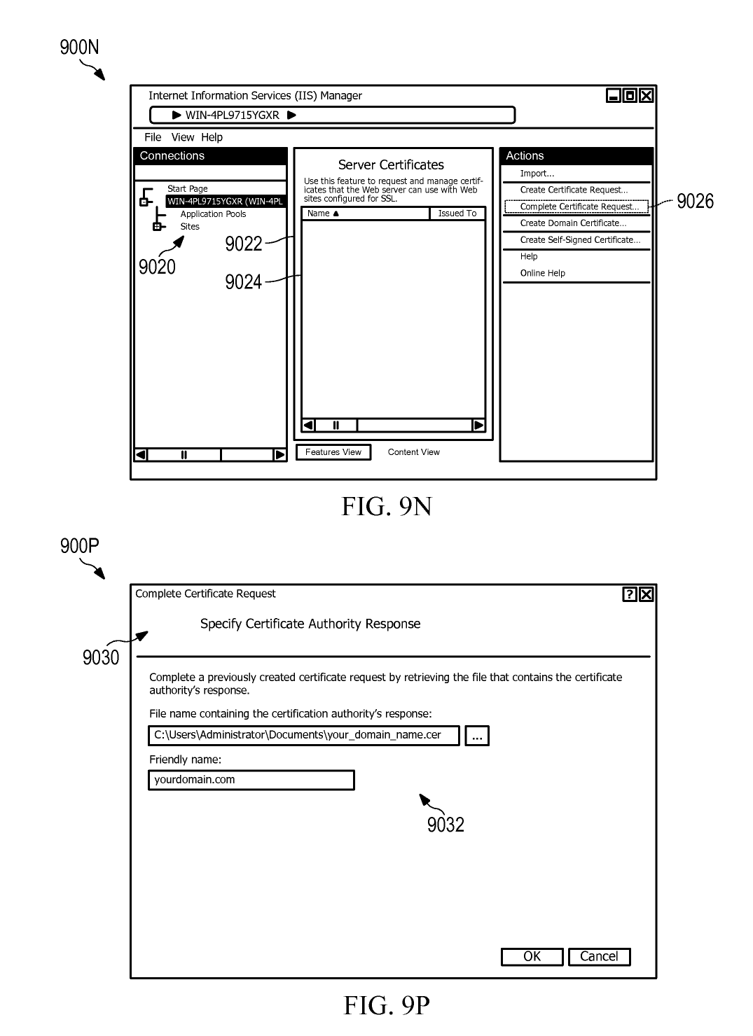

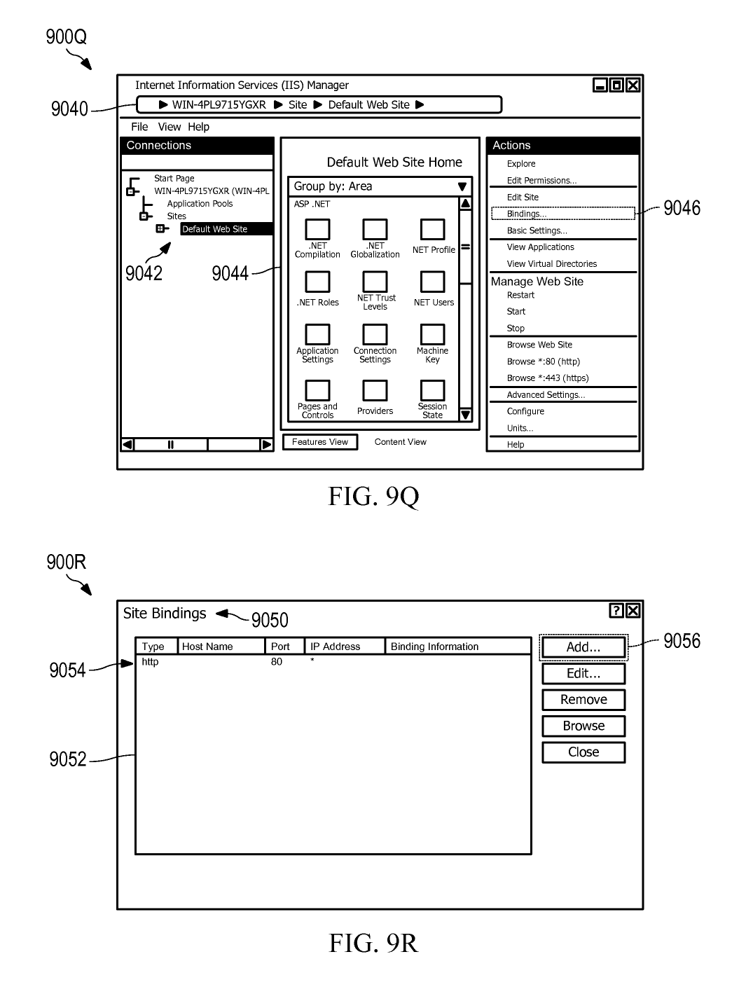

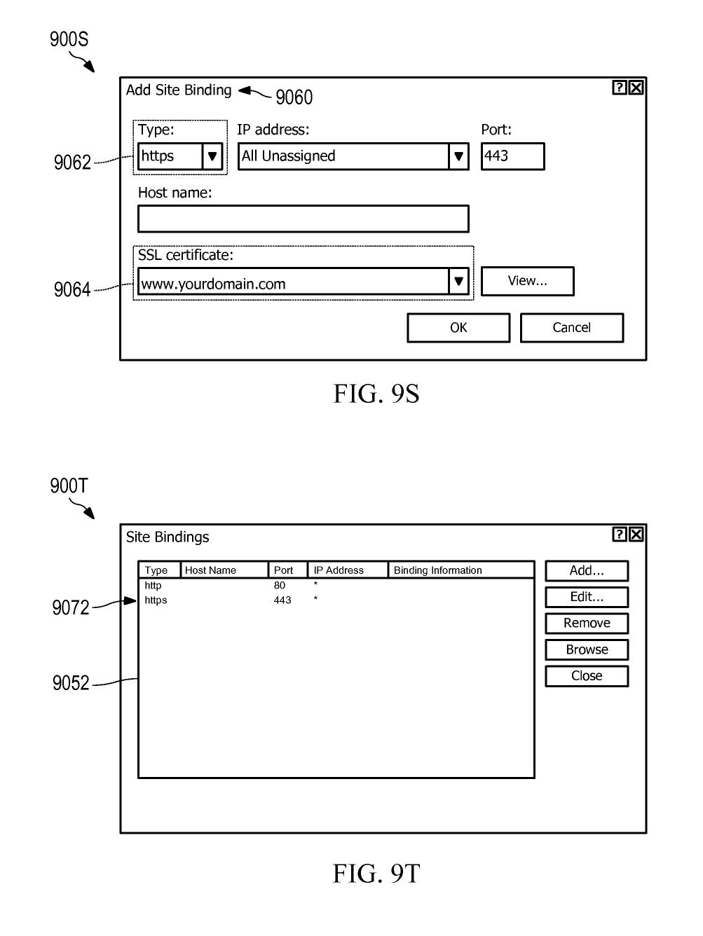

In FIG. 9A, an illustration of a display screen is shown, according to one embodiment. A first display image 900A may include a close button 901; a template title area 902; an account area 904; a deployment target area 906; an account to use for deployment menu 908; a redeploy application button 910; a deployment details area 912; a cancel button 903; a back button 905; a next button 907; and/or a finish button 909. In one example of the layering functionality, a developer may select an account for deployment, such as, new game one and then a deployment target. In this example, the application will deploy into an “Elastic Beanstalk” environment and create a load balancer and auto scaling group. Further, this will launch as a single EC2 instance and deploy the application. Therefore, in this example, the developer can start to create an overlay function which allows for one or more distinct platforms to be utilized to play one or more games where the one or more games would be incompatible which each other without the overlay function.

In FIG. 9B, another illustration of a display screen is shown, according to one embodiment. A second display image 900B may include an application title area 914; an application details area 916; an application version area 918; and/or an incremental deployment area 920. In this example, the application details may be stored, transmitted, modified, and/or compiled. For example, an application name may be Playverse developers and the application version may be v20140423161504. Further, an incremental deployment option may be selected which in this case may be utilized to automatically create a local Git repository to push only the changes made in the project to the “Elastic Beanstalk” environment.

In FIG. 9C, another illustration of a display screen is shown, according to one embodiment. A third image 900C may include an RDS database security group area 922; a selection message 924; a display area with multiple options 926; and/or one or more selection buttons 928. In this example, one or more security options may be utilized—a developer may select a default option, a development option, an instinct group option, and/or any other security option. In one example, when an overlay function is being developed for a first platform a first level of security is required. Whereas, when an overlay function is being developed for a second platform a second level of security is required.

In FIG. 9D, another illustration of a display screen is shown, according to one embodiment. A fourth image 900D may include a review area 930; a project details area 932; and/or one or more project implementation buttons 934. In this example, a review function is provided to review the settings before a deployment activity is implemented. In this example, an account (e.g., a new overlay for a game) may deploy an AWS Elastic Beanstalk using account “Trendy/AWS” into region ‘US East (Virginia) as a beta test for the new overlay for a game. The beta test may be deployed to any specific and/or predetermined accounts (e.g., voting members, funding members, loyal clients, a specific group—high usage, etc.).

In FIG. 9E, another illustration of a display screen is shown, according to one embodiment. A fifth image 900E may include a security area 936; a command area 938; a security options area 940 with various security options 942; a detailed security options area 944 with various detailed security options 946; and/or a security actions area 948 with various security actions 950. In another example, a developer may select one or more security options for one or more overlaying functionalities. There may be inbound rules, outbound rules, monitoring rules, criteria rules, exporting rules, importing rules, modification rules, etc.

In FIG. 9F, another illustration of a display screen is shown, according to one embodiment. A sixth image 900F may include an inbound rules security option 952 with detailed inbound rules 954; an inbound rules action area 956; and/or a new inbound rule option 958. In one example, a first overlay function for a game may have an inbound rules security option 952 with various detailed inbound rules 954 which may include a BlockAttendantConsoleOverMSTTVF option, a BlockAttendCommunicationOverM option, . . . , and/or a BlockPWConsoleOverMSTTVPN option. Any one of these options may be utilized to form a new inbound rule option 958. Further, a new inbound rule option 958 may be created/programmed utilizing the new inbound rule option 958.

In FIG. 9G, another illustration of a display screen is shown, according to one embodiment. A seventh image 900G may include a new inbound rule wizard title area 960; a rule type area 962; a step area 964; a rule type menu 966; and/or a detailed new rule area 968. In another example, a rule may have various types for an overlay functionality. In one example, the system, method, and/or device may have a program rule type, a port rule type, a predefined rule type, and/or a custom rule type. In one example, a program rule type may control connections for a program. In another example, a port rule type may control connections for a TCP or UDP port. Further, a predefined rule type may be rules that control connections for an environment experience. In addition, a custom rule may be a rule customized for the specific overlay functionality application.

In FIG. 9H, another illustration of a display screen is shown, according to one embodiment. An eighth image 900H may include a protocol and ports area 970; a protocol and ports option 972; and/or a detailed protocol and ports area 974. In one example, a rule may be applied to one or more ports—in this case a TCP or a UDP—which in this example, the TCP was selected. Further, the rule may be applied to all local ports or specific local ports—in this example, a specific local port (e.g., 443) was selected.

In FIG. 9J, another illustration of a display screen is shown, according to one embodiment. A ninth image 900J may include an action title area 976; an action option 978; and/or a detailed action area 980. In one example, an inbound rule may specify the action to be taken when a connection matches the conditions specified in the rule. In this example, when the connection matches the conditions specified in the rule, the system, method, and/or device allows the connection that are protected with IPsec as well as those that are not. In another example, the system, method, and/or device may have allowed the connection if the connection is secure—this includes only connections that have been authenticated by using Ipsec—connections will be secured using settings in Ipsec properties and rules in the connection security rule node. In another example, the connection could have been blocked.

In FIG. 9K, another illustration of a display screen is shown, according to one embodiment. A tenth image 900K may include a new rules title area 982; a profile option 984; and/or an applying the rule options area 986. In one example, an inbound rule profile may have various options. In this example, a first option is a domain option, a second option is a private option, and a third option is a public option. If the first option is selected, then the computing device is connected to a corporate domain. If the second option is selected, then the computing device is connected to a private network. If the third option is selected, then the computing device is connected to a public network.

In FIG. 9L, another illustration of a display screen is shown, according to one embodiment. An eleventh image 900L may include a name the rule area 988. In this example, a new rule for one or more overlaying functions may be created and named.

In FIG. 9M, another illustration of a display screen is shown, according to one embodiment. A twelfth image 900M may include an internet information services manager 9002; an address area 9004; a connections area 9006; a start page address 9008; a home area 9010; a group area 9012; one or more icons 9014; an action area 9016; and/or one or more action selections 9018. In one example, an overlaying function may have a starting page address 9008 which may be WIN-4PL9715YGXR. Further, the overlaying function may have a MIME types, modules, output caching, server certificates 9014, worker progress, and/or management modules such as feature delegation and shared configuration.

In FIG. 9N, another illustration of a display screen is shown, according to one embodiment. A thirteenth image 900N may include an application pools sites 9020; a server certificate area 9022; a list of serve certificates 9024; and/or a certificate action options 9026. In one example, a server certification may be used to request and manage certificates that the Web server can use with Web sites configured for SSL. In another example, a create certificate request option, a complete certificate request option, a create domain certificate option, a create self-signed certificate option, a help option, and/or an online help option may be utilized with one or more overlaying functionality features.

In FIG. 9P, another illustration of a display screen is shown, according to one embodiment. A fourteenth image 900P may include a certificate authority response area 9030 and a set-up details for the certificate authority response 9032. In one example, a complete a created certificate request may be implemented by retrieving the file that contained the certificate. This completed new certificate may be utilized with one or more overlaying functionalities and/or one or more platforms.

In FIG. 9Q, another illustration of a display screen is shown, according to one embodiment. A fifteenth image 900Q may include an Internet information services manager 9040; a default web site 9042; a default web site home 9044; and/or one or more action options 9046. In one example, one or more icons may be utilized with one or more overlaying functionalities. In various examples, a .Net compilation icon, a .Net globalization icon, a .Net Profile icon, a .Net roles icon, a .Net Trust levels icon, a .Net user's icon, an Application settings icon, a connection settings icon, a Machine Key icon, a pages and controls icon, a providers icon, and/or a session state icon may be utilizing with one or more overlaying functionalities and/or one or more gaming platforms.

In FIG. 9R, another illustration of a display screen is shown, according to one embodiment. A sixteenth image 900R may include a site bindings area 9050; a details site bindings area 9052; one or more site bindings criteria 9054; and/or one or more action buttons 9056. In one example, a developer may utilize a site binding action and/or functions with one or more overlaying functionalities and/or one or more gaming platforms.

In FIG. 9S, another illustration of a display screen is shown, according to one embodiment. A seventeenth image 900S may include an add site binding area 9060; a type menu 9062; and/or an SSL certificate area 9064. In one example, an add site binding action may be implemented via a type selection, an IP address selection, an SSL certification selection, and/or any other criteria selection for an overlaying function.

In FIG. 9T, another illustration of a display screen is shown, according to one embodiment. An eighteenth image 900T may include a site binding details area 9052 with one or more site binding characteristics 9072. In one example, a site binding option may be utilized for one or more overlaying functions and/or one or more gaming platforms. Therefore, in these examples in FIGS. 9A-9T, the developer can start to create an overlay function which allows for one or more distinct platforms to be utilized to play one or more games where the one or more games would be incompatible which each other without the overlay function (e.g., Playverse).

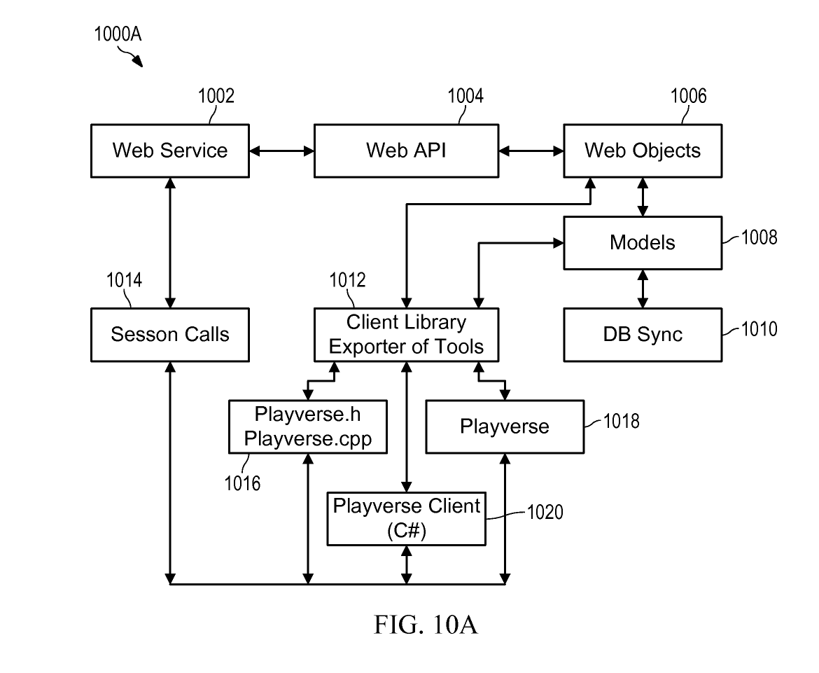

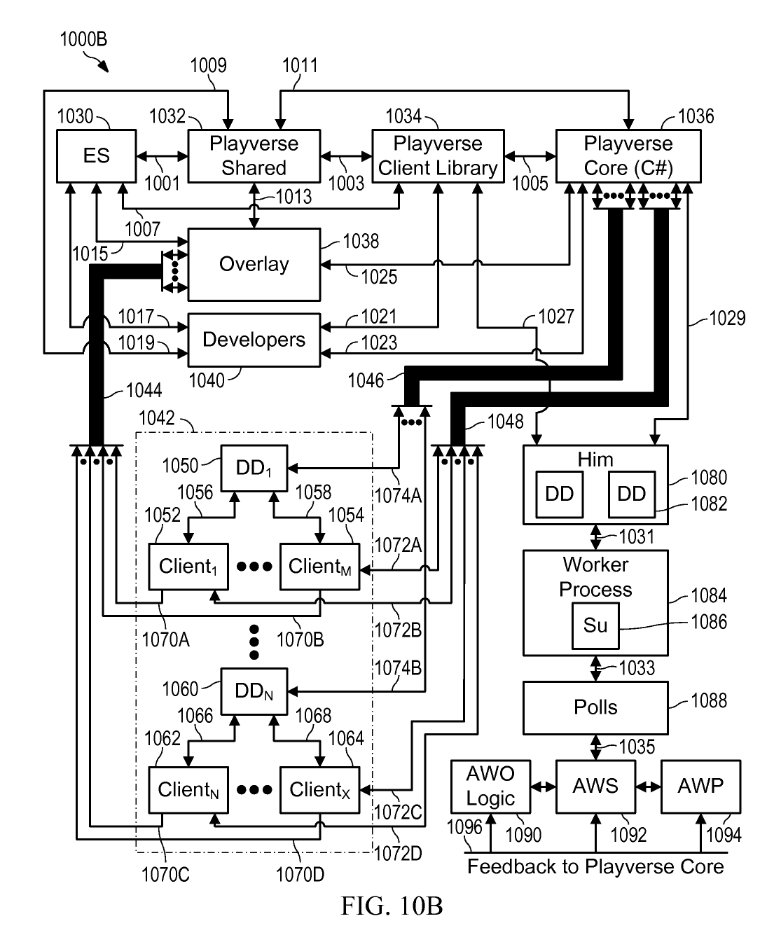

In FIG. 10A, a block illustration is shown, according to one embodiment. A first block diagram 1000A may include a web service 1002; web API 1004; web objects 1006; models 1008; a DB sync 1010; a client library exporter of tools 1012; sesson calls 1014; a playverse.h plarverse.cpp 1016; a playverse 1018; and/or playverse client 1020. In various examples, these modules, services, and/or tools may be utilized with one or more overlaying functionalities and/or one or more gaming platforms.

In FIG. 10B, another block illustration is shown, according to one embodiment. A second block diagram 1000B may include an ES 1030; a playverse shared 1032; a playverse client library 1034; a playverse core 1036; an overlay 1038; a developers 1040; a DD1 1050, . . . , a DDN 1060; a Client1 1052 relating to DD1, . . . , a ClientM 1054 relating to DD1; a ClientN relating to DDN 1062, . . . , a ClientX relating to DDN 1064; a Him 1080, one or more DD relating to Him 1082; a worker process 1084 with an Su 1086; a polls 1088; an AWO logic 1090; an AWS 1092; an AWP 1094; and/or various feedback module to playverse core 1096. In various examples, one or more of the list modules and/or devices shown in FIG. 10B may communicate with each other via one or more communication links (reference numbers 1001, 1003, 1005, 1007, 1009, 1011, 1013, 1015, 1017, 1019, 1021, 1023, 1025, 1027, 1029, 1031, 1033, 1035, 1044, 1046, 1048, 1056, 1058, 1066, 1068, 1070A, 1070B, 1070C, 1070D, 1072A, 1072B, 1072C, 1072D, 1074A, and/or 1074B) which may be wired, wireless, and/or a combination thereof. In various examples, these modules, services, and/or tools may be utilized with one or more overlaying functionalities and/or one or more gaming platforms.

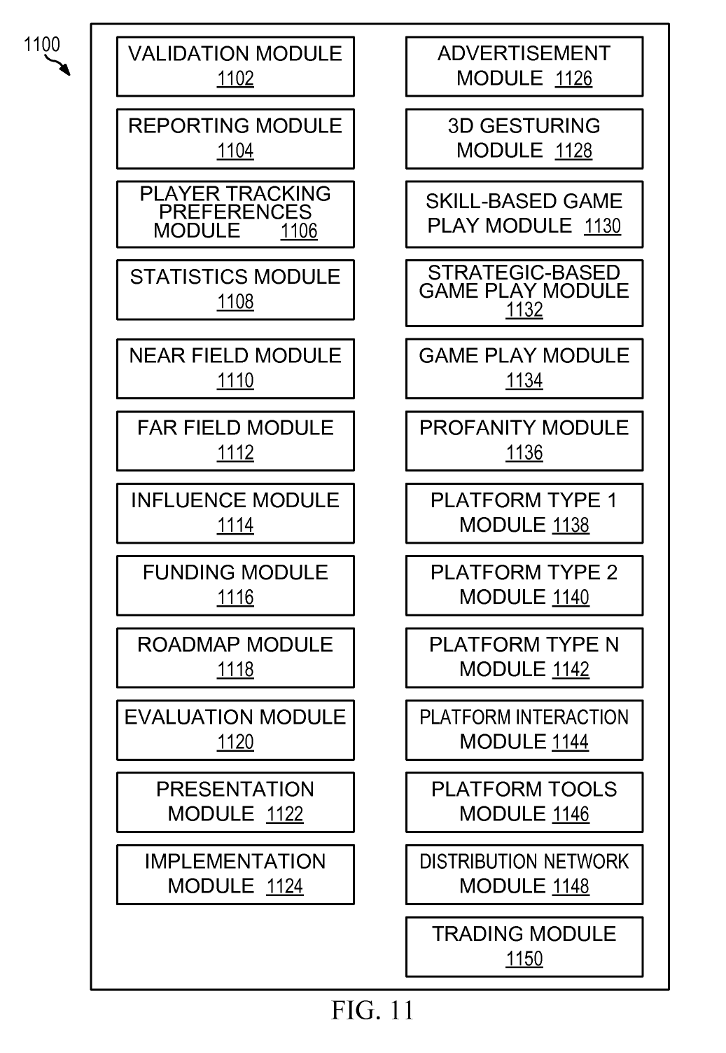

In FIG. 11, a block illustration is shown, according to one embodiment. A first block diagram 1100 may include a validation module 1102; a reporting module 1104; a player tracking preferences module 1106; a statistics module 1108; a near field module 1110; a far field module 1112; an influence module 1114; a funding module 1116; a roadmap module 1118; an evaluation module 1120; a presentation module 1122; an implementation module 1124; an advertisement module 1126; a 3D gesturing module 1128; a skill-based game play module 1130; a strategic-based game play module 1132; a game play module 1134; a profanity module 1136; a platform type 1 module 1138; a platform type 2 module 1140; . . . ; a platform type N module 1142; a platform interaction module 1144; a platform tools module 1146; a distribution network module 1148, and/or a trading module 1150.

Validation module 1102 may validate one or more gaming functions, one or more player functions, player data, gaming data, and/or any other data. Further, validation module 1102 may transmit, compile, store, and/or receiving any validation related data.

Reporting module 1104 may receive, transmit, compile, store, and/or generate one or more reports relating to any data within this disclosure.

Player tracking preferences module 1106 may receive, transmit, compile, and/or store any player preference data (e.g., language, sound level, display configuration, etc.).

Statistics module 1108 may receive, transmit, compile, and/or store data relating to player usage, game play, funding activity, voting activity, platform activity, overlay activity, and/or any other data.

Near field module 1110 may receive, transmit, compile, and/or store data relating to near field usage.

Far field module 1112 may receive, transmit, compile, and/or store data relating to far field usage.

Influence module 1114 may receive, transmit, compile, and/or store data relating to any voting activity.

Funding module 1116 may receive, transmit, compile, and/or store data relating to any funding activity.

Roadmap module 1118 may receive, transmit, compile, and/or store data relating to any project roadmap.

Evaluation module 1120 may receive, transmit, compile, and/or store data relating to any project evaluation, game evaluation, player evaluation, funding evaluation, voting evaluation, and/or any other evaluation.

Presentation module 1122 may receive, transmit, compile, and/or store data relating to any presentation.

Implementation module 1124 may receive, transmit, compile, and/or store data relating to any project, game, product, and/or any other implementation.

Advertisement module 1126 may receive, transmit, compile, and/or store data relating to any advertisement.

3D gesturing module 1128 may receive, transmit, compile, and/or store data relating to any 3D gesturing function.

Skill-based game play module 1130 may receive, transmit, compile, and/or store data relating to any skill based gaming function.

Strategic-based game play module 1132 may receive, transmit, compile, and/or store data relating to any strategic based gaming function.

Game play module 1134 may receive, transmit, compile, and/or store data relating to any gaming function.

Profanity module 1136 may receive, transmit, compile, and/or store data relating to any profanity function.

Platform type 1 module 1138 may receive, transmit, compile, and/or store data relating to any activity on platform type 1.

Platform type 2 module 1140 may receive, transmit, compile, and/or store data relating to any activity on platform type 2.

Platform type N module 1142 may receive, transmit, compile, and/or store data relating to any activity on platform type N.

Platform interaction module 1144 may receive, transmit, compile, and/or store data relating to any platform interaction.

Platform tools module 1146 may receive, transmit, compile, and/or store data relating to any activity relating to the utilization of platform tools.

Distribution network module 1148 may receive, transmit, compile, and/or store data relating to any activity on the distribution network.

Trading module 1150 may receive, transmit, compile, and/or store data relating to any trading activity.

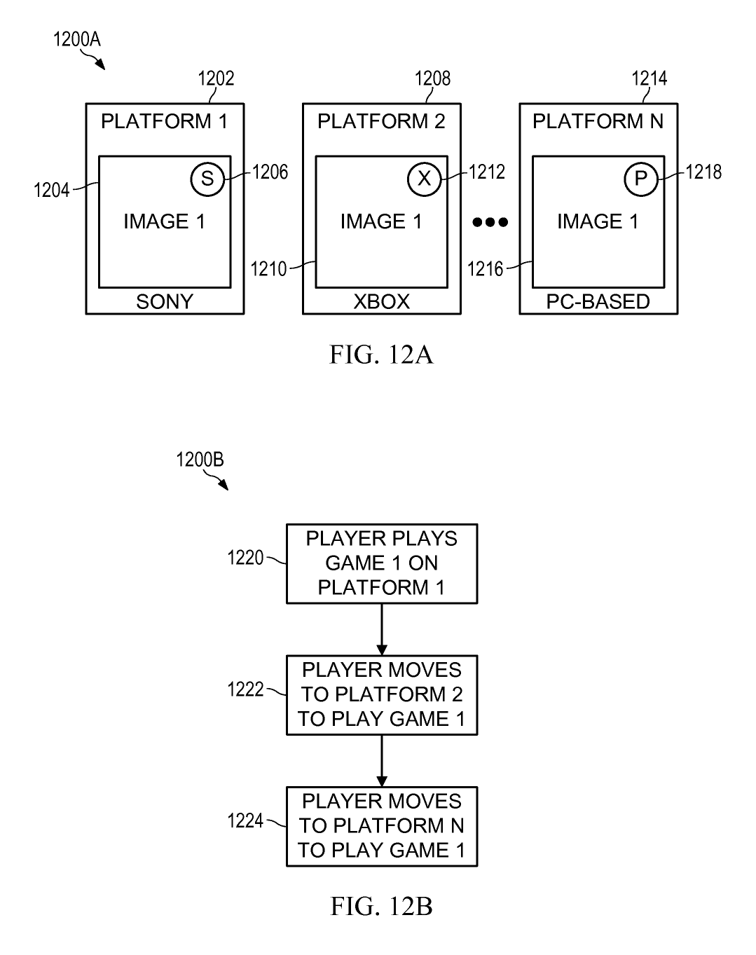

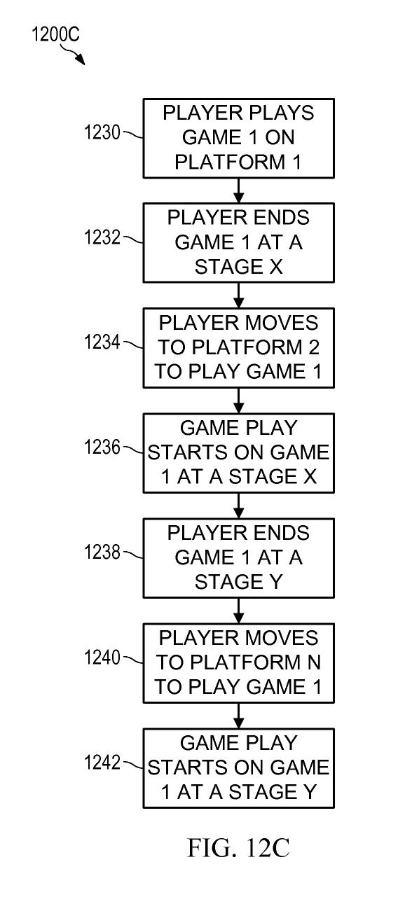

In FIG. 12A, a multi-platform image is shown, according to one embodiment. A first multi-platform image 1200A may include a first platform game 1202; a second platform game 1208; . . . ; an Nth platform game 1214. The first platform gaming system 1202 may include a first display screen 1204 with a first system indicator symbol 1206. The second platform game system 1208 may include a second display screen 1210 with a second system indicator symbol 1212. In addition, the Nth platform game system 1214 may include an Nth display screen 1216 with an Nth system indicator symbol 1218. In one example, a player on the first platform gaming system 1202 may be playing a game that was originally designed for a second gaming platform which may be indicated by the first system indicator symbol 1206. In other words, a player playing on a first platform may be playing a game designed for a second platform via one or more overlaying functionalities and the system, device, and/or method indicates this by displaying a second platform symbol in the first system indicator symbol 1206. In addition, a player on the second platform gaming system 1208 may be playing a game that was originally designed for a third gaming platform which may be indicated by the second system indicator symbol 1212. Further, a player on the Nth platform gaming system 1214 may be playing a game that was originally designed for a first gaming platform which may be indicated by the Nth system indicator symbol 1218.

In FIG. 12B, a multi-platform flow diagram is shown, according to one embodiment. A method 1200B may include a player playing a first game on a first platform (step 1220); the player moving to the second platform to play the first game (step 1222); and/or the player moving to an Nth platform to play the first game (step 1224). In one example, a player may play a first game on any platform (e.g., 1 to N) and then move to a second platform. For example, a player may start on a PC playing the first game and then move to a first console type to continue playing the first game and then move to a mobile device to continue playing the first game. In a more specific example, a player may be playing a first game on a PC because someone else is using the first console type to watch a movie. Once the movie is over, the first console type is free and the player moves over to the first console type to continue playing the first game. However, the player needs to leave the house with his family so the player transfers over to a mobile device to continue to play the first game.

In FIG. 12C, another multi-platform flow diagram is shown, according to one embodiment. A method 1200C may include a player playing a first game on a first platform (step 1230); a player ending the first game at a stage X on a first platform (step 1232); a player moving to the second platform to play the first game on the second platform (step 1234); game play starting on a first game at the X stage of the first game on the second platform (step 1236); the player ending the first game at a stage Y on the second platform (step 1238); the player moving to an Nth platform to continue playing the first game (step 1240); and/or starting game play on the first game at the Y stage of the first game on the Nth platform (step 1242). For example, a player may start to play a first game on a mobile device at a location outside of the home and then when the player reaches his home he stops playing the first game at a stage X to move over to a first console type to continue playing the first game which would begin at stage X because the screen is bigger and/or the controls are better and/or for any other reason. Then, the player's relatives wants to utilize the first console type to watch a movie which requires the player to move to a third platform (e.g., a PC) to continue playing the first game at a stage Y which is where the player stopped playing the first game on the second platform (e.g., first console type).

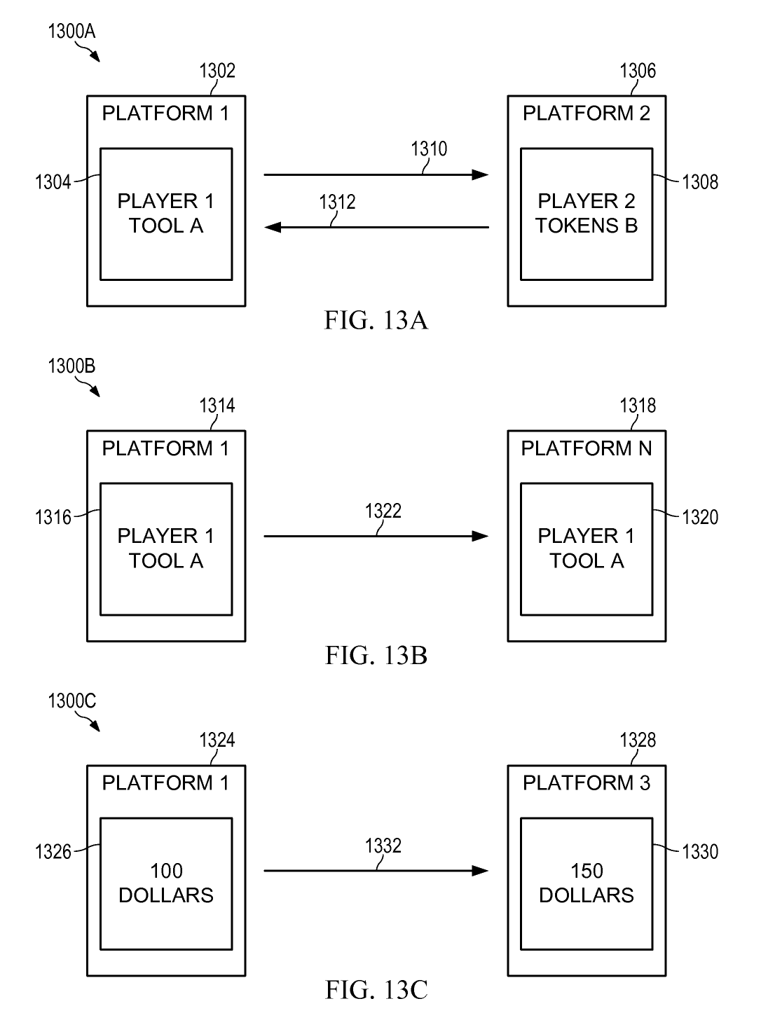

In FIG. 13A, a multi-platform image is shown, according to one embodiment. A first multi-platform image 1300A may include a first platform 1302 with a first item 1304 (e.g., a first player tool A) and a second platform 1306 with a second item 1308 (e.g., a second player tokens B). In this example, the first player transfers 1310 to the second player the first item 1304 based on the second player transferring 1312 the second item 1308 to the first player. In one example, the first player may barter with a second player relating to one or more items. For example, the first player may trade an item (e.g., a weapon, a map, a tool, tokens, gold, currency, secrets, awards, achievements, etc.) with a second player for any item (e.g., a weapon, a map, a tool, tokens, gold, currency, secrets, awards, achievements, etc.) where the items to be traded can be across one or more platforms. For example, a first weapon may only works on a game created for the second platform which is traded for a tool which may only works on a game created for the first platform and the second platform.

In FIG. 13B, another multi-platform image is shown, according to one embodiment. A second multi-platform image 1300B may include a first platform 1314 with a first item 1316 (e.g., a first player tool A) and an Nth platform 1318 with a transferred 1322 first item 1320 on the Nth platform 1318. In one example, a first action game may have five tools when played on a first platform but the same first action game may have four tools when played on a second platform. However, utilizing the one or more overlaying functionalities of this disclosure the first action game would have five tools no matter what platform the player was playing on. Therefore, the player may barter with a player that cannot use the fifth tool because his is on the second platform and is not utilizing the one or more overlaying functionalities for a reduced price because the fifth tool is of little value to the player because he cannot use it.

In FIG. 13C, another multi-platform image is shown, according to one embodiment. A third multi-platform image 1300C may include a first platform 1324 with a first item 1326 (e.g., $100) and a third platform 1328 with a second transferred item 1330 (e.g., $150) on third platform 1328. In this example, a player may transfer 1332 a first platform currency (e.g., $100) from a first platform 1324 to a third platform 1328 where the currency is now worth $150 in currency on third platform 1328. In this example, currencies on different platforms may have varying worth—on a first platform a first tool may cost $10 but on a second platform the first tool may cost $50.

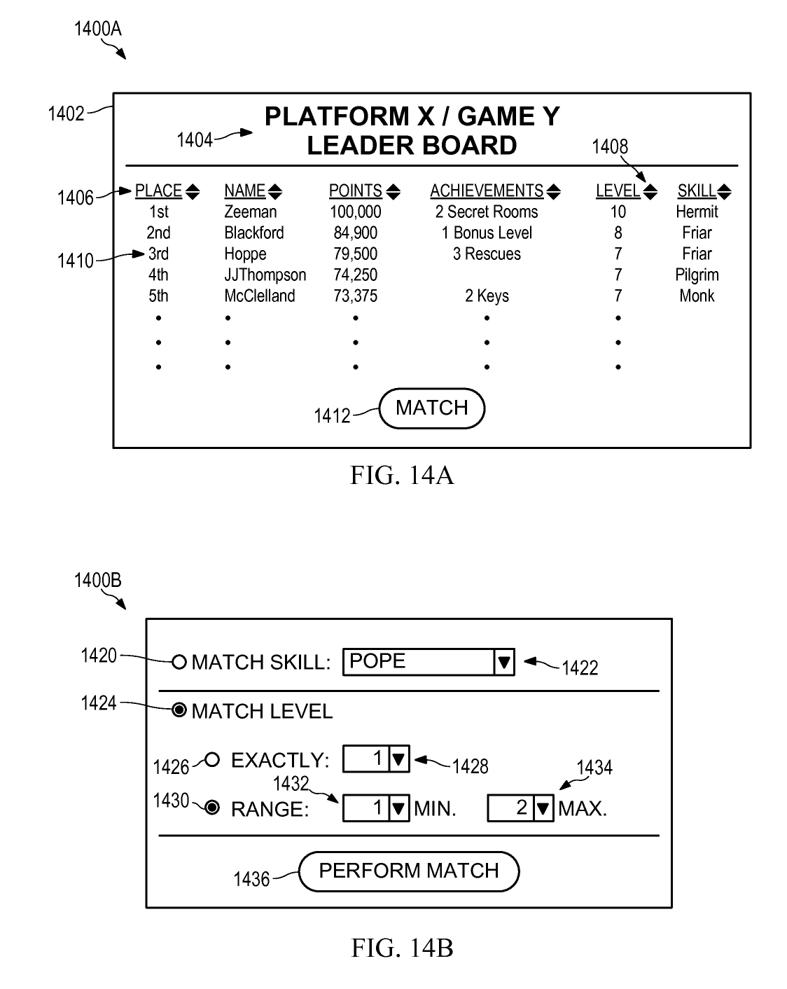

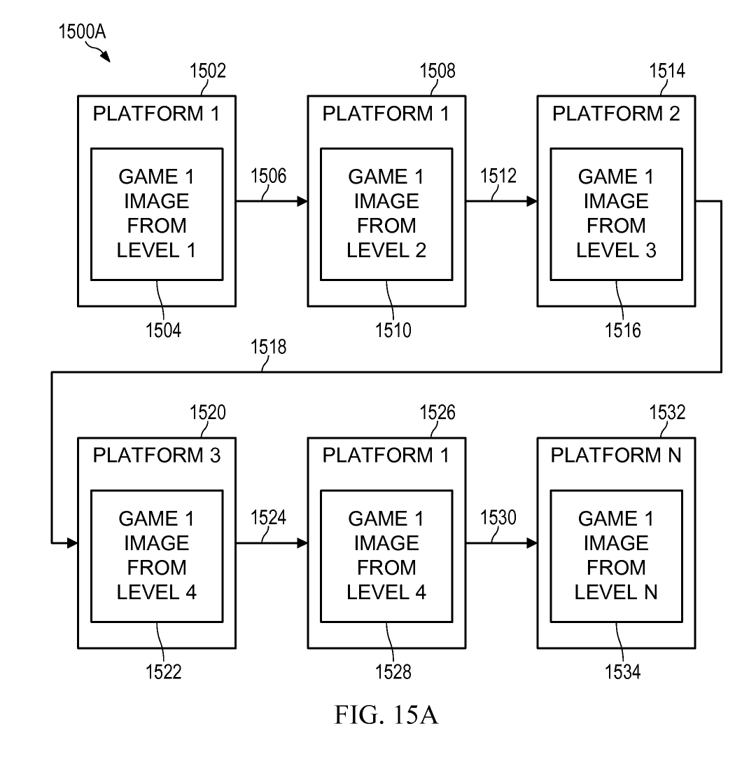

In FIG. 14A, a multi-platform image is shown, according to one embodiment. A leaderboard image 1400A may include a leaderboard 1402; a leaderboard title 1404; a ranking area 1406; one or more rankings 1410; one or more sorting buttons 1408; and/or a match button 1412. In one example, the leaderboard may show only a specific game on a specific platform (e.g., platform X game Y leaderboard). In another example, the leaderboard may show a game on all platforms, a plurality of games on all platforms, a plurality of games on a plurality of platforms, and/or all games on all platforms. The leaderboard may show one or more ranking positions (e.g., 1 to N), the players' names, one or more points, one or more achievements, one or more levels, and/or one or more skill levels for one or more individuals and/or groups.

In FIG. 14B, another multi-platform image is shown, according to one embodiment. A matching image 1400B may include a match skill button 1420; a match skill drop down menu 1422; a match level button 1424; an exactly match button 1426; an exactly match drop down menu 1428; a range match button 1430; a low level range drop down menu 1432; a high level range drop down menu 1434; and/or a perform match button 1436. In one example, the match skill button 1420 may be utilized to find player of equal skill level to a player. This may be utilized to compete against the other player and/or to recruit the other player for a team. Further, the skill level may be match exactly and/or within a range of skills from the player's current skill level. If a player was ranked a 5 skill level, the player may search for players with the exact same skill level of 5 or the player may search for players with a skill level from 4 to 6, 5 to 7, 3 to 5, etc. Further, the player may search for individuals that are better than him so the search may be for players with a skill level of 6 to 8, 6-10, 7-8, etc. The player may initiate the search by selecting perform match button 1436.

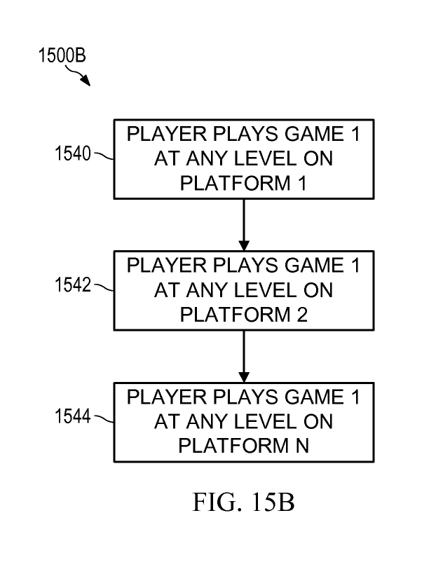

In FIG. 15A, another multi-platform image is shown, according to one embodiment. In one example, a first game image from a first level 1504 may be displayed on a first platform 1502 and then a first game image from a second level 1510 is displayed on a first platform 1508. In addition, a first game image from a third level 1516 is displayed on a second platform 1514 and then a first game image from a fourth level 1522 is displayed on a third platform 1520. Further, a first game image from a fourth level 1528 is displayed on a first platform 1526 and then a first game image from an Nth level 1534 is displayed on an Nth platform 1532. In one example, the player may play a first game on a first platform at a first level and then at a second level on the same first gaming platform. The player may then move to a second platform and play the game at a third level and then play the game at a fourth level on a third platform and then play the game at the fourth level on a first platform and then play the game at an Nth level on an Nth platform utilizing the overlaying functionality of this disclosure.

In FIG. 15B, a multi-platform flow diagram is shown, according to one embodiment. A method 1500B may include a player playing a first game at any level on a first platform (step 1540): a player playing a first game at any level on a second platform (step 1542); and/or a player playing a first game at any level on an Nth platform (step 1544). In one example, the player plays a first game at any level on a first platform using one or more overlaying functionalities and then plays the first game at any level on a second platform and/or an Nth platform.

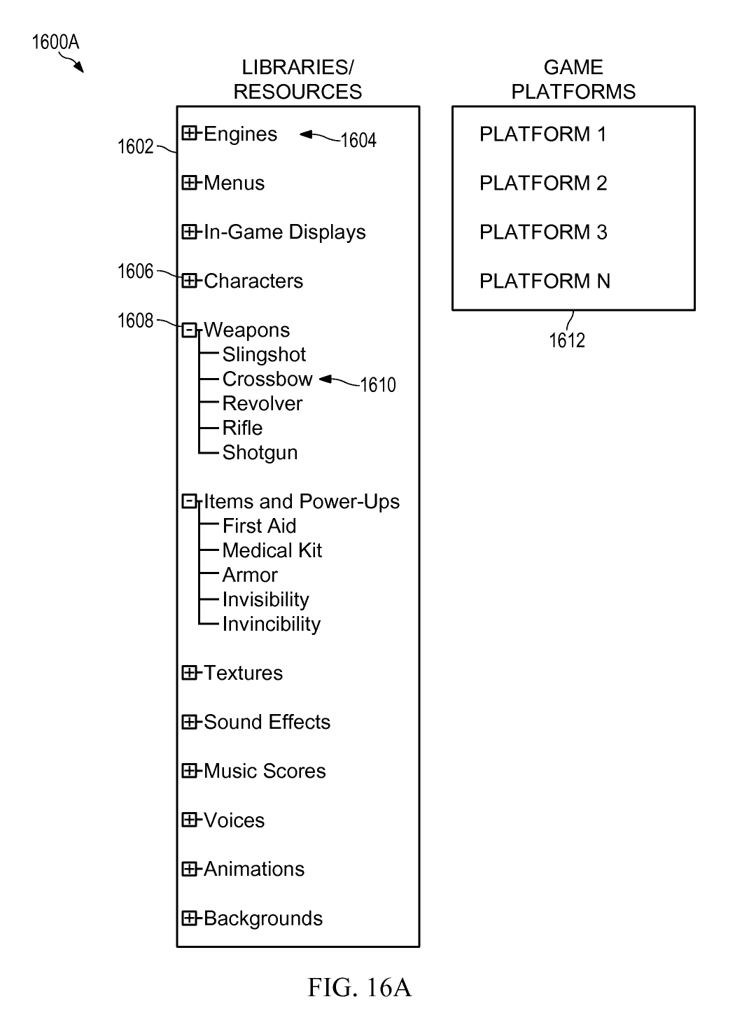

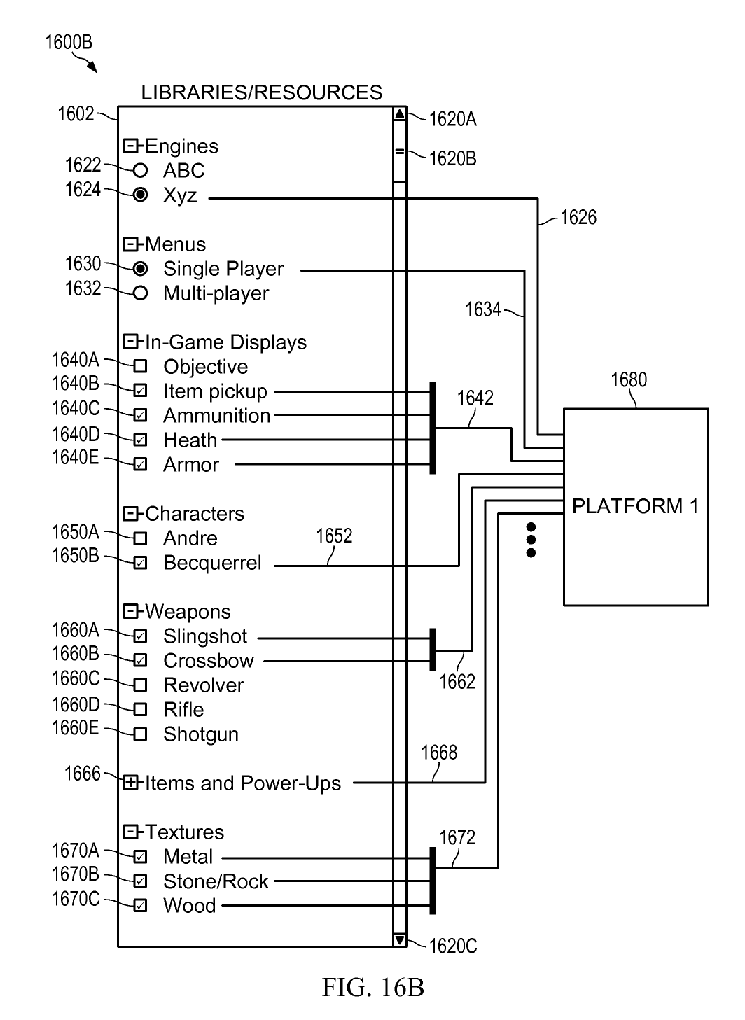

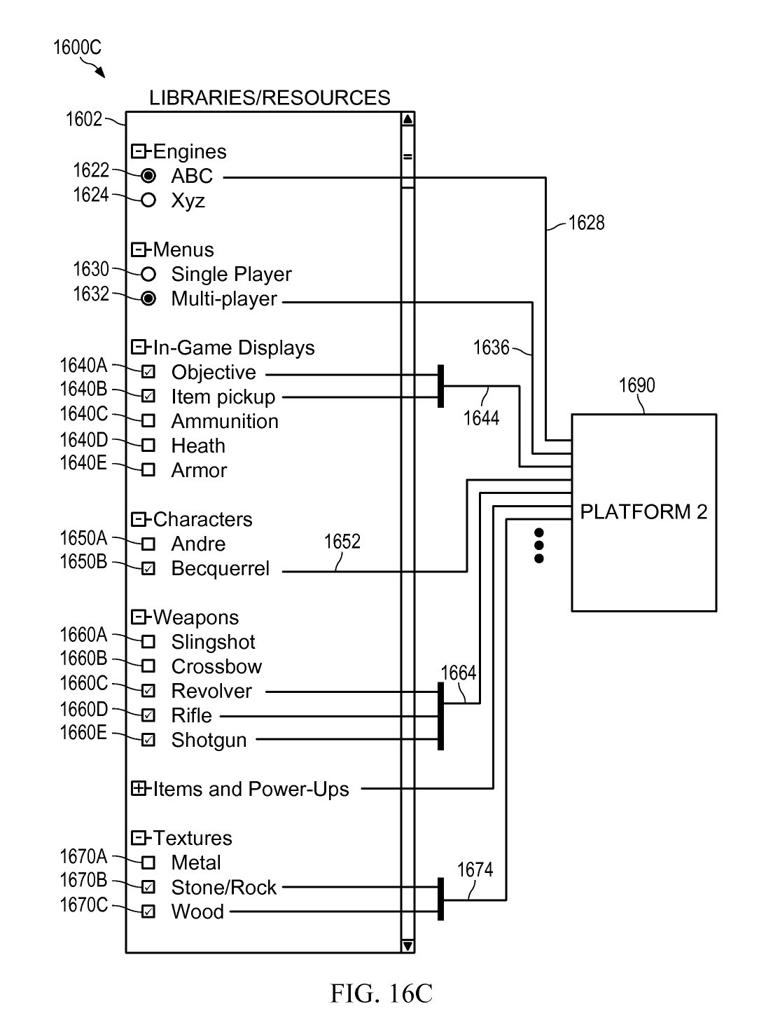

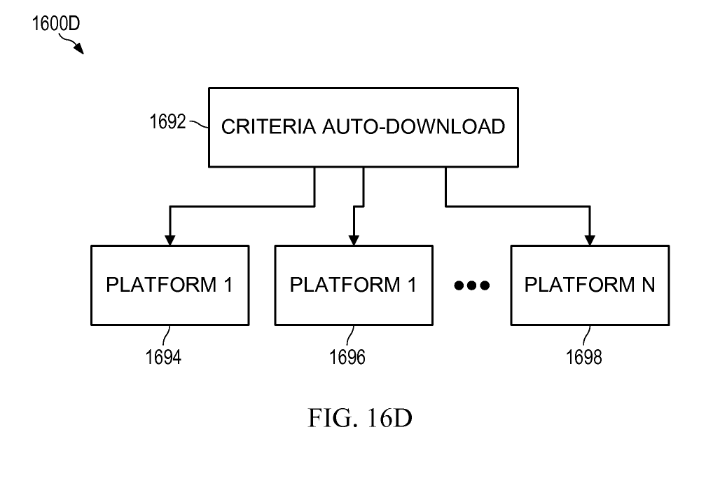

In FIG. 16A, a multi-platform image is shown, according to one embodiment. A first library image 1600A may include a library resources area 1602 which may include one or more library options 1606. In this example, the one or more library options 1606 (e.g., reference numbers 1608, etc.) may be engines, menus, in-game displays, characters, weapons, items and power-ups, textures, sound effects, music scores, voices, animations, backgrounds, and/or any other library criteria. In one example, a weapons option 1608 may include one or more weapon options (e.g., a slingshot, crossbow, revolver, rifle, shotgun, etc.). In another example, the items and power-ups may include one or more power-up options (e.g., first aid, medical fit, armor, invisibility, invincibility, etc.). The first library image 1600A may include one or more game platforms 1612 (e.g., a first platform, a second platform, a third platform, . . . , an Nth platform). In one example, a developer may utilize one or more of these options to build a new game for one or more platforms and/or to build an interface for an existing game (on one or more platforms) to be compatible with the other platforms (e.g., one or more other platforms).

In FIG. 16B, another multi-platform image is shown, according to one embodiment. A second library image 1600B may include library resources area 1602 which has one or more engine options (e.g., reference numbers 1622, 1624, etc.). In this example, there are two engine options (however any number may be utilized—1 to N). A first engine option 1622 is an ABC system and a second engine option 1624 is an XYZ system. Various libraries resources may be implemented into a first platform 1680. In this example, second engine option 1624 was utilized 1626 for the first platform 1680. In this example, there are two menu options (reference numbers 1630 and 1632—any number could have been utilized from 1 to N). A first menu option 1630 is a single player configuration and a second menu option 1632 is a multi-player configuration. In this example, the single player configuration (e.g., first menu option 1630) was utilized 1634 for the first platform 1680. In this example, there are five in game display options (reference numbers 1640A, 1640B, 1640C, 1640D, and 1640E—but any number from 1 to N could have been utilized). A first in game display option 1640A may be an objective. A second in game display option 1640B may be an item pickup. A third in game display option 1640C may be an ammunition configuration. A fourth in game display option 1640D may be a health configuration. A fifth in game display option 1640E may be an armor configuration. In this example, a second in game display option 1640B, a third in game display option 1640C, a fourth in game display option 1640D, and a fifth in game display option 1640E were utilized 1642 for the first platform 1680. In this example, there are two character options (reference numbers 1650A and 1650B—any number could have been utilized from 1 to N). A first character option 1650A is an Andre configuration and a second character option 1650B is a Becquerrel configuration. In this example, the second character option 1650B was utilized 1652 for the first platform 1680. In this example, there are five weapon options (reference numbers 1660A, 1660B, 1660C, 1660D, and 1660E—any number could have be utilized from 1 to N). In this example, a first weapon option 1660A is a slingshot, a second weapon option 1660B is a crossbow, a third weapon option 1660C is a revolver, a fourth weapon option 1660D is a rifle, and a fifth weapon option is a shotgun. In this example, a first weapon option 1660A and a second weapon option 1660B were utilized 1662 for the first platform 1680. In this example, one or more items and power ups 1666 were utilized 1668 (in this case all of the items were selected—therefore if there were 1 to N items—N items were utilized for first platform 1680) for the first platform 1680. In this example, three texture options (reference numbers 1670A, 1670B, and 1670C or from 1 to N) are available for use with first platform 1680. In this example, a first texture option 1670A is a metal texture, a second texture option 1670B is a stone/rock texture, and a third texture option 1670C is a wood texture. In this example, all three of the texture options were utilized 1672 for first platform 1680. In addition, the library resources may have an up menu arrow 1620A, a sliding menu indicator 1620B, and/or a down menu arrow 1620C.

In FIG. 16C, another multi-platform image is shown, according to one embodiment. A third library image 1600C may include library resources area 1602 which has one or more engine options (e.g., reference numbers 1622, 1624, etc.). In this example, there are two engine options (however any number may be utilized—1 to N). A first engine option 1622 is an ABC system and a second engine option 1624 is an XYZ system. Various libraries resources may be implemented into a second platform 1690. In this example, first engine option 1622 was utilized 1628 for the first platform 1680. In this example, there are two menu options (reference numbers 1630 and 1632—any number could have been utilized from 1 to N). A first menu option 1630 is a single player configuration and a second menu option 1632 is a multi-player configuration. In this example, the multi-player configuration (e.g., second menu option 1632) was utilized 1636 for the second platform 1690. In this example, there are five in game display options (reference numbers 1640A, 1640B, 1640C, 1640D, and 1640E—but any number from 1 to N could have been utilized). A first in game display option 1640A may be an objective. A second in game display option 1640B may be an item pickup. A third in game display option 1640C may be an ammunition configuration. A fourth in game display option 1640D may be a health configuration. A fifth in game display option 1640E may be an armor configuration. In this example, a first in game display option 1640A and a second in game display option 1640B were utilized 1644 for the second platform 1690. In this example, there are two character options (reference numbers 1650A and 1650B—any number could have been utilized from 1 to N). A first character option 1650A is an Andre configuration and a second character option 1650B is a Becquerrel configuration. In this example, the second character option 1650B was utilized 1652 for the second platform 1690. In this example, there are five weapon options (reference numbers 1660A, 1660B, 1660C, 1660D, and 1660E—any number could have be utilized from 1 to N). In this example, a first weapon option 1660A is a slingshot, a second weapon option 1660B is a crossbow, a third weapon option 1660C is a revolver, a fourth weapon option 1660D is a rifle, and a fifth weapon option is a shotgun. In this example, a third weapon option 1660C, a fourth weapon option 1660D, and a fifth weapon option 1660E were utilized 1664 for the second platform 1690. In this example, one or more items and power ups 1666 were utilized 1668 (in this case all of the items were selected—therefore if there were 1 to N items—N items were utilized for first platform 1680) for the second platform 1690. In this example, three texture options (reference numbers 1670A, 1670B, and 1670C or from 1 to N) are available for use with second platform 1690. In this example, a first texture option 1670A is a metal texture, a second texture option 1670B is a stone/rock texture, and a third texture option 1670C is a wood texture. In this example, a second texture option 1670B and a third texture option 1670C were utilized 1674 for second platform 1690.

In FIG. 16D, another multi-platform image is shown, according to one embodiment. A download platform image 1600D may include one or more criteria auto-downloading functions 1692, a first platform 1694, a second platform 1696, . . . , and/or an Nth platform 1698. In one example, an updated overlay structure, an updated tool, an updated weapon, any update to the gaming structure, and/or any other platform update, and/or interface update may be automatically sent out to one or more platforms and/or one or more interfaces, and/or one or more overlaying functionalities.

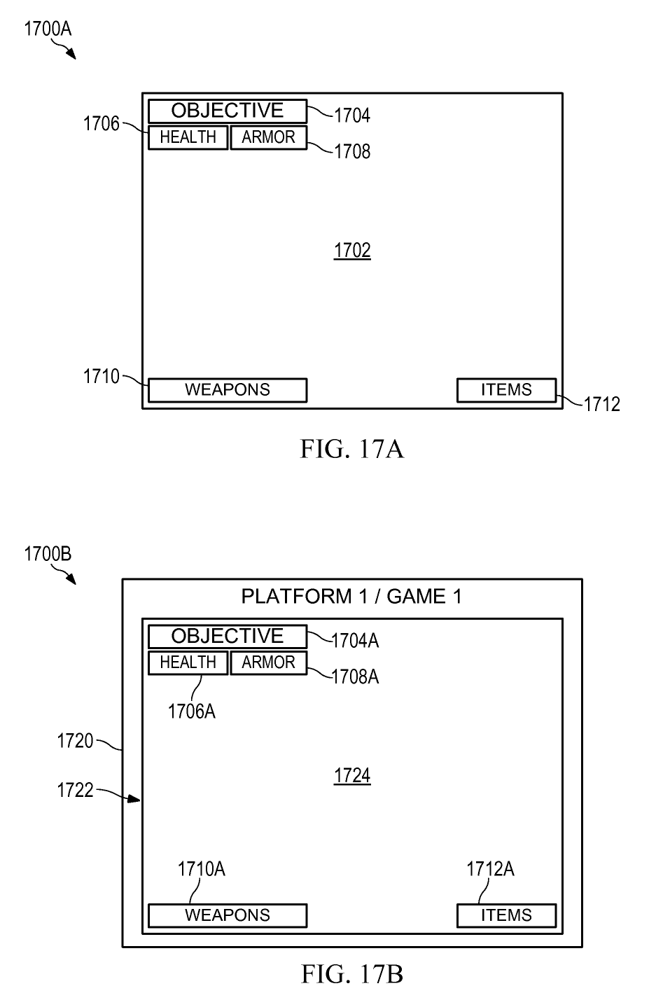

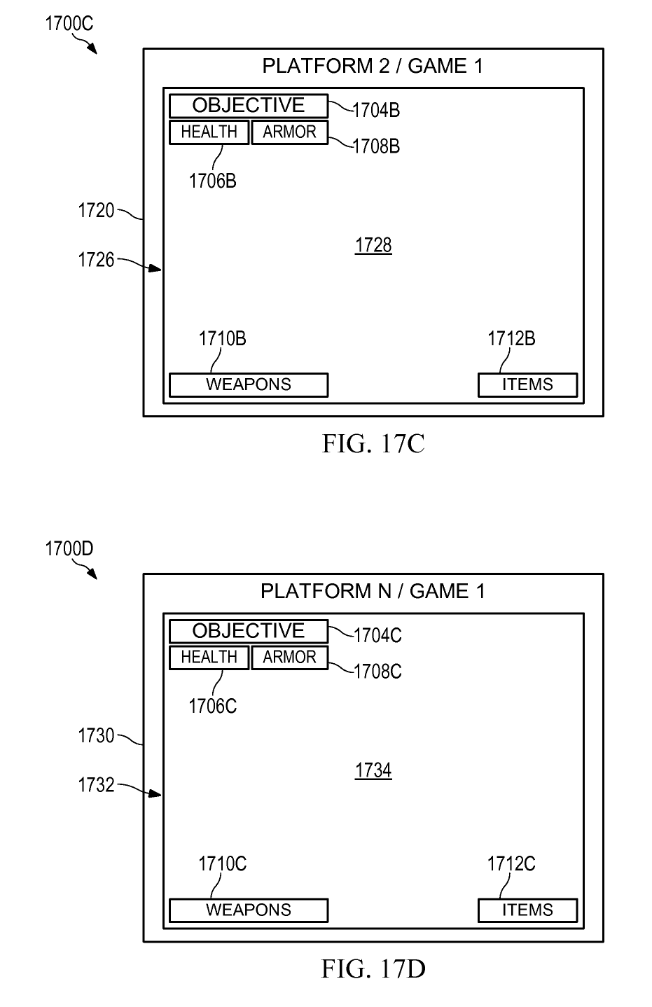

In FIG. 17A, a multi-platform image is shown, according to one embodiment. A first screen image 1700A may include a display screen 1702, an objective area 1704, a health area 1706, an armor area 1708, a weapons area 1710, and an items area 1712. In one example, display screen 1702 may have a default format where an objective area 1704, a health area 1706, an armor area 1708, a weapons area 1710, and an items area 1712 have a first structure (e.g., how they look on the display screen—size, shape, location, etc.) because it is on the first platform.

In FIG. 17B, another multi-platform image is shown, according to one embodiment. A second image 1700B may include a first platform display screen 1724, a first platform objective area 1704A, a first platform health area 1706A, a first platform armor area 1708A, a first platform weapon area 1710A, and a first platform item area 1712A. In another example, a first platform objective area 1704A, a first platform health area 1706A, a first platform armor area 1708A, a first platform weapon area 1710A, and a first platform item area 1712A may have a second structure because it is on the first platform.

In FIG. 17C, another multi-platform image is shown, according to one embodiment. A third image 1700C may include a first platform display screen 1728, a first platform objective area 1704B, a first platform health area 1706B, a first platform armor area 17088, a first platform weapon area 1710B, and a first platform item area 1712B. In another example, a first platform objective area 17048, a first platform health area 1706B, a first platform armor area 17088, a first platform weapon area 1710B, and a first platform item area 1712B may have a third structure because it is on the second platform.

In FIG. 17D, another multi-platform image is shown, according to one embodiment. A fourth image 1700D may include an Nth platform display screen 1734, an Nth platform objective area 1704C, an Nth platform health area 1706C, an Nth platform armor area 1708C, an Nth platform weapon area 1710C, and an Nth platform item area 1712C. In another example, an Nth platform display screen 1734, an Nth platform objective area 1704C, an Nth platform health area 1706C, an Nth platform armor area 1708C, an Nth platform weapon area 1710C, and an Nth platform item area 1712C may have a fourth structure because it is on the Nth platform.

Please note that in these documents the words need, must, should, will, requires, does, want, can, and/or future statements and/or any limiting statements all mean that the feature is operational and may be utilized in one or more embodiments. Further, any element in these documents may be combined with any other element in these documents and/or with other elements known to a person of ordinary skill in the art. Playverse and/or this disclosure is a platform-agnostic online/digital games distribution service, designed to unify the increasingly fragmented marketplace of devices into a single network. There is a server infrastructure that exists in a physical form and/or in a distributed cloud structure that is distributed and leveraged as the primary resource for the disclosure. In one example, the disclosure's main components are compiled from a series of source code projects that live in a centralized repository.

Playverse and/or this disclosure is a revolutionary platform-agnostic online games distribution service, designed to unify the increasingly fragmented marketplace of devices into a single network. Among many other essential features, Playverse and/or this disclosure supports game hosting, content delivery, multi-player, and monetization across devices. It is designed to be simple for developers and consumers to use, and as transparent to the end user as desired on each individual platform. Playverse's and/or this disclosure's games can function as a standalone application, operate within another game distribution network such as the iOS App Store, Google Play, Facebook, and/or Steam. Playverse and/or this disclosure is designed, in essence, to be a flexible distribution service for every gaming device. Playverse and/or this disclosure provides developers with the online infrastructure and pipelines to support, pool, and promote all players across these many access points, coalescing them into a massive unified userbase. With an SDK to utilize in any game engine, Playverse and/or this disclosure will be an essential service for game developers who wish to capture market share in this new age of fragmented hardware marketplaces, and for consumers to play the online games they want with their friends anywhere, anytime, on any device. Playverse's and/or this disclosure's primary purpose is to serve as the distribution platform of choice; but if the developer wishes to focus efforts on other platforms, Playverse can complement an existing service, providing new features and enhancing existing ones, rather than replacing the service as a whole. Playverse and/or this disclosure allows for seamless cross platform multiplayer gaming action now player can play with anyone on any device. Further, Playverse and/or this disclosure includes cross platform content distribution & patching: Game content & updates are downloaded dynamically to any device, with the smallest possible download sizes computed & packaged by the service. In addition, Playverse and/or this disclosure includes background streaming technology: Only minimal content required to play the game is initially downloaded. The rest may be streamed while you play, including textures, sounds, music, meshes, animations, and levels. games can be playable in under a 10 megabyte download on mobile devices and web. In addition, Playverse and/or this disclosure includes progress without restrictions: players can travel from device to device with their profiles and never skip a beat, as all their data is stored on the service. In addition, Playverse and/or this disclosure includes unified in-game overlay: All platforms have access to the same web-based overlay (enabling Playverse to update it on the fly), which supports our social, messaging, and cross-game service features. Further, Playverse and/or this disclosure includes social features: make Playverse friends, post-game status updates & invites to your social network, form parties to travel between games together, join players into your game play session, trade items, send messages and group 1M-chat with other players regardless of what they're playing on (Voice Chat). In addition, Playverse and/or this disclosure includes cross-platform and cross-game item trading: Any game item can be posted onto the service for auctioning or direct player trading, whether inside or outside the game. Further, Playverse and/or this disclosure includes customizable leaderboards, achievements, & matchmaking algorithms. In addition, Playverse and/or this disclosure includes third party login: Optional 3rd party login pass-through makes Playverse a transparent experience on supported Platforms. Use your Apple GameCenter, Face book, Google, or Steam account and you can play without ever having to create a Playverse account. Third party accounts can be linked to Playverse accounts to allow transitioning between devices as well. Further, Playverse and/or this disclosure integrates with other distribution networks: Playverse has standalone installers for the PC/Mac/Linux game versions to drive traffic through our site, but also has built-in authenticated Steam integration, Mac App Store, iOS App Store, Google Play, and Windows Store to ensure that Playverse games gain full access to every community of players regardless of 3rd party distribution network. In addition, Playverse and/or this disclosure includes customizable access and unlock codes: Developers can issue beta codes for their specific game, and enable/disable beta & public access. Developers can also assign & generate arbitrary Key Code ID's to generate, which can consume or unlock give anything within their game. Further, Playverse and/or this disclosure includes referrals: Players can invite their out-of-network friends to play their game, which grants Playverse Credits as a reward. In addition, Playverse and/or this disclosure includes optional cross-game currency: Currency can be specified as per-game, or cross-game, depending on the current platform to avoid TOS restrictions. Further, Playverse and/or this disclosure includes steam features integration: Enhances steam features include Steam Item Trading, Steam Workshop, Steam-specific IAP's & DLC support, and Steam Invites integrating them into the service. In addition, Playverse and/or this disclosure includes anonymous web access: Developers can optionally enable anonymous access, which allows players to play the shareable web version of the game without manually creating an account. They are given a special access code which allows them to keep playing and spend money with no commitments. Further, Playverse and/or this disclosure includes analytics & metrics: Track & record everything! From entry to exit, everything the user does on any platform can be recorded, correlated, and graphed at any level of detail per-user, per-game, or service wide in real-time via Playverse's proprietary integrated analytics. In addition, Playverse and/or this disclosure includes beta & NB Testing: Developers can assign users into beta game versions which are unique versions of the game for testing, and dynamically make these versions “Live” when considered ready for release. Old versions can be made obsolete at the developer's discretion, and network compatibility between versions can be specified. NB tests can be run across any version, delivering different content to specified percentages of users and then keyed into the analytics system. Further, secure cloud storage: All user data is stored on the cloud, setup for secure access only by Playverse's servers. Developers can easily save and access pertinent user & game data via our API, and also create & edit tables via our backend GUI. In addition, developers can use this system to easily create database driven game mechanics. Further, Playverse and/or this disclosure includes Scalable Cloud & Physical Infrastructure: The Playverse system automatically scales the number of allocated servers per game based on game load, with a predictive buffer model to ensure there are always server slots available to play on. This infrastructure can be run on any network (currently on AWS cloud), and supports optionally utilizing physical local servers alongside the cloud infrastructure. Support for region gating, per region servers, and cross-region play are also supported. In addition, Playverse and/or this disclosure includes Integrated IAP systems: PayPal, Amazon, Google Checkout, PlaySpan, Xsolla, are all natively integrated into the service's payment options with device-specific payment options utilized where applicable including App Store, Google Play, Steam, and Facebook One-Click Game Deployment System: Developers can generate & deploy game builds via a local frontend, with a single click initiating the entire packaging & upload process for every platform. The Playverse developer backend interface then allow the developer to manage the release of their game/version. In addition, Playverse and/or this disclosure includes Pluginless HTMLS/Javascript Technology: Our custom implementation of the Javascript “Emscripten” compiler enables us to convert C++ Playverse games into Javascript, and then with our streaming technology and proprietary WebSockets wrapper, host this superior Web version on Playverse with full multiplayer capabilities. No plugin or download required, you can go from link to gameplay in less than 60 seconds without any confirmation boxes. In addition, Playverse and/or this disclosure includes SDK for 3rd Party Developers: Playverse client libraries are compiled into an easy-to-integrate SDK that can be used with any game engine, including Unreal Engine 3 and Unity. The Unity version does not require any source code modifications, and functions as a simple plugin that can be dropped into any Unity project. Real world time to convert an existing Unreal Engine 3 game for use on Playverse is less than 5 days; for Unity, less than 1 day. Further, Playverse and/or this disclosure includes Profanity Engine: A custom profanity engine that allows developers to use advances in caching technology, hash tables and a bloom filter to rapidly check and update profanity filters cross-platform for their games. This profanity filtering engine can be re-used for multiple features. In addition, Playverse and/or this disclosure includes Client Swarm: A custom engine that allows developers to execute game-level scripts with thousands of simultaneous users simulated through a cloud environment used to test scalability and reliability of the game and its backing service. Further, Playverse and/or this disclosure includes Streaming Video Integration: Playverse supports integrating gameplay recording and publishing of videos cross-platform and cross game to various video services like Twitch. In addition, the distribution platform is much more developer and studio focused, it allows for heavy integration and customization across a large variety of projects for one or more platforms. This frees the developer from having to manage most of the API calls and libraries themselves, and allows them to focus more on game development rather than platform, service, network, and infrastructure development. Playverse and/or this disclosure includes expanding options for developers is much easier under the system; the system does not require a developer to take advantage of all the features at once, so a developer can start using a very small subset of the features and progressively implement more features and game platforms as they evolve. This environment allows cross-platform integration, right out of the box, instead of needing additional tools, utilities, services, or libraries. This allows does not restrict developers to solely using the service or platform, but allows them rich and full integration with several other platforms and frameworks of their choice like Steam, Google Play, Facebook, etc. Branch permissions on versions for games for users Current games. In addition, Playverse and/or this disclosure may include functions, such as, versions that are live with platform updates, update all existing code, to use the new object generated by DBSync, Overlay login (simple permission check, row existence), Bootstrapper login (simple version check, which version to download), Front page login (access to versions, and platforms, across all games), and/or Profanity Check. Further, Playverse and/or this disclosure may include Plugin/Module system, the Ability to load .NET assemblies dynamically from database or file based architecture, Ability to unload .NET assemblies dynamically, Ability to load both parallel plugin architectures and serial plugin architectures, and/or Fault recovery Load. Playverse and/or this disclosure may include Steam, iOS, Android Accounts, Facebook, Payment Providers, PlaySpan, Paypal, Google, Amazon, Ranking Providers, Friends List Provider, Achievements, PlayVerse Achievements, Platform Configuration, Messaging Provider, Default Implementation, Chat Provider, Default Implementation, Logging Provider, Default Implementation, Analytics Provider, Default Implementation, Overlay Provider, Default ImplementationPlayVerse, Roles and groups have to honor PlayVerse, Generate an open authorization cookie, PlayVerse OpenAuthority login, Pull permissions or group information from PlayVerse, All registration, to go through PlayVerse, PlayVerse should pass other attached logins, and/or vBulletin & Word Press should pick up the other attached logins. In one example, PlayVerse Login is all handled currently through two front-end methods, that point to one back end routine. The front end methods are found in the Developers ASP. NET MVC project, on the Overlay and Account controllers in the Login/Logon methods. Behind the scenes, on the back-end, these front-end methods call the Authenticate method in UserIdentities in the PlayVerse. WebObjects project. WPF is a Microsoft framework that allows a developer to create high-performance, graphically rich desktop applications. WPF inherently allows separation of presentation logic, business logic, and semantic logic; thus encouraging good application design by use of the framework. WPF has layout engines and styling engines with similar capability sets to HTML and CSS, allowing a developer to more easily and quickly convert a web application to a native windows application. Playverse and/or this disclosure includes a playverse native client, starting with Windows allows us to perform more capable administrative functions with rapid iteration cycles, faster loading times, and less risk than a web application would allow. A native client, especially a cross platform native client may include a rich user interface. A Windows client utilizing WPF is the primary administrative platform and desktop client for playverse. In one example, the playverse client handles deployment through a Microsoft framework called ClickOnce. The ClickOnce web page needs to live on its own server so that one version of the program can be downloaded separate from environment and properly patched and auto-updated on desktops. Once deployed to the server and downloaded to the users machine, the application is a standard Windows application that runs on any machine running Windows Vista or later and .NET Framework 4.5.1 or higher. Platforms & Frameworks—the WPF was chosen to be the primary framework employed by the client application due to the ability of WPF to quickly replicate and emulate common HTML and CSS layouts and designs. The WPF also features rich data-binding allowing for quick and easy manipulation of data returned from the service. The .NET Framework 4.5.1 was chosen due to the latest advances in threading technology, virtualizing panels, the ability to bind to static properties (which have much better performance than non-static properties), the ability to access collections on non-UI threads and live shaping of data. In order to provide a rich graphical UI at no cost, various controls from the Xceed toolkit are also being used.

PlayverseClient—This is the generated client libraries from the main playverse project needed to access the web service. Playverse.Rules—This host all future validation, deployment, business and workflow rules. These central rule engine that can be re-used on other platforms. Playverse.Data.Client—This host the PlayverseCiient and abstract that are away from the Playverse WPF project. Playverse.DAL—This is the standard API/interface that all the client projects call to access data from one of the Playverse.Data projects Depending on development needs. Playverse.Module—These are the core sets of user controls that provide a comprehensible module. Playverse.Data—These provide access to data through any other interface other than PlayverseCiient. Playverse.Controls—the controls have use outside of the desktop application, this project should be created to house those controls. Other modules include Playverse.Linux, Playverse.Mac, Playverse.Android, and/or Playverse.Ios.

One example structure includes AchievementController, GetAchievement(string gameId), • GetAchievements(string gameId, IDictionary<string, string> paging, IDictionary<string, string>[ ] sorting, IDictionary<string, string>[ ] filtering), DeleteGameAchievement(string gameId, string gameAchievementId), EditGameAchievement(string gameId, string gameAchievementId), EditGameAchievement(string gameId, string gameAchievementId, AddGameAchievementModel gameAchievementModel), AddAchievement(string gameId), AddAchievement(string gameId, AddGameAchievementModel model), BetaKeyController, AddBetaKey(string gameId), AddBetaKey(string gameId, AddBetaKeyModel betaKey), AddBetaKeys(string gameId), AddBetaKeys(string gameId, AddBunchGameBetaKeysModel betaKeys}, GetBetaKeys(string gameId, IDictionary<string, string> paging, IDictionary<string, string>[ ] sorting, IDictionary<string, string>[ ] filtering), GameBranchController, GetBranchMappings(string gameId, IDictionary<string, string> paging, IDictionary<string, string>[ ] sorting, IDictionary<string, string>[ ] filtering}, EditGameBranches(string gameId, string name, int key), EditGameBranches(string gameId, string name, int key, AddGameBranchesModel gamebranch}, DeleteGameBranch(string gameId, string name, int key), DynamicTableController, SetDynamicTableFile(Stream stream, string gameId, string fileName}, GetDynamicTables(string gameId, IDictionary<string, string> paging, IDictionary<string, string>[ ] sorting, IDictionary<string, string>[ ] filtering), GetDynamicColumns(string gameId, string tableName, byte shardIndex, IDictionary<string, string> paging, IDictionary<string, string>[ ] sorting, IDictionary<string, string>[ ] filtering), IndexIsStale(string tableName, string gameId), IndexIsOutOfDate(string tableName, string gameId), DynamicTablesColumns(string gameId, string tableName, byte shardIndex), IndexTable(string tableName, string gameId), DynamicTablesData(string gameiD, string tableName, string shard Indexes), GetDynamicTableslistInfo( ), GetDynamicTablesData(string gameId, string tableName, byte shardIndex, IDictionary<string, string> paging, IDictionary<string, string> U sorting, IDictionary<string, string>[ ] filtering), DeleteDynamicTableData(string gameId, string tableName, string rowId), DeleteDynamicTableAllData(string gameId, string tableName), DeleteDynamicTable(string gameId, string tableName), DeleteDynamicTableColumn(string gameId, string tableName, string columnName, StatsColumnType columnType), AddDynamicTable(string gameId), AddDynamicTable(string gameId, DynamicTableSettings model), EditDynamicTableColumn(string gameId, string tableName, string columnName), EditDynamicTableColumn(string gameId, string tableName, string columnName, DynamicTableColumnSchemaSettings model), AddDynamicTableColumn(string gameId, string tableName), AddDynamicTableColumn(string gameId, string tableName, DynamicTableColumnSchemaSettings model), AddDynamicTableData(string gameId, string tableName), AddDynamicTableData(string gameId, string tableName, KeyValueDictionary model), EditDynamicTableData(string gameId, string tableName, string rowId), EditDynamicTableData(string gameId, string tableName, string rowId, KeyValueDictionary model), GetDefaultValueFromEnum(StatsColumn Type type), GameController, Games( ), AddGameInfo(string gameId), GetGames( ), Game(string gameId), AddGame( ), AddGame(GameSettings model), GameInfos(string gameId), GetGameInfos(string gameId), DeleteGameInfo(string gameId, string gameInfold), EditGameInfo(string gameId, string gameInfold), EditGameInfo(string gameId, string gameInfold, GameInfoSettings Model), AddGameInfo(string gameId, GameInfoSettings model), EditGame(string gameId), GetOwnerNames(Uuid gameId), EditGame(string gameId, UpdateGameSettings gameModel), DuplicateGame(string gameId. bool confirmed), DuplicateGame(string gameId), GameKeyController, GetGameKeys(string gameId, IDictionary<string, string> paging, IDictionary<string, string>[ ] sorting, IDictionary<string, string>[ ] filtering), AddKeyToUser(AddBetaTesterModel model), AddKeyToUser(string gameId, string PermissionName), DeleteKeyFromUser(string gameId, string useremail, string TargetPermissionName), EditUserKeys(string gameiD, string PermissionName), GetCurrentUserKeys(string gameId, string PermissionName, IDictionary<string, string> paging, IDictionary<string, string>[ ] sorting, IDictionary<string, string>[ ] filtering), GameRoleController, AddGameRole(string gameId), AddGameRole(string gameId, AddGameRoleModel model), GetGameRoles(string gameId), EditGameRole(string gameRoleId), EditGameRole(string gameRoleId, AddGameRoleModel Model), DeleteGameRole(string gameRoleId), ToggleRoleAccess(string gameRoleId), GameSessionController, DeleteGameSessionUser(string gameId, string sessionId, string userSessionId), DeleteGameSession(string gameId, string sessionId), GetGameSessions(string gameId, IDictionary<string, string> paging, IDictionary<string, string>[ ] sorting, IDictionary<string, string>[ ] filtering), GetGameSessionAttributes(string gameId, string sessionId,IDictionary<string, string> paging, IDictionary<string, string>[ ] sorting, IDictionary<string, string>[ ] filtering), GetGameSessionUsers(string gameId, string sessionId, IDictionary<string, string> paging, IDictionary<string, string>[ ] sorting, IDictionary<string, string>[ ] filtering), GameSession TypeController, GameSessionTypeRetries(string gameId, string gameSessionTypeId), GameSessionTypeRankrange(string gameId, string gameSessionTypeId), GameSessionTypeFilters(string gameId, string gameSessionTypeId), GameSessionTypeFilterValues(string gameId, string gameSessionTypeId, GameSessionFilterType filterType, string Id), GetGameSessionTypeRetries(string gameId, string gameSessionTypeId), GetGameSessionTypeFilters(string gameId, string gameSessionTypeId), GetGameSessionTypeFiltersValue(string gameId, string filterId), EditGameSessionTypeFilter(string gameId, string gameSessionTypeId, string Id), EditGameSessionTypeFilter(string gameId, string gameSessionTypeId, string Id, GameSessionTypeFilterSettings model), DeleteGameSessionRankRange(string gameId, string gameSessionRankRangeId, string gameSession Type Id), GameVersionController, DeleteVersion(string gameId, string gameVersionId), EditVersion(string gameId, string gameVersionId), EditVersion(string gameId, string gameVersionId, GameVersionEdit version Model), AddVersion(string gameId, GameVersionSettings versionModel), AddVersion(string gameId), GetVersions(string gameId, dynamic data, IDictionary<string, string> paging, IDictionary<string, string>[ ] sorting, IDictionary<string, string>[ ] filtering), HostingConfigurationController, RegionHostingConfigurations(string gameiD, string configurationId), GetRegionHostingConfigurations(string gameId, string configurationId, IDictionary<string, string> paging, IDictionary<string, string>[ ] sorting, IDictionary<string, string>[ ] filtering), DeleteRegionHostingConfiguration(string gameId, string configurationId, string regionId), AddRegionHostingConfiguration(string gameId, string configurationId), AddRegionHostingConfiguration(string gameId, string configurationId, AddRegionHostingConfigurationModel model), EditRegionHostingConfiguration(string gameId, string configurationId, string regionId), EditRegionHostingConfiguration(string gameId, string configurationId, string regionId, EditRegionHostingConfigurationModel model), DeleteHostingConfiguration(string gameId, string HostingConfigurationId), GetHostingConfigurations(string gameId, IDictionary<string, string> paging, IDictionary<string, string>[ ] sorting, IDictionary<string, string>[ ] filtering), EditHostingConfiguration(string gameId, string hostingConfigurationId), EditHostingConfiguration(string gameId, string hostingConfigurationId, EditHostingConfigurationModel hostingConfiguration), AddHostingConfiguration(string gameId), AddHostingConfiguration(string gameId, HostingConfigurationSettings configurationModel), GetServerPiatformNames( ), Hosting! nstanceController, GetHostingInstances(string gameId, IDictionary<string, string> paging, IDictionary<string, string>[ ] sorting, IDictionary<string, string>[) filtering), DeleteHostingInstance(string gameId, string hostingInstanceId), IAPMappingController, GetiAPProductMappings(string gameId, IDictionary<string, string> paging, IDictionary<string, string>[ ] sorting, IDictionary<string, string>[ ] filtering), OeleteiAPProductMapping(string gameId, string productId), AddiAPProductMapping(string gameId), AddiAPProductMapping(string gameId, IAPNameMappingModel model), EditiAPProductMapping(string gameId, string productId), EditiAPProductMapping(string gameId, string productId,IAPNameMappingModel model), ImmediateMessageController, ImmediateMessages( ), ImmediateMessages(ImmediateMessageModel model), LeaderboardController, Deleteleaderboard(string gameId, string boardId), GetleaderBoards(string gameId, IDictionary<string, string> paging, IDictionary<string, string>[ ] sorting, IDictionary<string, string>[ ] filtering), Editleaderboard(string gameId, string boardId), Editleaderboard(string gameId, string boardId, Leaderboard leaderboard), AddleaderBoard(string gameId, LeaderboardSettings model), MemCacheController, GetMemCacheNodes(string gameId, IDictionary<string, string> paging, IDictionary<string, string>[ ] sorting, IDictionary<string, string>[ ] filtering), DeleteMemCacheNode(string gameId, string memCacheNodeId), AddMemCacheNode(string gameId), AddMemCacheNode(string gameId, AddMemCacheNodeDialogModel model), OverlayController, AddOverlay(string gameId), GetOverlay(string gameId, IDictionary<string, string> paging, IDictionary<string, string>[ ] sorting, IDictionary<string, string>[ ] filtering), PlatformController, AddSupportedPiatform(string gameId), AddSupportedPiatform(string gameId, AddSupportedPiatformModel model), SetBootstrapperFile(Stream stream, string gameId, string platformName, string fileName), EditSupportedPiatform(string gameId, string platformName, EditGamePiatformModel settings), GetSupportedPiatforms(string gameId, IDictionary<string, string> paging, IDictionary<string, string>[ ] sorting, IDictionary<string, string>[ ] filtering), EditSupportedPiatform(string gameId, string platformName), GetUpdatedPiatformsChange(string gameId, string major, string minor), RedeemCodeController, RedeemCode(string gameiD, string UnlockId), EditRedeemCode(string gameiD, string UnlockId), GetRedeemCode(string gameId, string UnlockId, IDictionary<string, string> paging, IDictionary<string, string>[ ] sorting, IDictionary<string, string>[ ] filtering), DeleteRedeemCode(string gameId, string RedeemCode), MatchFilterEnumColumns(string dbcolumn, Type enumtype, string filtervalue), GetEnumValue(Type type, string p), AddRedeemCode(string gameId, string UnlockId), AddRedeemCode(string gameId, string UnlockId, AddRedeemCodeDialogModel Model), AddRedeemCodes(string gameId), AddRedeemCodes(string gameId, string UnlockId, AddBunchBetaKeysModel betaKeys), DeleteUnlockCode(string gameId, string UnlockId), AddUnlockCode(string gameId), AddUnlockCode(string gameId, AddUnlockCodeModel model), GetUnlockCode(string gameId, IDictionary<string, string> paging, IDictionary<string, string>[ ] sorting, IDictionary<string, string>[ ] filtering), SteamWorkshopItemController, AddSteamWorkshopItem(string gameId), AddSteamWorkshopItem(string gameId, SteamWorkshopItemModel model), GetSteamWorkshopItems(string gameId, I Dictionary<string, string> paging, IDictionary<string, string>[ ] sorting, IDictionary<string, string>[ ] filtering), EditSteamWorkshopItem(string gameId, int steamItemId), EditSteamWorkshopItem(string gameId, int steamItemId, SteamWorkshopItemModel model), TestController, TestStats( ), TestMatchMake(string gameId), TestFriends( ), WebStorageController, UploadFiles(IEnumerable<HttpPostedFileBase> files, string gameId, string prefix), GetFilesByGameId(string gameId, string prefix), UploadFileByGameId(Stream stream, string gameId, string filename, string prefix), RemoveFileByGameId(string gameId, string filename), RemoveFolderByGameId(string gameId, string foldername), CreateFolderByGameId(string gameId, string foldername), ListObjectsInBucket(string bucketName, string prefix), S3(string bucketName, string fileName), SetImage(Stream stream, string Id), UploadImage(HttpPostedFileBase fileName, string fileId), Game, BrowserController, Browser(string), BrowserAnon(string, string), CheckAnonymous(string), HomeController, and/or Index(string).

Per-player ignore capability: “ignore list” management will be done from playverse overlay similar to friends list, if someone is added to ignore list, the following happens: no longer can receive playverse messages from them; no longer can see their online status; no longer receive friend requests from them; no longer receive party invites from them; and/or no longer can send messages to them; and/or sender is not notified he/she was ignored.

Payment Processors—Playverse may integrate Amazon Payments as a payment processor—Playverse UX/UI may include an Amazon Payments option in the IAP.

UX flowUser use a bootstrapper that can have the most up to date updated automatically software provided. The user may download a launcher specific to their platform and have the latest updates for their platform. The user may register a new account via playverse and use the bootstrapper to download and access games. The user may have their name displayed and/or the user can log in as a guest (anonymous). Further, the user can play a game without a playverse account. The user can log in with facebook (and/or any other cite) and share their data between playverse and other services.

In one example, a developer may apply a custom logo to a playverse bootstrapper for a specific game, a specific platform, and/or any other reason. In addition, the developer may replace the key art and tailor it to the playverse bootstrapper (background) for a specific game and/or a platform. The Playverse branding may be tied into the playverse service and UI elements that can be customized based on the game that it is serving. The users may be able to see the online status of their friends, to deny friend requests from other users, to purchase purchasable digital goods regularly as a mechanism to increase an IP's market share, reinforce consumer “mindshare” for the IP, and serve as an extra cash flow for the business, and/or trade one or more items. Further, Playverse supported games have the capability of adding and removing digital goods so they can be purchased and traded by users. Playverse also supports third party item integration to prevent the isolation of users that are already invested in those said systems. This will give users the ability to create, purchase, trade, share, and use digital goods across playverse, which reinforces social interactions, playing with friends, and IP reinforcement. Playverse is an agnostic In-Application-Purchase system. Further, developers are able to create digital goods which are Game agnostic, Game specific, and/or Platform specific. Further the developer may modify the digital goods, delete the digital goods, timebox digital goods, make only available during certain time ranges (holidays, sale period, etc.), and/or integrate third-party item systems (Steam). The user are able to purchase digital goods, purchase digital goods in bundles (more than one digital good), under a single transaction, sending digital goods to friends, receive digital goods from friends, trade digital goods, and/or purchase, obtain, send, and trade more than one digital good at a time under one transaction, like in a bundle purchase or bulk trades.

Matchmaking requests are divided into 4 types; User Ready requests—Indicate that the user has logged in and is ready to be placed into a session; Join requests—The user has a specific session they're trying to join or re-join; and/or Leave requests.

Analytics is about processing collected metrics data, generating reports, and displaying information useful to game developers and data analysts. Analytics is for crunching data to present “high value” findings. A good distinction between metrics and analytics can be found here.

In one embodiment, the system for providing game play may include a first gaming platform, a second gaming platform, and an interface module which may allow for an implementation of a game via the first gaming platform and the second gaming platform. Further, the first gaming platform may utilize a first operating system and the second gaming platform may utilize a second operating system. In addition, the interface module may allow a first player on the first gaming platform to communication with a second player on the second gaming platform. In one example, the interface module may allow a first player on the first gaming platform to form a relationship with a second player on the second gaming platform. Further, the interface module may allow a first player on the first gaming platform to trade with a second player on the second gaming platform. In addition, the interface module may allow a first player on the first gaming platform to form a party with a second player on the second gaming platform. In one example, the system may include a third gaming platform where the interface module may allow the implementation of the game via the first gaming platform, the second gaming platform, and the third gaming platform. Further, the third gaming platform may utilize a third operating system. In addition, the interface module may allow a first player on the first gaming platform to communication with a second player on the second gaming platform and a third player on the third gaming platform. In one example, the system may include a fourth gaming platform where the interface module may allow the implementation of the game via the first gaming platform, the second gaming platform, the third gaming platform, and the fourth gaming platform. Further, the fourth gaming platform may utilize a fourth operating system. In addition, the interface module may allow a first player on the first gaming platform to communication with a second player on the second gaming platform, a third player on the third gaming platform, and a fourth player on the fourth gaming platform. In one example, the first gaming system is a first console type, the second gaming system is a second console type, the third gaming system is a desktop computer, and the fourth gaming system is a mobile device. Further, the interface module may generate a master leaderboard for the first gaming platform, the second gaming platform, the third gaming platform, and the fourth gaming platform. In addition, the interface module may generate at least one of a first gaming platform leaderboard, a second gaming platform leaderboard, a third gaming platform leaderboard, and a fourth platform leaderboard. In one example, a first player may stop game play on the first gaming platform at a first stage and start game play on the second gaming platform at the first stage. Further, the interface module may implement a match skills function. In addition, the match skills function may allow a first player to search for other players with a skill level. Further, the match skills function may allow a first player to search for other players with a skill level range. In addition, the interface module may implement an auto downloading function for at least one of the first gaming platform and the second gaming platform.

In another embodiment, the interface system for providing game play may include one or more memory devices. The one or more memory devices may include an engine module, an in-game display module, a character module, and a tools module. The interface system may include one or more processors which may receive an engine input, an in-game display input, a character input, and/or a tool input to create a first game where the first game is configured to be implemented on a first gaming platform and a second gaming platform. In addition, the first gaming platform utilizes a first operating system and the second gaming platform utilizes a second operating system. Further, the first game may be implemented on a third gaming platform. In one example, the first game may be implemented on a fourth gaming platform. In addition, the first gaming system may be a first console type, the second gaming system may be a second console type, the third gaming system may be a desktop computer, and the fourth gaming system may be a mobile device. Further, the engine input may include a first engine option and a second engine option where the first engine option is a first operating system and the second engine option is a second operating system. In addition, the in-game display input may include an objective option, an item pickup option, an ammunition option, a health option, and/or an armor option. Further, the character input may include a first character option and a second character option. In addition, the tool input may include a weapon option, an item option, a power-up option, and/or a tool option. Further, the one or more processors may receive a second engine input, a second in-game display input, a second character input, and/or a second tool input to create a second game where the second game is configured to be implemented on the first gaming platform and the second gaming platform. In addition, the second game may be implemented on a third gaming platform. Further, the second game may be implemented on a fourth gaming platform. In addition, the first gaming system is a first console type, the second gaming system is a second console type, the third gaming system is a desktop computer, and the fourth gaming system is a mobile device. In one example, the one or more processors may implement an auto downloading function for the first gaming platform and/or the second gaming platform. In addition, the one or more processors may implement a first game display structure for a first game on the first platform. Further, the one or more processors may implement a second game display structure for the first game on the second platform. In addition, the first game display structure may be different than the second game display structure. Further, the differences between the first game display structure and the second game display structure may be a size of an object, a location of the object, and a form of the object. In addition, the first game display structure may be based on a player profile.

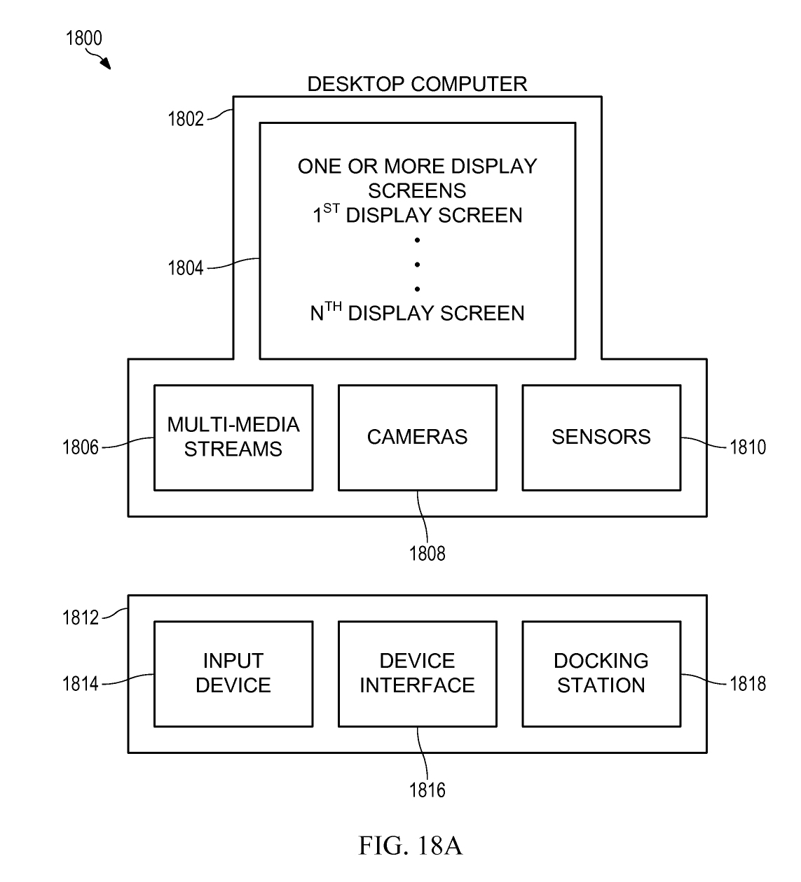

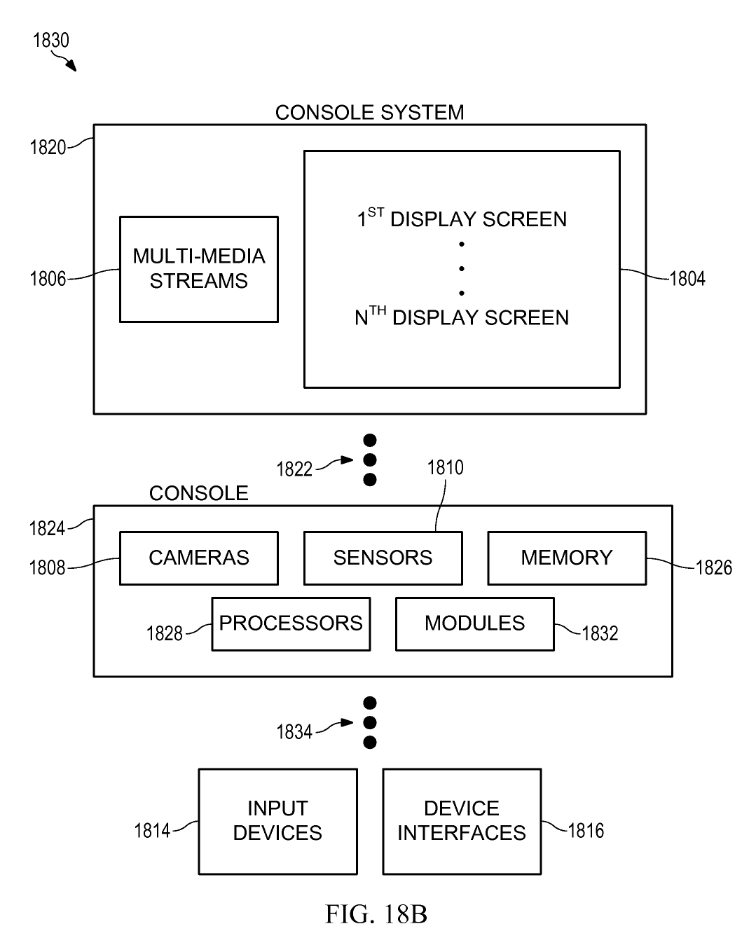

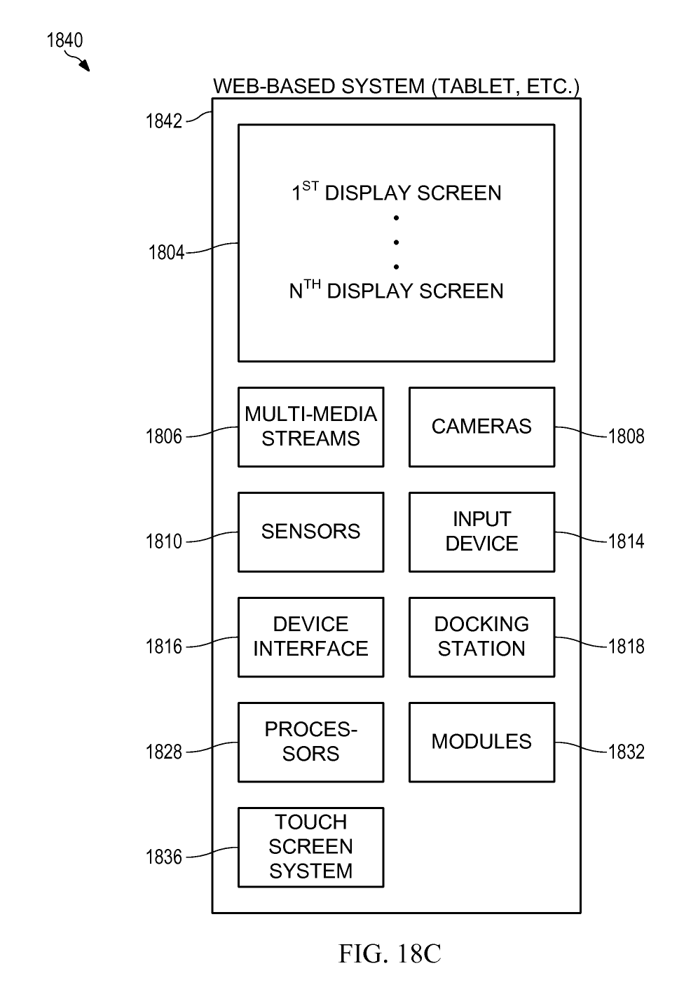

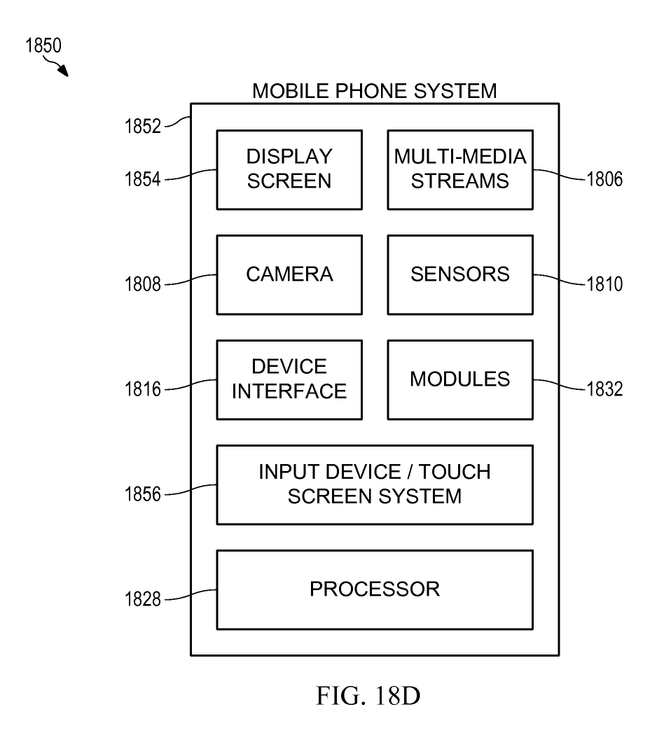

FIG. 18A is an illustration of an electronic gaming device 1800 (e.g., desktop computer 1802). Electronic gaming device 1800 may include a multi-media stream 1806, and/or one or more display screens 1804 (e.g., a first display screen, a second display screen, a third display screen, an nth display screen, etc.). A controller 1812 may include one or more input devices 1814, a device interface 1816, and/or a docking station 1818. Further, the gaming system may include one or more cameras 1808 and/or one or more sensors 1810. Electronic gaming device 1800 may display one, two, a few, or a plurality of multi-media streams 1806, which may be obtained from one or more gaming devices, a central server, a video server, a music server, an advertising server, another data source, and/or any combination thereof.

Multi-media streams may be obtained for an entertainment event, a promotional event, a promotional offering, an advertisement, a sporting event, any other event, and/or any combination thereof. For example, the entertainment event may be a concert, a show, a television program, a movie, an Internet event, and/or any combination thereof. In another example, the video streams may be feeds from other players' playing the game, the electronic gaming device 1800 the person is playing on, any other game, and/or any combination thereof. For example, a first player may be playing a first game with four other players on his team and have feeds from one or more of the other four players shown on a portion of a display screen. In another example, the video feeds might be from other players playing a second game and/or the first game. In another example, a car race and/or any other race can be utilized. For example, a NASCAR race may be occurring while the player is playing the first game and the player wants to do both (e.g., play the first game and watch the race).

The advertisement may be an advertisement for a new game, a new game feature, a voting opportunity, a funding opportunity, a restaurant, a shop, any other entity, to preorder a game and/or game feature, a contest, the leaderboard, to recruit player to a team, selling, buying, and/or trading items, to request items, and/or any combination thereof. The sporting event may be a football game, a baseball game, a hockey game, a basketball game, any other sporting event, and/or any combination thereof. These multi-media streams may be utilized in combination with the other gaming device video streams.

Input device 1814 may be mechanical buttons, electronic buttons, mechanical switches, electronic switches, optical switches, a keyboard, a keypad, a touch screen, a gesture screen, a joystick, a pointing device (e.g., a mouse), a virtual (on-screen) keyboard, a virtual (on-screen) keypad, biometric sensor, or any combination thereof.

Device interface 1816 may be utilized to interface electronic gaming device 1800 to a peripheral display device, signage, a promotional device, network components, a local network, a wide area network, remote access equipment, a game monitoring system, a player tracking system, the Internet, a server, and/or any combination thereof.

Display screens may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology.

One or more cameras 1808 and/or one or more sensors 1810 may be utilized as one or more depth image sensing devices, which may be located in various locations, including but not limited to, above the base display, above second display, in one or more locations on gaming device front, and/or any other location.

In one embodiment, electronic gaming device 1800 may not include separate one or more input devices, but instead may only utilize one or more depth image sensing devices. In another embodiment, a player may utilize one or more input devices and/or may utilize gestures that electronic gaming device 1800, via one or more depth image sensing devices, recognizes in order to make inputs for a play of a game. A player may interact with electronic gaming device 1800 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 1800.

Electronic gaming device 1800 may also include one or more speakers. In various examples, any of the description related to FIG. 18A can be utilized with a desktop computer, a console (FIG. 18B), a web-based system (FIG. 18C), and/or a mobile device (FIG. 18D).

FIG. 18B is an illustration of a console system 1830. Console system 1830 may include a multi-media stream 1806, one or more display screens 1804 (e.g., a first display screen, a second display screen, a third display screen, an nth display screen, etc.), an input device 1814, a device interface 1816, and a console device 1824. Console device 1824 may include one or more cameras 1808, one or more sensors 1810, memory devices 1826, one or more processors 1828, and/or one or more modules 1832. In various examples, the communication links 1822 and 1834 may communicate via a wired connection, a wireless connection, and/or any combination thereof.

FIG. 18C is an illustration of a web-based system 1840. Web-based system 1840 may include a multi-media stream 1806, one or more display screens 1804 (e.g., a first display screen, a second display screen, a third display screen, a side display screen, etc.), one or more cameras 1808, one or more sensors 1810, an input device 1814, a device interface 1816, a docking station 1818, one or more processors 1828, one or more modules 1832, and/or one or more touch screen systems 1836.

FIG. 18D is an illustration of a mobile phone system 1850. Mobile phone system 1850 may include a multi-media stream 1806, a display screen 1854, an input device/touch screen system 1856, a device interface 1816, one or more cameras 1808, one or more sensors 1810, one or more processors 1828, and/or one or more modules 1832.

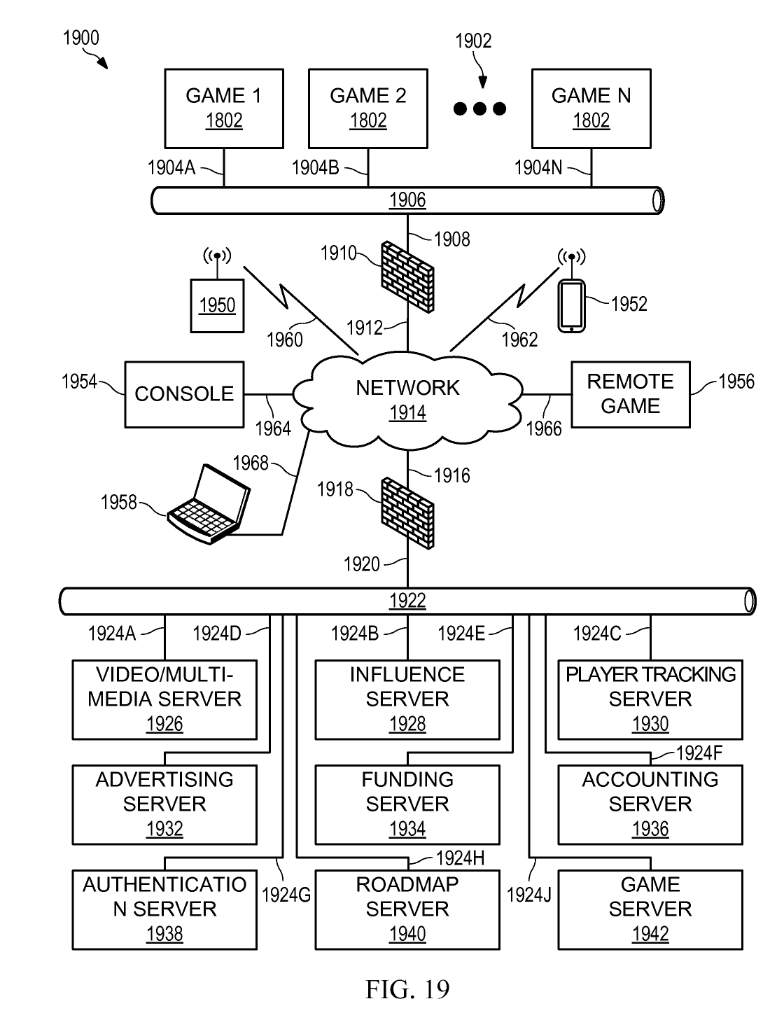

In FIG. 19, an electronic gaming system 1900 is shown. Electronic gaming system 1900 may include a video/multimedia server 1926, an influence server 1928, a player tracking server 1930, an advertising server 1932, a funding server 1934, an accounting server 1936, an authentication server 1938, a roadmap server 1940, and/or a game server 1942.

Electronic gaming system 1900 may include video/multimedia server 1926, which may be coupled (via a buss 1922, an internal link 1920, and/or a firewall 1918) to network 1914 via a network link 1916. Network 1914 may be the Internet, a private network, and/or a network cloud. One or more video streams may be received at video/multimedia server 1926 from other electronic gaming devices 1800. Video/multimedia server 1926 may transmit one or more of these video streams to a mobile phone 1952, electronic gaming device 1800, a remote electronic gaming device at a different location, a remote electronic gaming device 1956, a laptop 1958, and/or a game console 1954. Video/multimedia server 1926 may transmit these video streams via network link 1916 and/or network 1914.

Gaming server 1942 may generate and/or monitor gaming outcomes. Gaming server 1942 may provide electronic gaming device 1800 with game play content. Gaming server 1942 may provide electronic gaming device with game play math and/or outcomes. Gaming server 1942 may provide one or more of: basic game feature functionality; enhanced game feature functionality; enhanced game feature functionality based on voting history; enhanced game feature functionality based on funding history; enhanced game feature functionality based on purchasing history, enhanced game feature functionality based on usage history, enhanced game feature functionality based on a combination of voting history, funding history, usage history, and/or purchasing history, other game functionality, and/or any other virtual game functionality.

Player tracking server 1930 may track a player's funding activity, a player's preferences (e.g., language, font, sound level, etc.), voting activity, purchasing activity, submission activity, etc. Based on data obtained by player tracking server 1930, a player may be eligible for gaming rewards (e.g., free shirts), promotions, and/or other awards (e.g., special game features, etc.). For example, after a player completes their voting, funding, purchasing, usage, and/or any other criteria, the player may receive a bonus feature in a game, a tee shirt, a gaming coupon, virtual currency, project currency, and/or any other item, and/or any other service. In another example, after a player completes a first level of voting, funding, purchasing, usage, and/or any other criteria (e.g., 10 votes, $100 in funding, 50 hours of play, $1,000 in purchases, etc.), then the player may receive a bonus and/or item of value. In another example, after a player completes a second level (and/or nth level) of voting, funding, purchasing, usage, and/or any other criteria, the player may receive a higher bonus and/or item of value.

Authentication server 1938 may determine the validity of the player's identity. For example, a player identity may need to be confirmed before a funding pledge may be accepted by the player. This may be completed via a password and/or any other validation means.

Accounting server 1936 may compile, track, and/or monitor cash flows and/or other transaction data. Transaction data may include the number of votes, the size of any funding, the date and time for these fundings, the identity of the players making these fundings and/or votes, the frequency of the voting and/or funding, and/or verification data, and/or confirmation data, and/or followers data, and/or grouping data, and/or group data. Accounting server 1936 may generate tax information relating to these fundings. Accounting server 1936 may generate profit/loss reports for funding, voting, purchasing, usage, and/or any other activity. In one example, project X may have been successfully funded at a projected cost of $1,000,000. However, project X's total cost was $1,050,000. Therefore, a total loss of $50,000 was recorded. In another example, project X was funded at $1,000,000 and cost a total of $1,000,000. However, the functionality of project X actually increased sales by 25% or 10 million dollars. In another example, the functionality of project X actually decreased sales by 2% or $400,000 in revenue. In another example, an advertisement may have a success rate of 10% and a closure rate of 2% which has a value of $100,000 while the advertisement cost was $5,000. In one example, the funders may receive a percentage of the profits generated by a funded and/or submitted idea. In another example using one or more of the accounting server, tracking system, and/or statics system, the system, device, and/or method may determine that when a player utilizes and/or play for 5 hours a day that player is 4 times more like to purchase an add-on item.

Network connection (reference numbers 1916, 1920, 1960, etc.) may be used for communication between dedicated servers, thin clients, thick clients, back-office accounting systems, etc.

Laptop computer 1958 and/or any other electronic devices (e.g., mobile phone 1952, electronic gaming device 1800, etc.) may be used for downloading new gaming device applications or gaming device related firmware through remote access. Laptop computer 1958 and/or any other electronic device (e.g., mobile phone 1952, electronic gaming device 1800, etc.) may be used for uploading accounting information.

Network 1914 may be a local area network, a player's network, a wide area network, a virtual private network, an enterprise private network, the Internet, or any combination thereof. Hardware components, such as network interface cards, repeaters and hubs, bridges, switches, routers, firewalls, or any combination thereof may also be part of network 1914.

A statistics server may be used to maintain data relating to historical game play, individual voting data, group voting data, follower voting data, individual funding date, group funding data, follower funding data, individual purchasing data, group purchasing data, follower purchasing data, individual usage data, group usage data, follower usage data, individual idea submissions, group submissions, follower submissions, and/or any other gaming, player, group, follower, and/or event data. This historical data may include funding amounts, voting numbers, voting time, funding time, purchase amount, purchase quantity, discounts, playing time, service usage time, playing frequency, service frequency, and/or any other data relating to any game, device, product, and/or service.

Searching server may implement a search on one or more gaming devices to obtain gaming data. Searching server may implement a messaging function, which may transmit a message to a third party (e.g., a player) relating to a search, a search status update, a game status update, a funding status update, a voting status update, confirmation of a wager, a confirmation of a money transfer, and/or any other data relating to the player's account. The message can take the form of a text display on the gaming device, a pop up window, a text message, an email, a voice message, a video message and the like. Searching server may implement a voting (and/or funding) function, which may be an automatic mechanism. These functions of searching server 1932 may be integrated into one or more servers. In one example, a search results could state “Your friends X, Y, and Z have all voted and/or funded projects A and B. Do you want to vote for these projects too?” In another example, the search results could state “Your friends are using C and D, do you want to use C and/or D too?”

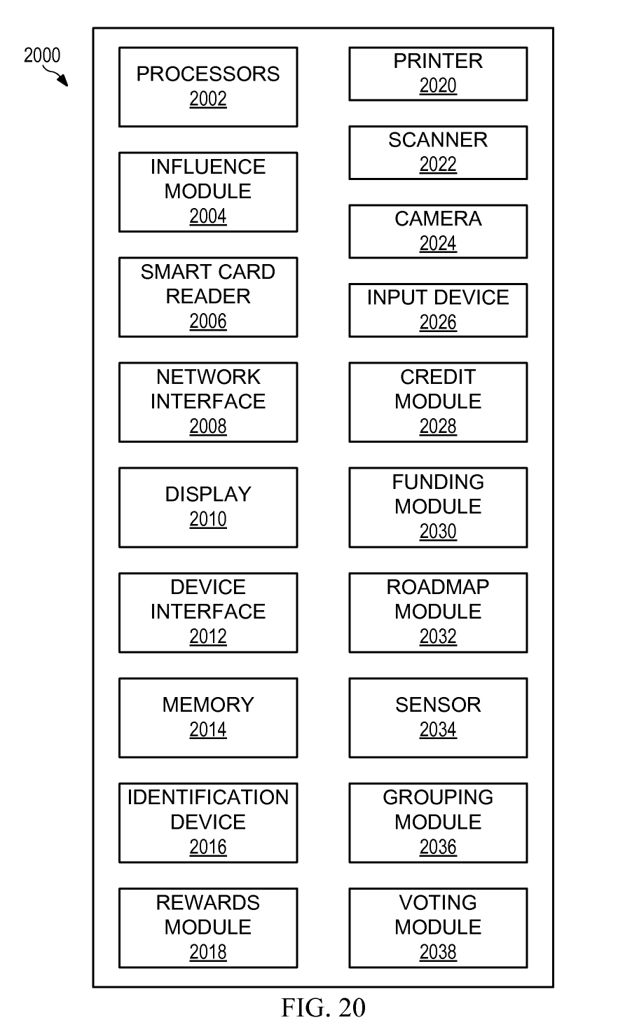

FIG. 20 shows a block diagram 2000 of electronic gaming device. Electronic gaming device may include a processor 2002, an influence module 2004, a smart card reader 2006, a network interface 2008, a display 2010, a device interface 2012, a memory 2014, an identification device 2016, a rewards module 2018, a printer 2020, a scanner 2022, a camera 2024, an input device 2026, a credit module 2028, a funding module 2030, a roadmap module 2032, a sensor 2034, a grouping module 2036, and/or a voting module 2038.

Processor 2002 may execute program instructions of memory 2014 and use memory 2014 for data storage. Processor 2002 may also include a numeric co-processor, or a graphics processing unit (or units) for accelerated video encoding and decoding, and/or any combination thereof.

Processor 2002 may include communication interfaces for communicating with electronic gaming device 1800, electronic gaming system 200, and user interfaces to enable communication with all gaming elements. For example, processor 2002 may interface with memory 2014 to access a player's mobile device through device interface 2012 to display contents onto display 2010. Memory 2014 may include communication interfaces for communicating with electronic gaming device 1800, electronic gaming system 1900, and user interfaces to enable communication with all gaming elements. For example, the information stored on memory 2014 may be printed out. Videos or pictures captured by camera 2024 may be saved and stored on memory 2014. Memory 2014 may include a confirmation module, which may authenticate any data relating to purchases, usage, game play, the player, the game, any voting data, and/or any funding data. Processor 2002 may determine the value of the voucher based on generated voucher data and data in the confirmation module. Electronic gaming device 1800 may include a player preference input device. The player preference input device may modify a game configuration. The modification may be based on data from the identification device.

Memory 2014 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 2014 may also be volatile semiconductor memory such as, dynamic random access memory (“DRAM”), static random access memory (“SRAM”), and/or any combination thereof.

Memory 2014 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 2014 may be used to store read-only program instructions for execution by processor 2002, for the read-write storage for global variables and static variables, read-write storage for uninitialized data, read-write storage for dynamically allocated memory, for the read-write storage of the data structure known as “the stack,” and/or any combination thereof.

Smart card reader 2006 may allow electronic gaming device 1800 to access and read information provided by the player or technician, which may be used for setting the player preferences and/or providing maintenance information. For example, smart card reader 2006 may provide an interface between a smart card (inserted by the player) and identification device 2016 to verify the identity of a player.

Printer 2020 may be used for printing receipts, non-gaming coupons, game coupons, advertising promotions, funding confirmation, and/or any combination thereof.

Network interface 2008 may allow electronic gaming device 100 to communicate with video/multimedia server 1926, gaming server, player tracking server, voucher server, authentication server, and/or accounting server.

Input device 2026 may be mechanical buttons, electronic buttons, a touch screen, and/or any combination thereof.

Display 2010 may show video streams from one or more content sources. Display 2010 may encompass first display screen, second display screen, third display screen, side display screen, an Nth screen, and/or another screen used for displaying video content.

Credit module 2028 may be utilized to collect monies and distribute monies (e.g., cash, vouchers, etc.). Credit device 2028 may interface with processor 2002 to complete funding options, voting options, purchases, generate and/or distribute cash prizes, distribute cash, distribute virtual currency, distribute project currency, and/or any combination thereof.

Electronic gaming device 1800 may include a device interface that a user may employ with his or her mobile device (e.g., smart phone) to receive information from and/or transmit information to electronic gaming device 100 (e.g., watch a movie, listen to music, verify identification, transmit credits, etc.).

Identification device 2016 may be utilized to allow electronic gaming device 1800 to determine an identity of a player. Based on information obtained by identification device 2016, electronic gaming device 1800 may be reconfigured. For example, the language, sound level, music, placement of video streams, placement of images, placement of gaming options, and/or the streams utilized may be modified based on player preference data.

For example, a player may have selected a specific baseball team (e.g., Florida Marlins) under the sporting event preferences, the electronic gaming device 1800 will then automatically (or via player input) display the current baseball game (e.g., Florida Marlins vs. New York Mets) onto a display screen as set in the player's options.

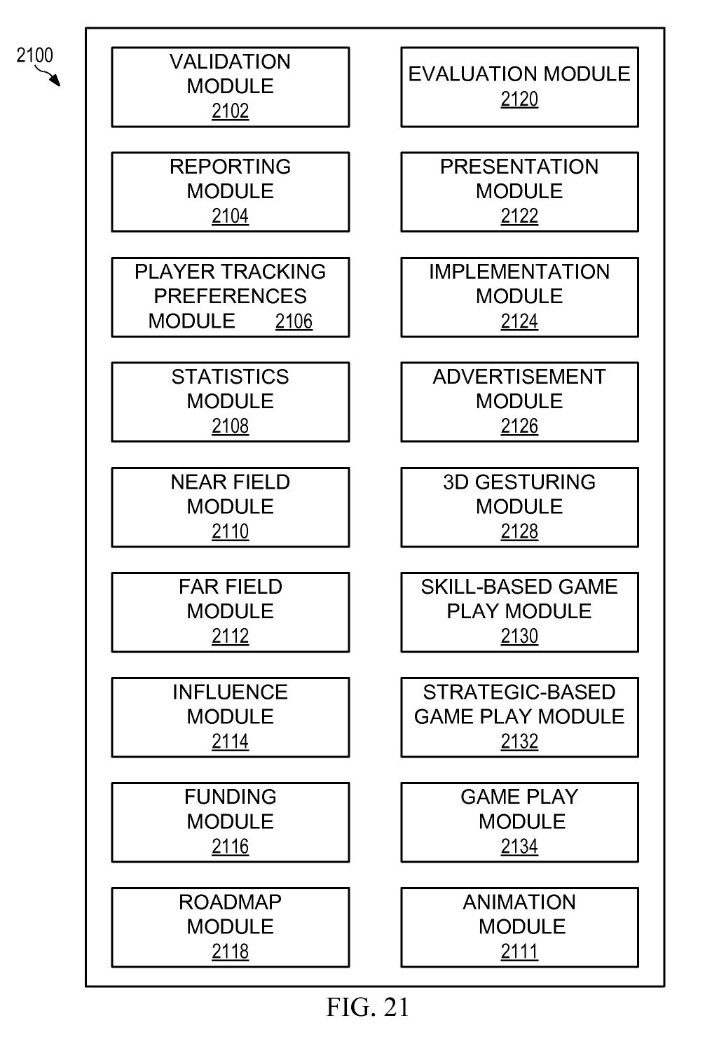

FIG. 21 shows a block diagram of memory 2100, which includes various modules. Memory 2100 may include a validation module 2102, a reporting module 2104, a player tracking preferences module 2106, a statistics module 2108, a near field module 2110, an animation module 2111, a far field module 2112, an influence module 2114, a funding module 2116, a sensor module, a scene module, a sensor and scene evaluation module, a sensor and scene output module, a reference models module, an audio module, a roadmap module 2118, a game evaluation module 2120, a presentation module 2122, an implementation module 2124, a tracking module, a signage module, an advertisement module 2126, a 3D gesturing module 2128, a skill-based module 2130, a mobile device module, a strategic-based game play module 2132, a game play module 2134, and a game configuration module.

Validation module 2102 may utilize data to confirm the validity of voting data, funding data, usage data, player data, gaming data, purchasing data, group data, follower data, trading data, and/or any other information relating to the systems, devices, and/or method disclosed in this disclosure. For example, a 3D gesturing module 2128 may be utilized to allow the player/user to play a game, make a purchase, vote for one of more projects, and/or fund one or more projects which may be validated by the validation module 2102.

Reporting module 2104 may generate reports related to a performance of electronic gaming device 1800, electronic gaming system 1900, video streams, gaming objects, funding activities, voting data, funding data, usage data, player data, gaming data, purchasing data, group data, follower data, trading data, and/or any other information relating to the systems, devices, and/or method disclosed in this disclosure. For example, the system, device, and/or method may track trading data where it may be observed that X item is the most popular traded item—a list of top traded items and/or a history of items traded may be compiled, distributed, and/or displayed.

Player tracking preferences module 2106 may compile and track data associated with a player's preferences. For example, the system, device, and/or method may determine that males in the 22-25 age group prefer by 80% to 20% item Z (e.g., a virtual weapon, product X, service Y, etc.). In another example, women in the 30-35 age group prefer (e.g., 70%) to buy product Z by procedure A. In another example, a first male age group purchases a first product type during a first time period during the day while a first female age group purchases the first product type during a second time period during the day.

Animation module 2111 may generate, compile, transmit, and/or store one or more animations and/or presentations based on one or more scene data, one or more scenes, one or more reference models, one or more game play data, one or more player profiles, and/or any combination thereof.

Game evaluation module 2120 may evaluate one or more outcomes for one or more events relating to game play.

Sensor module may generate, compile, transmit, and/or store any data relating to one or more scene data, one or more scene, and/or any other sensor data. This data may include one or more gestures (e.g., body movement made by one or more players). Scene module may generate, compile, transmit, and/or store on one or more scene data, one or more scenes, one or more reference models, one or more game play data, one or more player profiles, and/or any combination thereof. Sensor and scene evaluation module may evaluate any data stored on, transmitted to, and/or transmitted from sensor module and scene module. Sensor and scene evaluation module may obtain data including one or more gestures (e.g., body movement made by one or more players) from sensor module and compare this data to one or more body reference models, body part reference models, device reference models, gaming device reference models, floor plan reference models, and/or any other reference models from reference models module to determine one or more actions. Sensor and scene output module may evaluate the combined output of sensor module and scene module.

Reference models module may generate, compile, transmit, and/or store one or more body reference models, body part reference models, device reference models, gaming device reference models, floor plan reference models, and/or any other reference models which can be utilized by any of the other modules. Audio module may generate, compile, transmit, and/or store one or more audio structures, sound wave configurations, and/or any other audio data.

Statistics module 2108 may be used to maintain data relating to historical game play, voting activities, funding activities, voting data, funding data, usage data, player data, gaming data, purchasing data, group data, follower data, trading data, and/or any other information relating to the systems, devices, and/or method disclosed in this disclosure.

Near field game module 2110 may generate, transmit, compile, and/or store one or more data points and/or presentations relating to one or more near field gaming options and/or near field gaming functions.

Far field module 2112 may generate, transmit, compile, and/or store one or more data points and/or presentations relating to one or more far field gaming options and/or far field gaming functions.

Influence module 2114 may generate, transmit, compile, and/or store one or more data points relating to one or more voting procedures, voting structures, projects, influence criteria, and/or any other voting data. For example, males in a first age group with a first set of characteristics (e.g., income, profession, education, etc.) accounted for 25% of the approval votes for a first project while only 1% of the approval votes for the first project where from males in a second group with a second set of characteristics. In another example, males in a second age group purchased a first product on Mondays and Fridays 80% of the time.

Funding module 2116 may generate, transmit, compile, and/or store one or more data points relating to one or more funding procedures, funding structures, projects, and/or any other funding data. For example, females in a third age group with a third set of characteristics (e.g., income, profession, education, etc.) accounted for 50% of the funding amount for a third project while only 5% of the funding amount for the third project where from females in a fourth group with a fourth set of characteristics. In another example, females in a second age group purchased a first product on Tuesdays and Wednesdays 80% of the time.

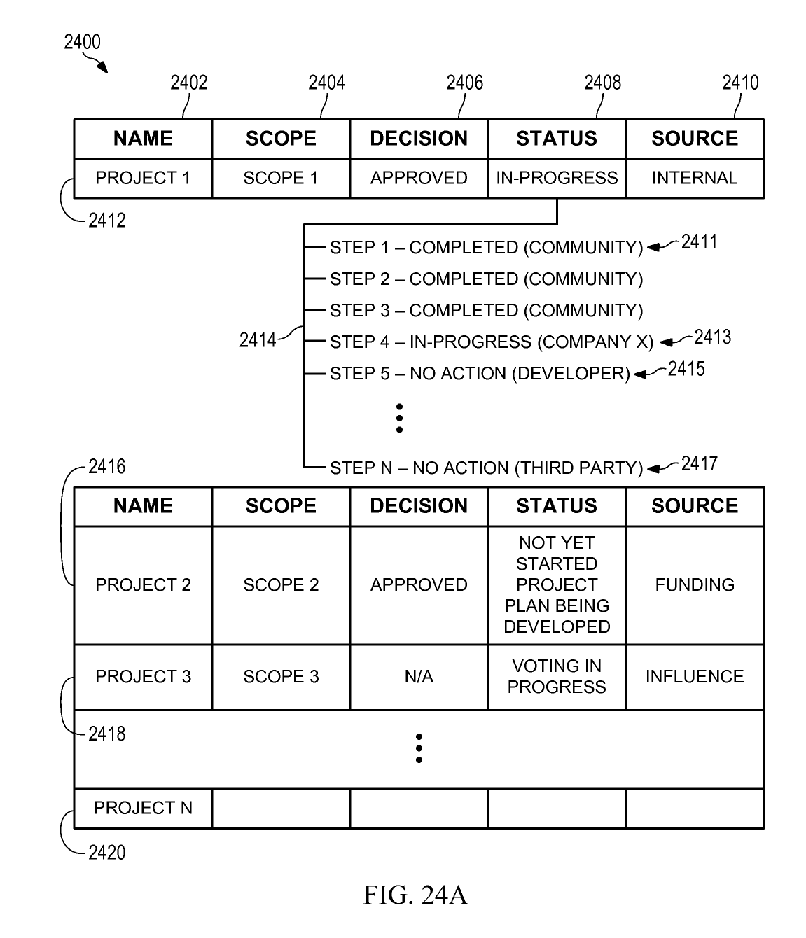

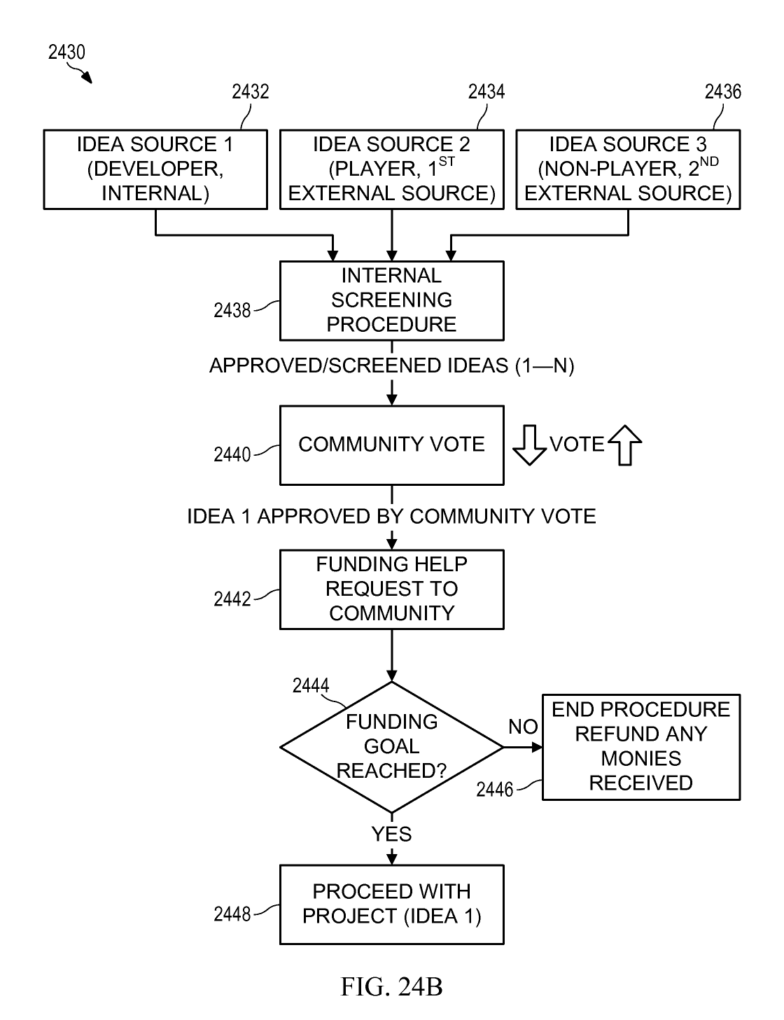

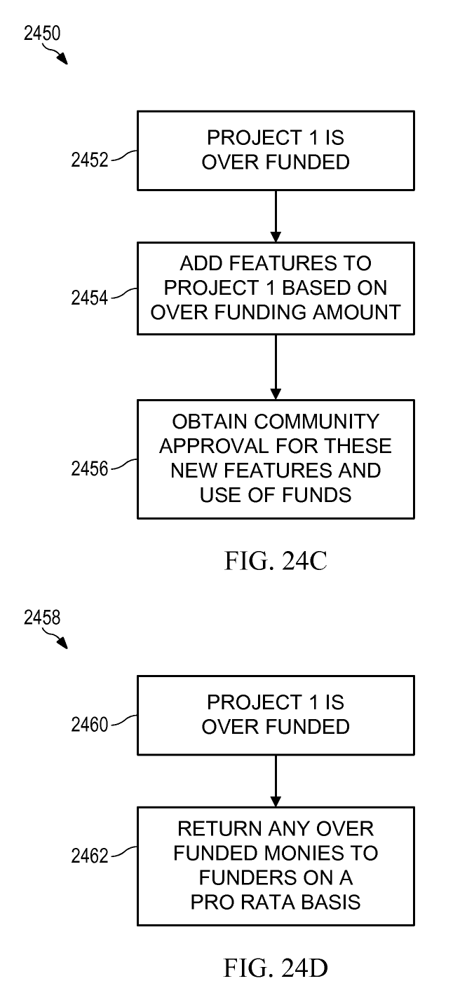

Roadmap module 2118 may generate, transmit, compile, and/or store one or more data points relating to one or more roadmap procedures, roadmap structures, projects, and/or any other roadmap data. For example, a first roadmap for a first project may include any number of steps and/or action items (e.g., 1 to N) for completion of the first project (See FIG. 24A, reference numbers 2411, 2413, 2414, 2415, and 2417).

Presentation module 2122 may generate, transmit, compile, implement, and/or store one or more presentations relating to game play, usage, purchases, advertisements, voting procedures, funding procedures, and/or any other items in this disclosure.

Implementation module 2124 may generate, transmit, compile, implement, and/or store one or more presentations relating to game play, usage, purchases, advertisements, voting procedures, funding procedures, and/or any other items in this disclosure.

Tracking module may generate, transmit, compile, and/or store one or more data points related to tracking one or more player/user activities. For example, a first player may have voted for projects 1, 5, 12, and 20 while funding projects 1 and 20 which may be compiled, stored, and analyzed to generate one or more reports and/or one or more algorithms which can be utilized for future use. In one example, the system, device, and/or method may determine why the player/user funded projects 1 and 20 but did not fund either project 5 and/or 12.

Signage module may generate, transmit, compile, initiate, and/or store one or more presentations for one or more signs and/or one or more displays.

Advertisement module 2126 may generate, transmit, compile, present, implement, initiate, and/or store one or more advertisements. Advertisement module 2126 may generate, compile, transmit, and/or store advertisement information relating to one or more game play.

Near field evaluation module may evaluate one or more outcomes for one or more events relating to near field game play. Further, near field evaluation module may determine one or more outcomes of one or more interactions.

3D gesturing module 2128 may generate, compile, transmit, and/or store one or more data points, presentations, reference modules, and/or structure relating to any aspect of 3D gesturing.

Skill-based module 2130 may generate, compile, store, and/or transmit one or more skill-based structures and/or one or more skill-based structures. Skill-based evaluation module may evaluation one or more outcomes of one or more skill-based games and/or skill-based extra game play.

Strategic-based game play module 2132 may generate, compile, store, and/or transmit one or more strategic-based structures and/or one or more strategic-based structures. Strategic-based evaluation module may evaluation one or more outcomes of one or more strategic-based games.

Game play module 2134 may generate, compile, store, and/or transmit one or more gaming structures. Gaming evaluation module may evaluation one or more outcomes of one or more games.

Mobile device module may generate, compile, store, and/or transmit one or more data relating to the mobile device. Further, mobile device module may interact and communicate with mobile device to transfer and/or receive data from and/or to mobile device.

Game configuration module may generate, compile, store, and/or transmit one or more game configuration data. Further, mobile device may also include a game configuration module. For example, a first player may be playing a first game on a console and be at a first position in the first game. The first game may be configured per the first player's preferences. The first player may transfer the first game play from the console to a mobile device where the player may continue at the first position and the game play may include the first player's preferences utilized on the console.

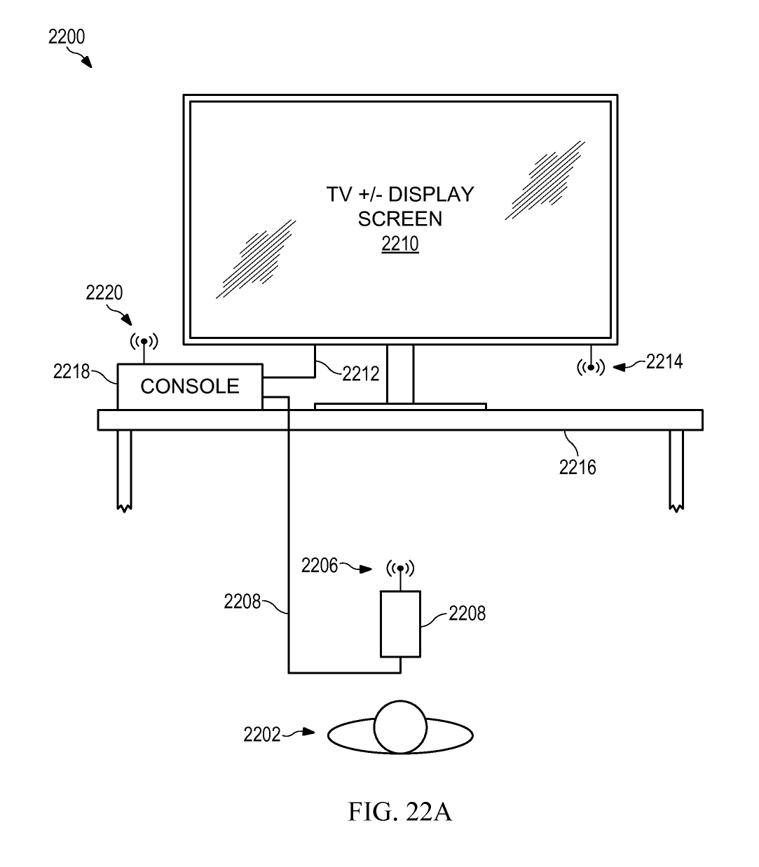

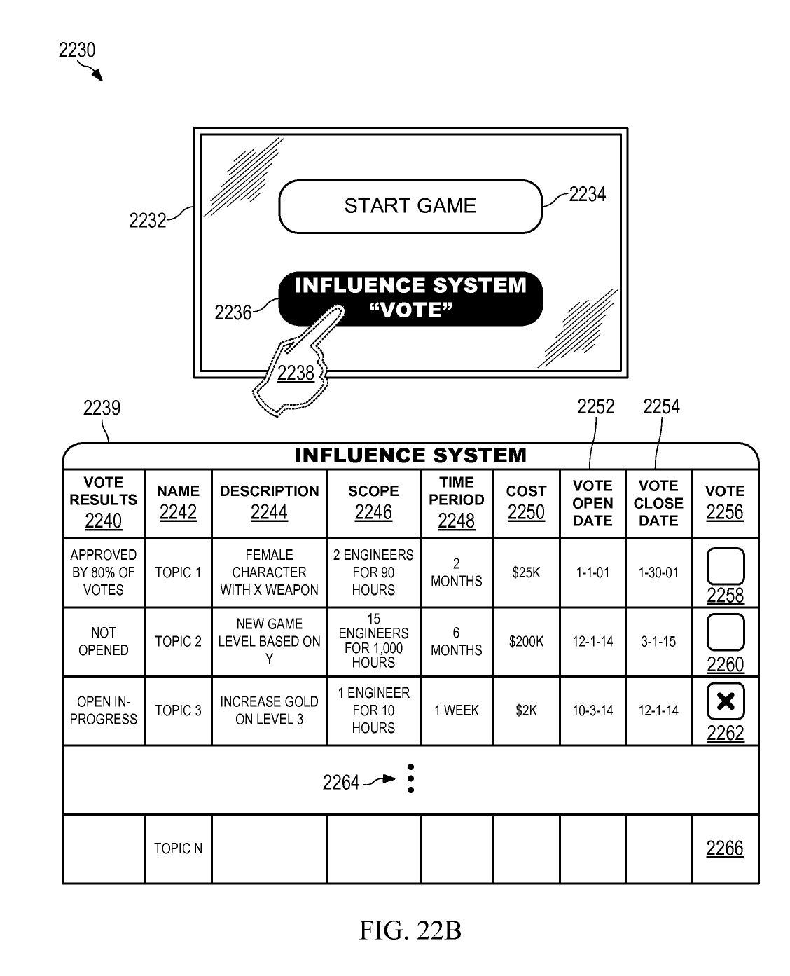

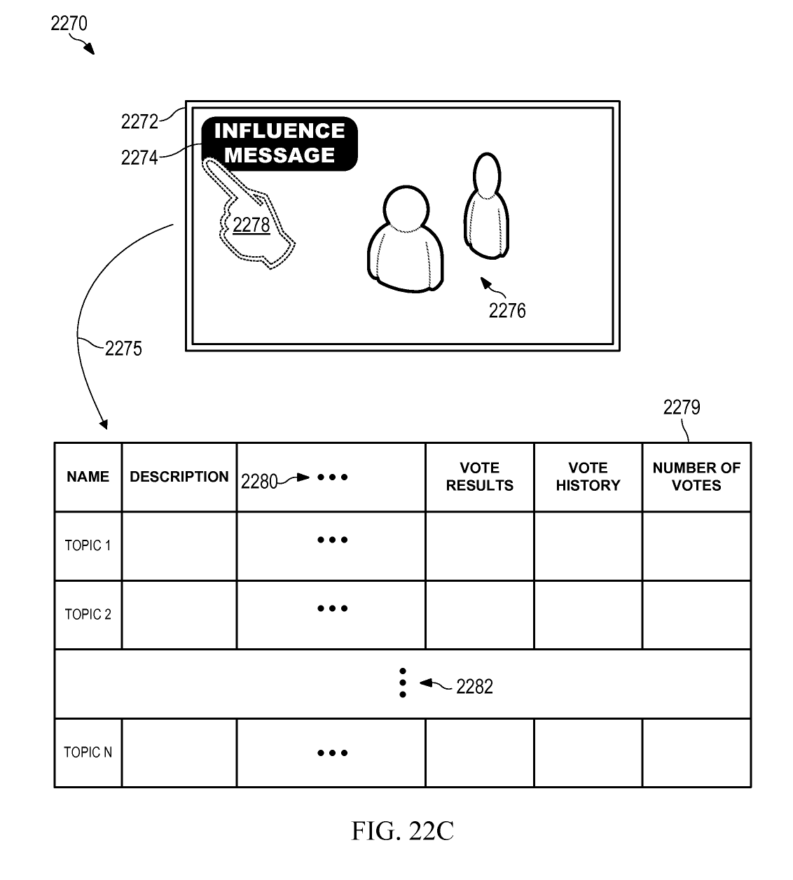

In FIG. 22A, an illustration of game play on a gaming device is shown, according to one embodiment. A first image 2200 may include a player 2202 sitting in a chair utilizing a controller 2204 to send/receive signals 2206 to/from a console 2218 located on a table 2216. Console 2218 may communicate wired 2212 and/or wirelessly 2220 with a display device 2210 (e.g., any number of display devices—1 to N). In various examples, the player 2202 may be initiating a purchase, playing a game, communicating with other players, voting for a project, and/or funding a project.

In FIG. 22B, an illustration of influence procedure for a product is shown, according to one embodiment. A second image 2230 may include a display 2232 which includes a start game button 2234 and an influence system voting button 2236. The player may select (reference number 2238) the influence system voting button 2236 which initiates an influence screen 2239. The influence screen 2239 may include a vote results area 2240, a name area 2242, a description area 2244, a scope area 2246, a time-period area 2248, a cost area 2250, a vote open date area 2252, a vote close date area 2254, and a vote area 2256. In one example, a topic 1 row 2258, a topic 2 row 2260, a topic 3 row 2262, and/or a topic N row 2264. In one example, topic 1 row 2258 may be related to one or more characteristics of a female character. In this example, the project related to topic 1 has been approved by 80% of the votes, will require 2 engineers for 90 hours to complete the project, take 2 months to complete, cost $222K, and the voting was opened on 1-1-1 and closed on 1-30-01.

In another example, a topic 2 row 2260 may be related to one or more characteristics for a new game level based on Y. In this example, the project related to topic 2 has no approval votes because it has not been opened up for voting yet, will require 122 engineers for 1,000 hours to complete the project, will take 6 months to complete, will cost $200K, and the voting will open up on 12-1-14 and the voting will close on 3-1-122.

In another example, a topic 3 row 2262 may be related to one or more characteristics for increasing a gold amount on level 3. In this example, the project relating to topic 3 has no approval votes but has been opened up for voting, will require 1 engineer for 10 hours to complete the project, will take 1 week to complete, will cost $2K, and the voting opened up on 10-3-14 and the voting will close on 12-1-14.

In another example, a topic N row 2264 may relate to any gaming characteristic, a new game, a new product, a new service, and/or any combination thereof.

In FIG. 22C, an illustration of influence procedure for a product is shown, according to one embodiment. In this example, an influence message area 2274 is shown while the player is interacting 2276 with the game on display screen 2272. If the player selects (reference number 2278) the influence message area 2274, then an influence screen 2279 is display (reference number 2275) and game play may be halted and/or paused. In one example, a player may be playing a first game and an influence message is shown on a portion of the screen. The player may indicate that the player wants to read the influence message which halts and/or pauses the first game while the player is taken to an influence message screen (see reference numbers 2275 and 2279). In various examples, the person may have been making an online purchase (and/or watching a video, and/or voting, and/or funding, and/or utilizing a service, and/or any other activity) when the influence message appear and the purchase may be halted and/or paused.

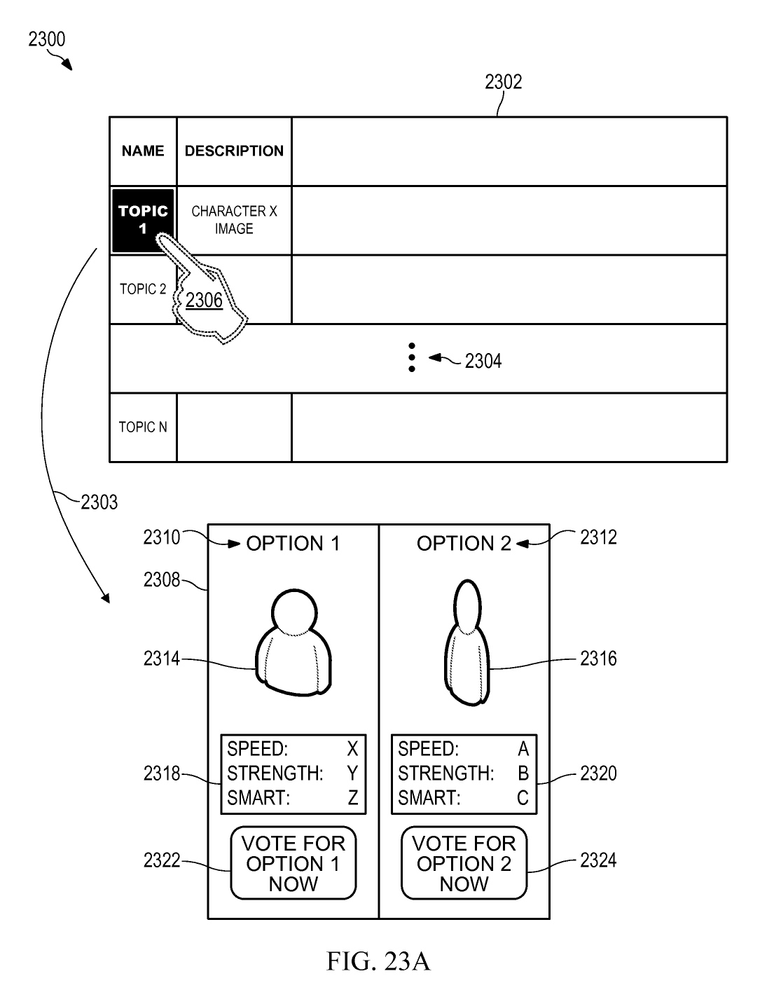

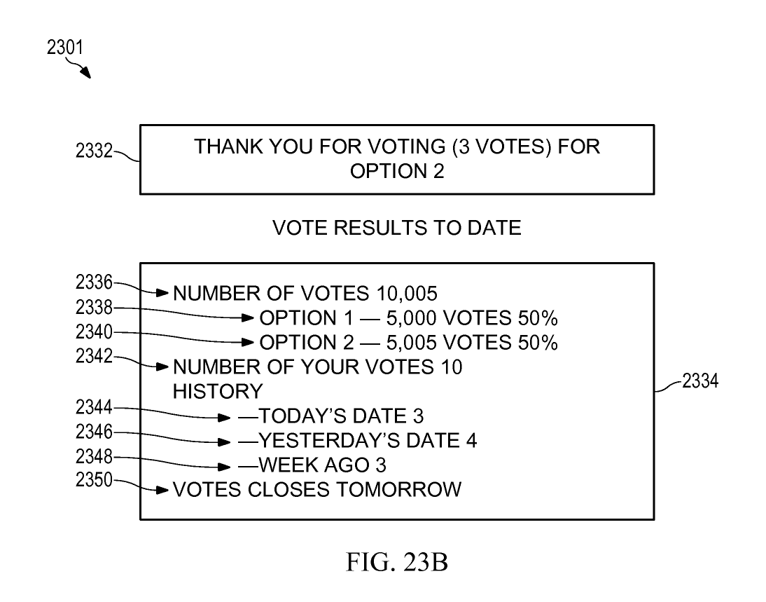

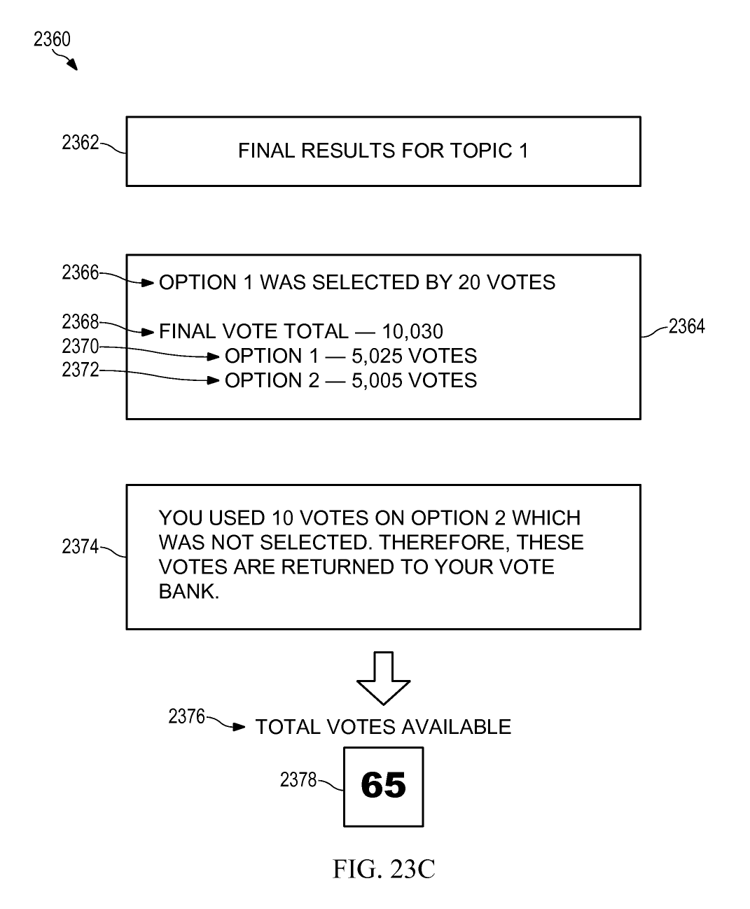

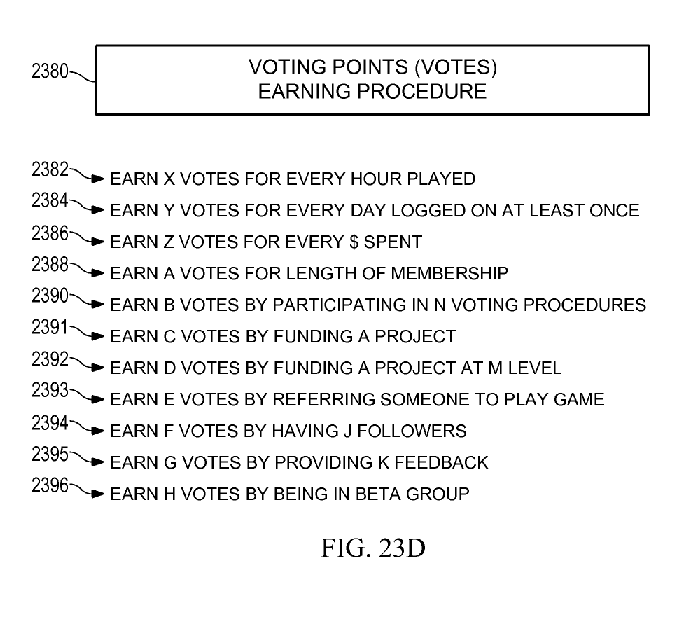

In FIG. 23A, another illustration of influence procedure for a product is shown, according to one embodiment. A third image 2300 may include an influence table 2302 which include one or more selection areas. In this example, the first topic was selected 2306 which displayed a first voting idea 2308. In this example, first voting idea 2308 has two options (e.g., option 1 (reference number 2310) and option 2 (reference number 2312)). However, any number of options (e.g., 1 to N) could be utilized. In this example, a first option 2310 includes a first character option 2314 with a first character characteristics 2318. The player may vote for first option 2310 by selecting first voting button 2322. Further, a second option 2312 may include a first character option 2316 with a second character characteristics 2320. In one example, the first character characteristics 2318 may include a speed of X (e.g., a first speed level), a strength of Y (e.g., a first strength level), a smart of Z (e.g., a first smart level), etc. In one example, the second character characteristics 2320 may include a speed of A (e.g., a second speed level), a strength of B (e.g., a second strength level), a smart of C (e.g., a second smart level), etc. In another example, the characteristics may relate to any attribute (e.g., healing power, height, weight, color, shape, etc.) of any character. Further, the characteristics may relate to any attribute (e.g., speed, cost, quality, reliability, responsiveness, etc.) of any service (e.g., delivery, professional service, etc.). In addition, the characteristics may relate to any attribute (e.g., size, color, cost, etc.) of any product (e.g., watch, car, refrigerator, etc.).

In FIG. 23B, another illustration of an influence procedure for a product is shown, according to one embodiment. In one example, the system may display (after a person has voted) an image 2301 which includes a first message 2332 which may state “thank you for voting (3 votes) for option 2”. In this example, the player has utilized 3 votes from the player's vote balance. In various examples, the player may utilize one, a few, a plurality, and/or all of their votes on any voting procedure (e.g., project 1, project 2, etc.). In various examples, the votes and/or voting procedure may be limited and/or capped, the limiting and/or capping may be based on time, based on game play, based on previous voting history, based on purchases, based on usage, based on funding history, and/or any other factor. Further, the system may display the vote results to date. A second message 2334 may include a number of votes 2336 received which in this example is 10,005. The second message 2334 may further state a number of votes for a first option 2338 which in this example is 5,000 votes (50%). The second message 2334 may further state a number of votes for a second option 2340 (up to an Nth option) which in this example is 5,005 votes (50%—any percentages may be displayed based on the number of votes compared to the number of total votes). The second message 2334 may further state a number of total player votes 2342 for this voting procedure which in this case may be 10 (may be 0 to N). Further, the voting history for the player may be shown which in this example is that the player utilized 3 votes today (e.g., a first time) on this option, 4 votes yesterday (e.g., a second time), and 3 votes a week ago (e.g., an Nth time). In addition, the second message 2334 may state a vote closing time 2350 (e.g., vote closes tomorrow and/or any other time period). In another example, a project may have 49% approved and 51% non-approval votes. In this example and/or any other example in this disclosure, the project may be approved and funded by the company (instead of the community) because the community did not have enough approval votes. Further, the project may be funded by the community even though the project did not receive enough of the popular vote because an important part of the community wanted the project to proceed.

In FIG. 23C, another illustration of an influence procedure for a product is shown, according to one embodiment. In one example, a fourth image 2360 may include a final results area 2362 which states final results for topic 1. Further, fourth image 23230 may include a summary of the results area 2364 which states option 1 was selected by 20 votes 2366. Further, a final vote total 2368 of 10,030 votes may be shown with a first option total votes 2370 of 5,025 votes and a second option total votes 2372 of 5,005. In addition, a return vote's message 2374 may state you used 10 votes on option 2 which was not selected. Therefore, these votes are returned to your vote bank. Any votes utilized for a non-winning option may be returned to the player. In another example, these votes may not be returned. In a further example, these votes may be returned on a prorated basis. Further, a total player vote's available message 2376 may be shown along with a total vote's number area 2378 (e.g., 235 votes and/or any other number (e.g., 0-N)). In one example, a player may utilize 10 votes on option 2 which was not selected and because the system, device, and/or method is designed to not return any used votes, the player does not receive any of the 10 votes back. In another example, a player may utilize 10 votes on option 2 which was not selected and because the system, device, and/or method is designed to only return a portion of any used votes, the player receives a percentage (and/or portion) of the 10 votes back (e.g., 5%, 10% . . . 50%, 52%, . . . 83%, 95%, etc.).

In FIG. 23D, another illustration of an influence procedure for a product is shown, according to one embodiment. In one example, a voting earning procedure menu screen 2380 is shown. In one example, a first method of earning votes 2382 may include earning X votes for every hour played. In one example, a second method of earning votes 2384 may include earning Y votes for every day logged on at least once. In one example, a third method of earning votes 2386 may include earning Z votes for every $ spent. In one example, a fourth method of earning votes 2388 may include earning A votes for the length of membership time. In one example, a fifth method of earning votes 2390 may include earning B votes by participating in X voting procedures. In one example, a sixth method of earning votes 2391 may include earning C votes by funding a project. In one example, a seventh method of earning votes 2392 may include earning D votes by funding a project at an M level. In one example, an eighth method of earning votes 2393 may include earning E votes for referring someone to play the game. In one example, a ninth method of earning votes 2394 may include earning F votes by having J followers. In one example, a tenth method of earning votes 2395 may include earning G votes by providing K feedback submissions. In one example, an eleventh method of earning votes 2396 may include earning H votes by being in a Beta group. These methods of earning votes may be combined.

In one example, a first method of earning votes 2382 may include earning X votes for every hour played—in this example, a player may earn (e.g., 0.5, 1, 1.5, 1.75, . . . 100 . . . any number) of votes for each specific (and/or predetermined) time period (e.g., 1 minute, 5 minutes, 30 minutes, 1 hour, 5 hours, 1 day, 1 week, 1 month, etc.) of play. In another example, a second method of earning votes 2384 may include earning Y votes for every day logged on at least once—in this example, a player may earn (e.g., 0.5, 1, 1.5, 1.75, 5, 10, . . . 100 . . . any number) of votes for a specific (and/or predetermined) number (e.g., 2, 3, 4, . . . , any number, etc.) of consecutive days of logging on. In one example, a third method of earning votes 2386 may include earning Z votes for every $ spent—in this example, a person may earn (e.g., 1, 2, 3, 4, 5, . . . any number) of votes for each and/or a predetermined number of dollars spent on purchases. In one example, a fourth method of earning votes 2388 may include earning A votes for a length of membership time—in this example, a person may earn votes based on the length of membership (e.g., 1 month, . . . 23 months, . . . , 1 year, etc.). In one example, a fifth method of earning votes 2390 may include earning B votes by participating in X voting procedures—in this example, a person may receive a first level of votes (e.g., 1) for participating in a first level of voting procedures (e.g., 5) and then the person may receive a second level of votes (e.g., 5) for participating in a second level of voting procedures (e.g., 15). There may be any number of levels (e.g., 1 to N) and any level of votes granted (e.g., 1 to N) and any level of voting procedure levels (e.g., 1 to N). This structure may be used with any example disclosed in this disclosure.

In one example, a sixth method of earning votes 2391 may include earning C votes by funding a project—in this example, a person may receive a first level of votes (e.g., 5) for participating in a first level of funding procedures (e.g., 1) and then the person may receive a second level of votes (e.g., 20) for participating in a second level of funding procedures (e.g., 3). There may be any number of levels (e.g., 1 to N) and any level of votes granted (e.g., 1 to N) and any level of funding procedure levels (e.g., 1 to N). In one example, a seventh method of earning votes 2392 may include earning D votes by funding a project at an M level—in this example, a person may receive a first level of votes (e.g., 23) for participating in at a first level of funding (e.g., $500.00) and then the person may receive a second level of votes (e.g., 25) for participating in at a second level of funding (e.g., $1,500.00). There may be any number of levels (e.g., 1 to N) and any level of votes granted (e.g., 1 to N) and any level of funding levels (e.g., 1 to N). In one example, an eighth method of earning votes 2393 may include earning E votes for referring someone to play the game—in this example, a person may receive a first level of votes (e.g., 1) for referring other people at a first level of referrals (e.g., 1) and then the person may receive a second level of votes (e.g., 10) for referring other people at a second level of referrals (e.g., 8). There may be any number of levels (e.g., 1 to N) and any level of votes granted (e.g., 1 to N) and any level of referral levels (e.g., 1 to N). In one example, a ninth method of earning votes 2394 may include earning F votes by having J followers—in this example, a person may receive a first level of votes (e.g., 5) for having followers at a first level (e.g., 10) and then the person may receive a second level of votes (e.g., 50) for having followers at a second level (e.g., 50). There may be any number of levels (e.g., 1 to N) and any level of votes granted (e.g., 1 to N) and any level of follower levels (e.g., 1 to N). In one example, a tenth method of earning votes 2395 may include earning G votes by providing K feedback submissions—in this example, a person may receive a first level of votes (e.g., 1) for a first level of submissions (e.g., 5) and then the person may receive a second level of votes (e.g., 4) for a second level of submissions (e.g., 15). There may be any number of levels (e.g., 1 to N) and any level of votes granted (e.g., 1 to N) and any level of submission levels (e.g., 1 to N). In one example, an eleventh method of earning votes 2396 may include earning H votes by being in a Beta group.

In FIG. 24A, another illustration of an influence procedure for a product is shown, according to one embodiment. In this example, a roadmap image 2400 may include a name area 2402, a scope area 2404, a decision area 2406, a status area 2408, and a source area 2410. Further, a first project 2412 may include a project 1 title in name area 2402, a first scope description in scope area 2404, a decision message in decision area 2406, a status message (e.g., the project is being worked on, denied, cancelled, approved, pending, finished, started, will start on X date, on hold, etc.) in status area 2408, and a source message (e.g., submitted by internal sources, external source, player, vendor, third party, etc.) in source area 2410. Further, a sub-project steps 2414 may include all of the steps with a status for each (e.g., completed, in-progress, no action, denied, cancelled, approved, pending, finished, started, will start on X date, on hold, needs additional funding, etc.). In one example, the entity funding a specific piece of the project will be noted. For example, reference number 2411 shows that the community funded step 1 (also steps 2 and 3), reference number 2413 shows that the company funded step 4, reference number 2415 shows that the developer funded step 5, and reference number 2417 shows that a third party funded step N.

Further, a second project 2416 may have been approved but may have a status of not yet started because the project plan is being developed—this project may have been funded by the community. In addition, a third project 2418 may have a no decision status because the third project 2418 is still in the voting process and may have been submitted by an influence person. Further, up to an Nth project 2420 may be displayed with corresponding data. Projects may be submitted by internal sources, external sources, players, vendors, and/or third parties. Further, ideas submitted by these entities may be combined. In one example, a first submission by an internal source relates to creating a first player with various characteristics and a second submission by an external source relates to creating a second player with various characteristics. In one example, these two submissions may be combined to form a first project.

In FIG. 24B, another illustration of an influence procedure for a product is shown, according to one embodiment. In this example, there may be Nth number of sources for project ideas. For example, three sources which include a first source 2432 (e.g., idea source 1—developers, internal sources), a second source 2434 (e.g., idea source 2—players, first external source), and an Nth source 2436 (e.g., idea source N—non-player, second external source). Once an idea is submitted, an internal screen procedure 2438 is initiated—this procedure validates the idea and develops a cost/benefit analysis. Further, the approved/screened ideas (e.g., 1 to N) may be submitted to the community for a vote. In the community vote 2440, the community (e.g., players, etc.) may give an up or down vote.

In this example, a first idea was approved by the community vote. In one example, a funding help request to community 2442 may be initiated. In another example, the system, device, and/or method may determine whether the funding goal has been reached 2444. If the funding goal has not been reached, then the system, device, and/or method may end and any fund may be returned to one or more sources (e.g., player, etc.) 2446. In another example, if the funding goal has been reached, then the system, device, and/or method may proceed with the project (e.g., idea 1) 2448.

Please note that these ideas submitted by these entities may be combined. In one example, a first submission by an internal source relates to creating a first player with various characteristics and a second submission by an external source relates to creating a second player with various characteristics. In one example, these two submissions may be combined to form a first project.

In FIG. 24C, another illustration of an influence procedure for a product is shown, according to one embodiment. In this example, the system, device, and/or method may determine whether project 1 has been overfunded (e.g., step 2452). If project 1 has been overfunded, then the system, device, and/or method may add features to project 1 based on the overfunding amount (step 2454). Further, the new features for project 1 may be submitted to the community to obtain community approval for these new features and/or any other use of funds (step 2456). In one example, an approved project for a new product had a funded budget of $100,000. The approved project for the new product had 10 items that needed to be completed to create the new product. However, the completion of the new product only required $240,000. Therefore, features 11-15 were added to the new product at a cost of $30,000 and the new product may be released with 15 items, instead of the original 10 items approved. Further, these additional features and/or items (11-15) may be submitted to the community of funders (only the individuals that funded the project not the entire community) to obtain their approval before these new features and/or items are implemented. In addition, any number of new features may be submitted to the community and the community is allowed to select and/or vote on and/or fund the additional features. For example, 10 items may be submitted to the community where all 10 items cost $6,000 to implement and then the community may vote for their top 5 choices to be added to the new product to utilize the $30,000 in additional funds (e.g., 5 items times $6,000 per item equals $30,000—added to the $240,000 already spent equals the total funded budget of $100,000). In another example, 10 items may be submitted to the funders (only the individuals that funded the project not the entire community) where all 10 items cost $6,000 to implement and then the funders (only the individuals that funded the project not the entire community) may vote for their top 5 choices to be added to the new product to utilize the $30,000 in additional funds (e.g., 5 items times $6,000 per item equals $30,000—added to the $240,000 already spent equals the total funded budget of $100,000).

In FIG. 24D, another illustration of an influence procedure for a product is shown, according to one embodiment. In one example, when a project is overfunded, the method may determine whether the project is overfunded (step 2460). The method may return any overfunded monies to funders (e.g., people who paid to fund project 1) on a pro rata basis (step 2462). In one example, an approved project for a new product had a funded budget of $100,000. The approved project for the new product had 10 items that needed to be completed to create the new product. However, the completion of the new product only required $240,000. The $30,000 surplus may be distributed back to the funders. In one example, there were 100 funders so each funder would receive $300 back.

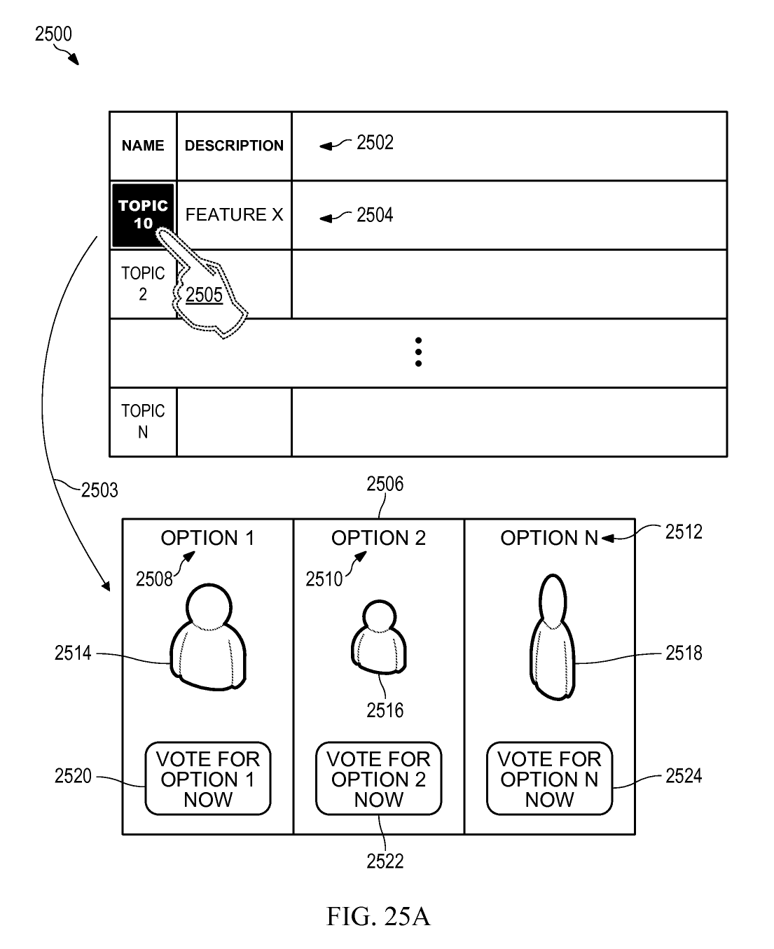

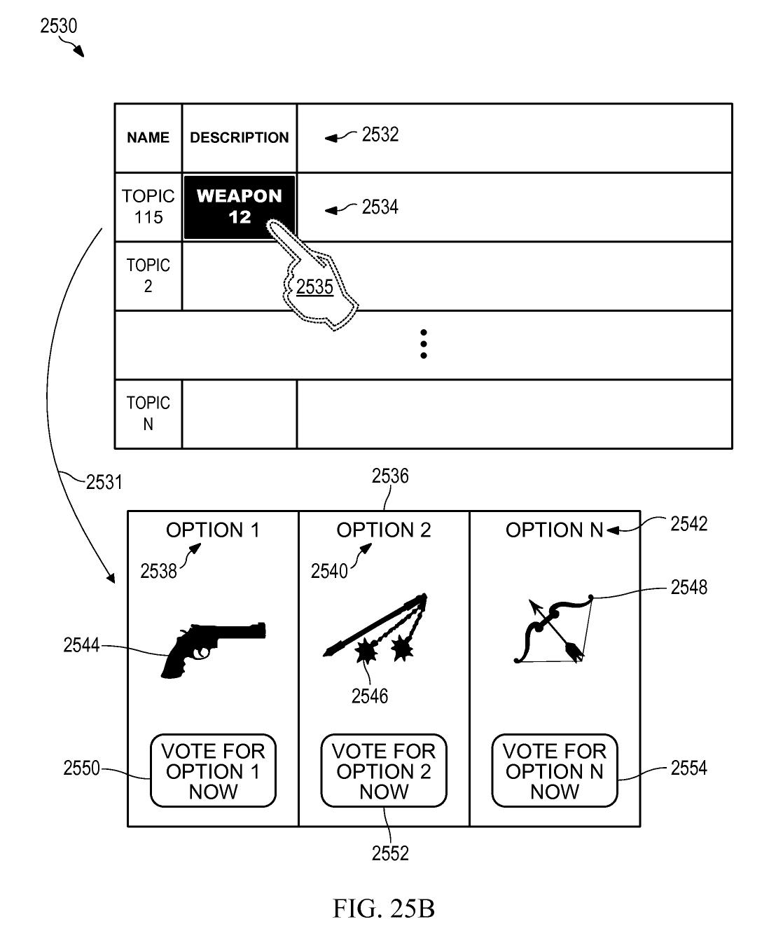

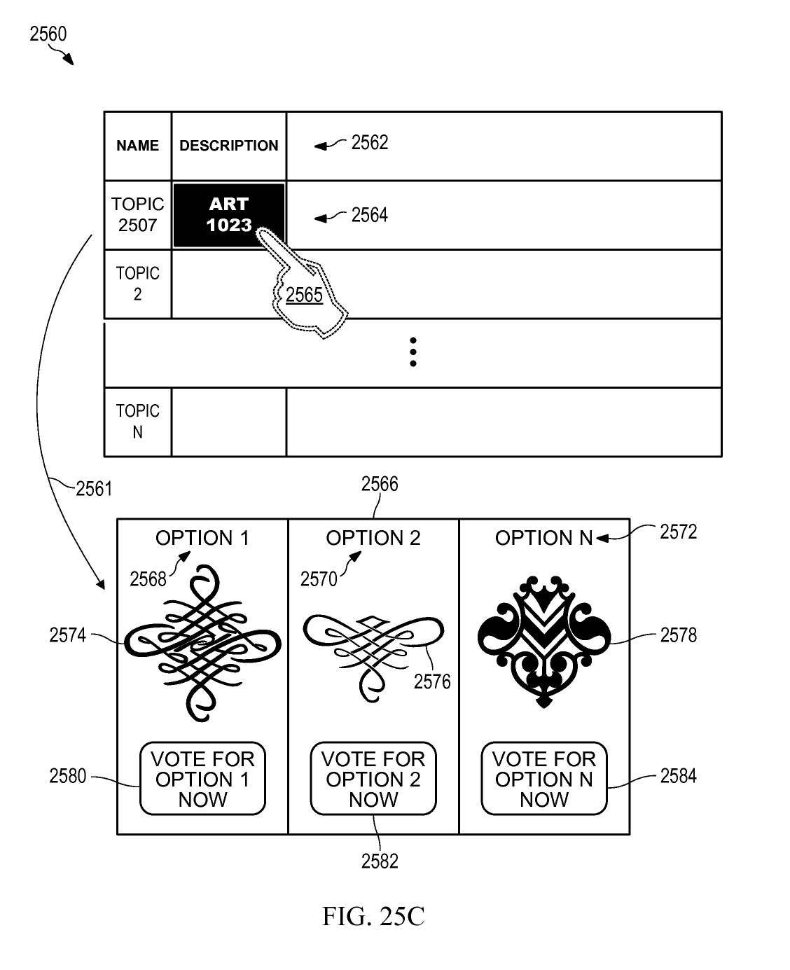

In FIG. 25A, another illustration of an influence procedure for a product is shown, according to one embodiment. A fifth image 2500 may include a project list box 2502 and a first project details 2504. After selecting (reference numbers 2503 and 2505) the first project, a first project options screen 2506 is shown. First project options screen 2506 may include a first option 2508, a second option 2510, and an Nth option 2512. First option 2508 may include a first player icon 2514 with four arms and two legs. Second option 2510 may include a second player icon 2516 with two arms and four legs. Nth option 2512 may include an Nth player icon 2518 with four arms, four sub-arms, and four legs. Further, a first voting button 2520 may be utilized to select the first option. In addition, a second voting button 2522 may be utilized to select the second option. Lastly, a third voting button 2524 may be utilized to select the Nth option.

In FIG. 25B, another illustration of an influence procedure for a product is shown, according to one embodiment. A sixth image 2530 may include a project list box 2532 and a second project details 2534. After selecting (reference numbers 2531 and 2535) the second project, a second project options screen 2536 is shown. Second project options screen 2536 may include a first weapon option 2538, a second weapon option 2540, and an Nth weapon option 2542. First weapon option 2538 may include a first weapon icon 2544 which is a gun. Second weapon option 2540 may include a second weapon icon 2546 which is a flail. Nth weapon option 2542 may include an Nth weapon icon 25425 which is a bow. Further, a first voting button 2550 may be utilized to select the first option. In addition, a second voting button 2552 may be utilized to select the second option. Lastly, a third voting button 2554 may be utilized to select the Nth option.

In FIG. 25C, another illustration of an influence procedure for a product is shown, according to one embodiment. A seventh image 2560 may include a project list box 2562 and a third project details 2564. After selecting (reference numbers 2561 and 2565) the third project, a third project options screen 2566 is shown. Third project options screen 2566 may include a first art option 2568, a second art option 2570, and an Nth art option 2572. First art option 2568 may include a first art icon 2574 which is a first artwork (e.g., star-based art work). Second art option 2570 may include a second art icon 2576 which is a second artwork (e.g., water-based art work). Nth art option 2572 may include an Nth art icon 2578 which is a third artwork (e.g., mountain-based art work). Further, a first voting button 2580 may be utilized to select the first option. In addition, a second voting button 2582 may be utilized to select the second option. Lastly, a third voting button 2584 may be utilized to select the Nth option.

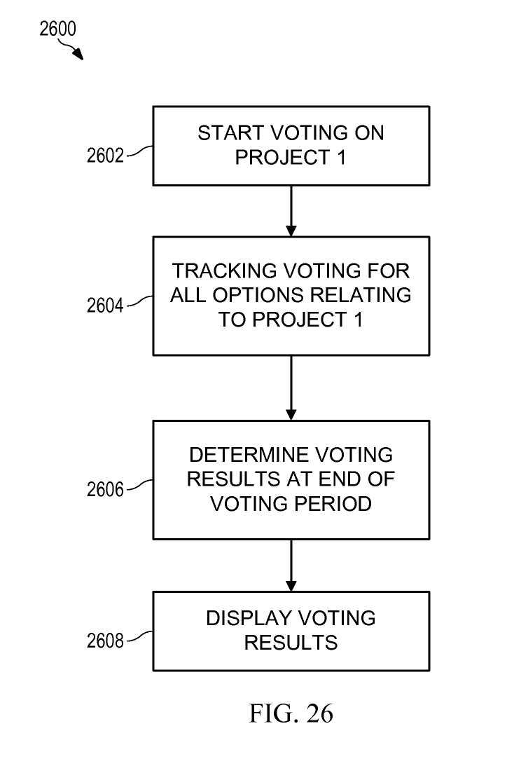

In FIG. 26, a flow diagram is shown, according to one embodiment. The method may include starting a voting procedure for a first project (step 2602). The method may include tracking voting for all options (and/or a portion and/or subset) relating to a first project (step 2604). The method may include determining the voting results at the end of a voting period (step 2606). The method may include displaying the voting results (step 2608). In one example, a voting procedure for a first project may start at a first time and the voting procedure for the first project may end at a second time. During the time period between the first time and the second time, voting data may be collected and compiled by the system, device, and/or method. In one example, a current voting total may be displayed (e.g., 504 votes for and 323 votes against the first project). In another example, the first project may be broken down into a plurality of subparts (e.g., first project part 1, first project part 2, first project part 3, . . . , first project part N). These subparts of first project may also be voted on. For example, first project part 1 has 300 votes approving it and 150 votes denying it while first project part 2 has 10 votes approving it and 440 votes denying it. In one example, a party needs to vote for every subpart during the voting process. In another example, a party may vote for one or more subparts but does not need to vote (either for or against) for every subpart.

In one example, influence system, device, and/or method may be an online platform that allows players to use time spent using and/or purchasing software/games/devise/services to vote on how the software/games/devise/services is developed and to suggest and fund individual features of the software/games/devise/services that will be developed in the future. In other examples, a system can be binary which is not a dynamic system. A binary system (which the influence system, device, and/or method are not) does not allow consumers to use time spent playing/using/purchasing a game/device/product/server to quantify how much influence they have. The influence system, device, and/or method gives users the ability to influence the software/games/devise/services based on how much they've played/used/bought it allows for more accurate decision making among the community of players/users/purchasers.

In one example, players/consumers/users are given a description of a software/games/devise/services and must choose whether to fund it based on that description. The influence system, device, and/or method allows consumers/users/purchasers/players to suggest their own ideas for the software/games/devise/services, collaborate with other consumers and developers to design a specific feature from that idea, and then crowd source the funding for that specific feature to be incorporated into the software/games/devise/services. It is an entirely new way of monetizing software/system/devices/products/services, whereby the consumer/user/purchaser is both sourcing the ideas and funding for individual features of a product/device/game/service.

In one example, the process is split into two parts: Influencing and Funding. In this example, influencing is the act that a consumer/player/user/purchaser does to influence the creation and/or direction of the product/device/game/service. In one example, time spent using and/or purchasing the software/product/device/game/service is converted by an algorithm to a set amount of influence points. These influence points can be spent on answering questions in the influence portal and/or voting in one or more voting procedures. Each of these questions may be multiple choice question that help determine the direction of future development of the software/product/device/game/service. In one example, consumer/player/user/purchaser can put any number of points into one of the question's choices. Each question may have a time limit, after which voting and/or point allocation is no longer allowed and a decision is reached. When a question reaches its time limit, the total number of points for each choice is tallied and a winner is chosen. In one example, points that were put into the losing choices may be reimbursed back to the consumer for use in future votes and/or questions.

In one example, funding is the act that a consumer/player/user/purchaser does to fund a new software/product/device/game/service and/or a new feature for the software/product/device/game/service. Consumers, a member of the development team, players, third parties, vendors, and/or any other source may use an application form and/or a procedure to submit ideas for the software/product/device/game/service to one or more communities and/or one or more developers. In various examples, the submission procedure may be electronic, non-electronic, and/or a combination of both.

The developer can comment on these ideas and the community may rank the ideas through a ranking system. After an idea reaches a certain popularity threshold, the developers may take the idea and flesh out a pitch to incorporate it into the software/product/device/game/service. Each approved pitch will be submitted for voting for a specified period of time. Consumers may then purchase a digital currency with real money, and use that currency to fund a pitch. If the pitch reaches funding, then the digital currency will be consumed, the pitch will be added to the development roadmap, and the developers will create a project plan. People who funded the pitch may be able to use their influence points to influence its creation. If it is not funded, then everyone who put the digital currency into the object to fund it may receive it back.

Additionally, the influence system, device, and/or method may serve to create an economy around consumers influencing and funding a software/product/device/game/service. Consumer/player/user/purchaser may be able to trade the influence points and funding currency, which will create a market based around influencing the software/product/device/game/service and funding new features for the software/product/device/game/service.

Further, influence system, device, and/or method may allow players and/or user to spend time using software/product/device/game/service to earn points that allows the player and/or user to vote on the direction of the software/product/device/game/service.

In addition, the funding system, device, and/or method may allow users and/or players to spend real money (virtual currency and/or project currency) to crowd fund individual features of a piece of software/product/device/game/service.

Further, the suggestion system, device, and/or method may create ideas (and/or comments) for a software/product/device/game/service. This is a multi-step process which allows users to submit an idea. After the idea is submitted, the idea may be approved for development by the development team and then the community curates and comments on the ideas. When ideas rise to the top they are turned into pitches for the voting and/or funding system.

In addition, the roadmap system, device, and/or method may aggregate all of the development tasks on a software/product/device/game/service for users to view. It distinguishes between features that were funded by developers and features that were funded by crowdfunding (See FIG. 24A, reference numbers 2411, 2413, 2415, and 2417). This roadmap uses internal tools to stay updated with the development of the software, so at any time users can see the development progress of the software in sum.

Community Platform—All of these systems are fully integrated into a community platform where people can discuss the software/product/device/game/service and the software/product/device/game/service features.

No other platform turns the act of making decisions about a products future based on a system, device, and/or method that is a function of the time/quantity purchased/usage/a consumer/player/user/purchaser spends in the software/product/device/game/service. This provides a distinct advantage of allowing the software/product/device/game/service to evolve weighted to decisions of the consumer/player/user/purchaser using the software/product/device/game/service the most.

Similarly, no other platform provides a means for users to directly fund additional features for it after release. This provides a brand new mechanism for people to pay for a live product. Instead of purchasing a subscription to gain access to the product or spending money on micro transactions, they can directly fund the product's ongoing development on a feature-by-feature basis.

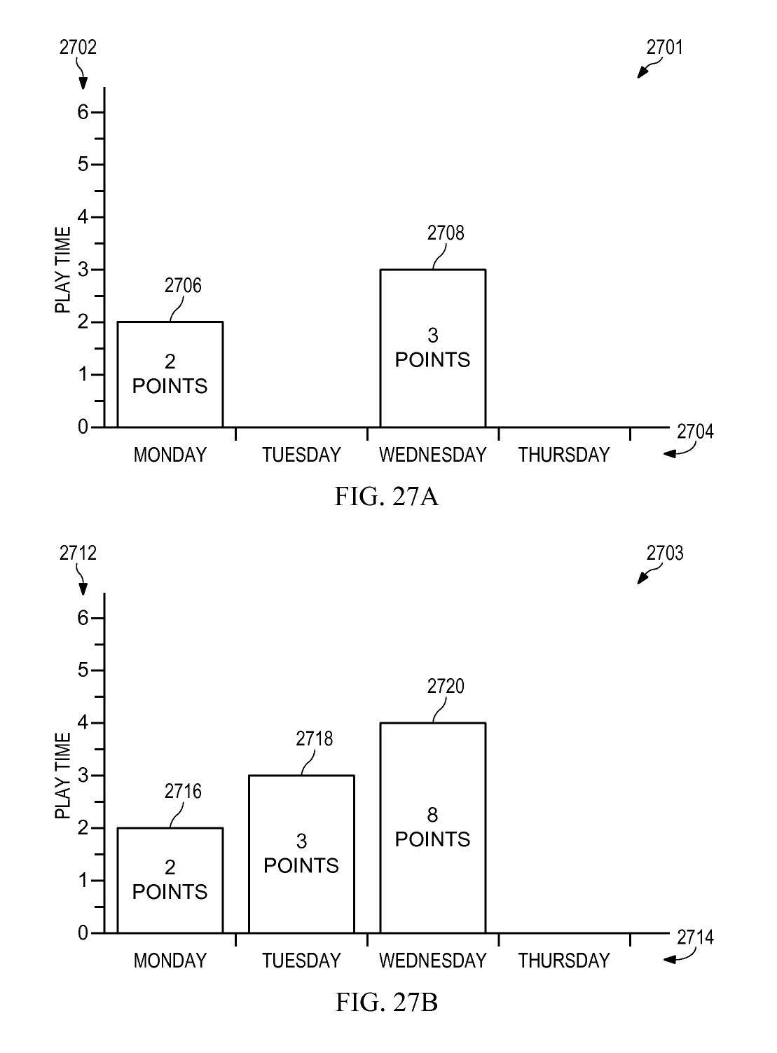

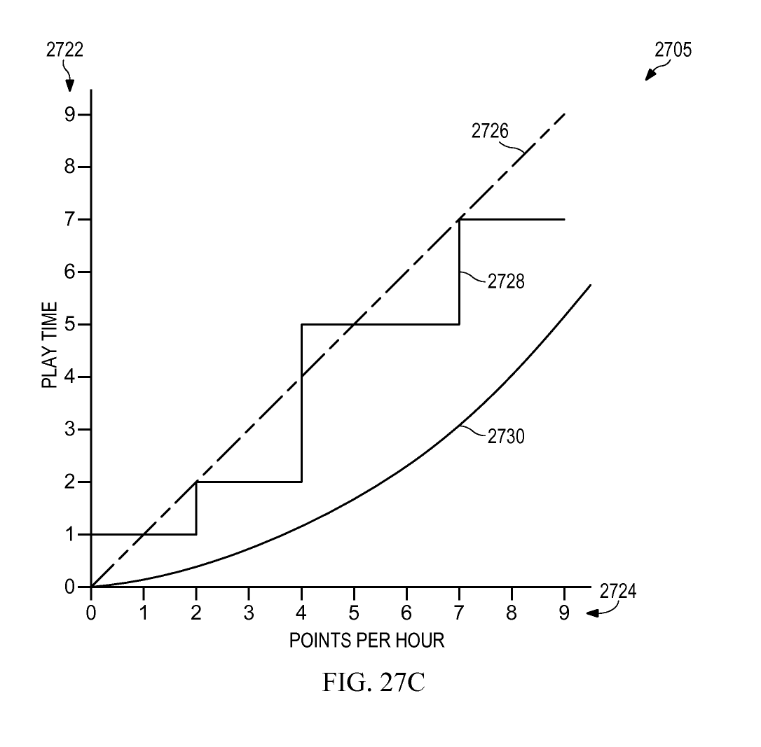

In FIG. 27A, an illustration of earning votes and/or influence criteria is shown, according to one embodiment. A first table image 2701 includes a time period scale 2704 and a play time scale 2702. It should be noted that the play time scale 2702 could be a number of times bought, number of times utilized, frequency of utilization, time period for playing, etc. Further, the time period scale 2702 may be in seconds, minutes, hours, days, weeks, months, years, etc. In this example, a player that plays during a first time period 2706 (e.g., a Monday) may earn 1 point per hour played (in other words, the player played for two hours and earned 2 points). Since the player skipped a day (e.g., a second time period—Tuesday), the player earned the same 1 point per hour played when the player played during a third time period (e.g., Wednesday). Therefore, since the player played for 3 hours, the player would have earned 3 points.

In FIG. 27B, another illustration of earning votes and/or influence criteria is shown, according to one embodiment. A second table image 2703 may show that a player earned one point per hour of game play during a first time period 2716 and a second time period 2718. Therefore, the player earned 2 points during the first time period 2716 (earned one point an hour for two hours of play) and the player earned 3 points during the second time period 2718 (earned one point per hour for three hours of play). However, since the player has played on three consecutive days, the player earned 2 points per hour of game play during a third time period 2720. Therefore, the player earned 8 points for four hours of game play during the third time period 2720 (e.g., Wednesday).

In FIG. 27C, another illustration of earning votes and/or influence criteria is shown, according to one embodiment. In this example, a first point earning line 2726 can be linear, a second point earning line 2728 can be a step function, a third point earning line 2730 can be logarithmic, and/or any other algorithm can be utilized.

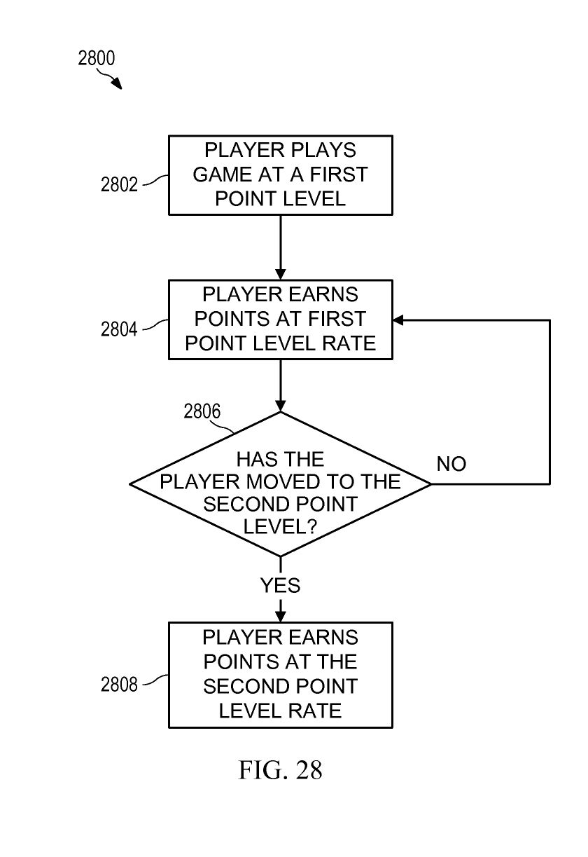

In FIG. 28, a flow diagram is shown, according to one embodiment. The method may include the player playing a game at a first point earning level (step 2802). The method may include the player earning points at the first point earning level rate (step 2804). The method may include the system, device, and/or method determining whether the player has moved to the second point earning level (step 2806). If the player has not moved to the next point earning level, the method moves back to step 2804. If the player has moved to the next point earning level, then the method may allow the player to earn points for game play at the second point earning level. For example, when a player plays for the first three hours of play, the player may earn 1 point for hour—therefore the player earns 3 points for this specific playing time. However, if the player keeps playing, the player earns 2 points per hour. Therefore, if the player plays for 2 more hours, the player will earn 4 additional points. In this case, the player earns a total of 7 points for playing 5 total hours of game play. In another example, a person may earn voting points (e.g., 1 vote) for every $1 spent and then the person may earn voting points (e.g., 2 votes) for every $1 spent over $100. This may be in total and/or during a predetermined time frame (e.g., a day, a week, two weeks, a month, etc.).

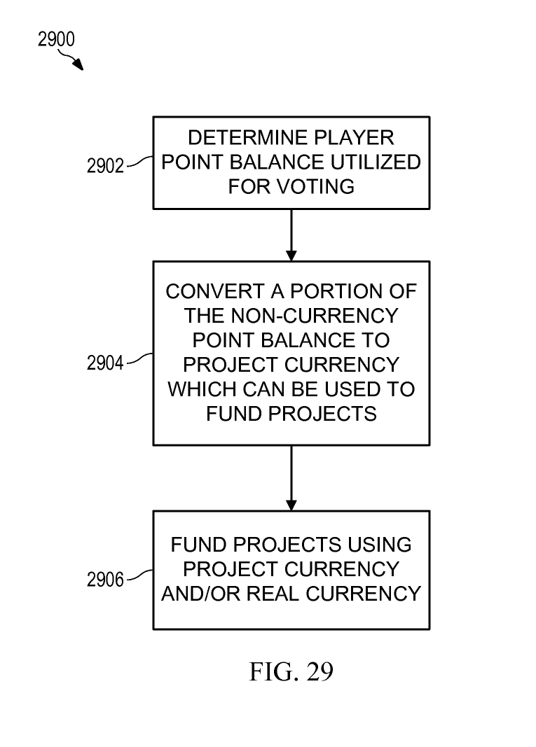

In FIG. 29, a flow diagram is shown, according to one embodiment. The method may include determining whether the player's point balance was utilized for voting (step 2902). The method may include converting a portion of the non-currency point balance to project currency which can be used to fund projects (step 2904). The method may include funding projects utilizing the project currency and/or or real currency (step 2906). In one example, the player may have earned 1,000 votes and may be able to convert all and/or a portion of these earned votes into project currency and/or real currency. In this example, the player may convert 100 votes into $100 of project currency and/or real currency (and/or any other number $1, $10, $50, etc.). In this example, the project currency can be used to fund one or more projects. Further, the real currency may be used to purchase one or more services, games, products, and/or devices.

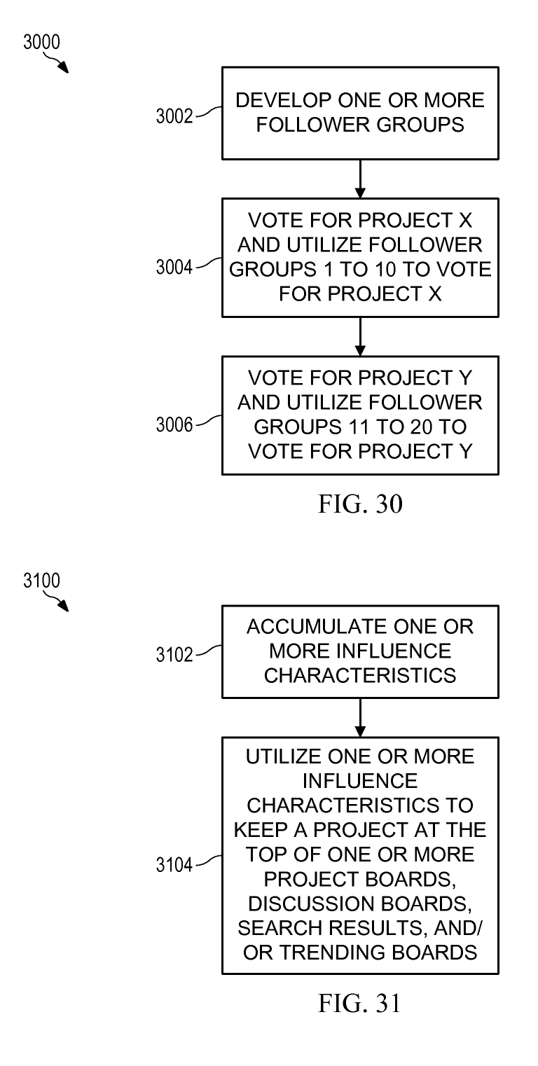

In FIG. 30, a flow diagram is shown, according to one embodiment. The method may include developing one or more follower groups (step 3002). The method may include voting for project X and utilizing follower groups 1 to 10 (and/or any number of follower groups) to vote for project X (step 3004). The method may include voting for project Y and utilizing follower groups 11 to 20 to vote for project Y (step 3006). In one example, a person may have one or more followers based on one or more criteria. The followers may allow the leader to case and/or place one or more votes for the follower. In this example, the leader has utilized followers 1-10 to vote for a specific project while the leader has utilized follower groups 11-10 to vote for a different project.

In FIG. 31, a flow diagram is shown, according to one embodiment. The method may include accumulating one or more influence characteristics (step 3102). The method may 20 include utilizing one or more influence characteristics to keep a project at the top of one or more project boards, discussion boards, search results, and/or trending boards (step 3104). In various examples, a person may have certain influence characteristics (e.g., followers, number of voting procedures participated in, number of funding procedures participated in, number of hours played, number of products bought, total amount spent, etc.) which can be utilized to place a project at the top of one or more leaderboards, project boards, searching results, trending topic, any other communication vehicle, and/or any combination thereof.

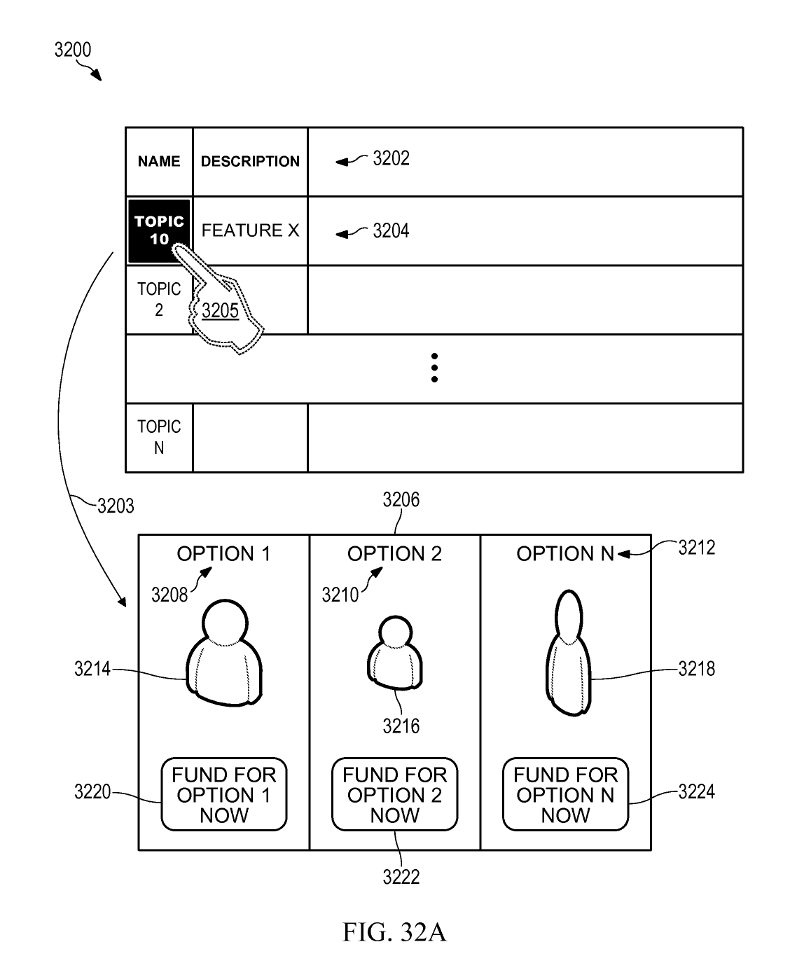

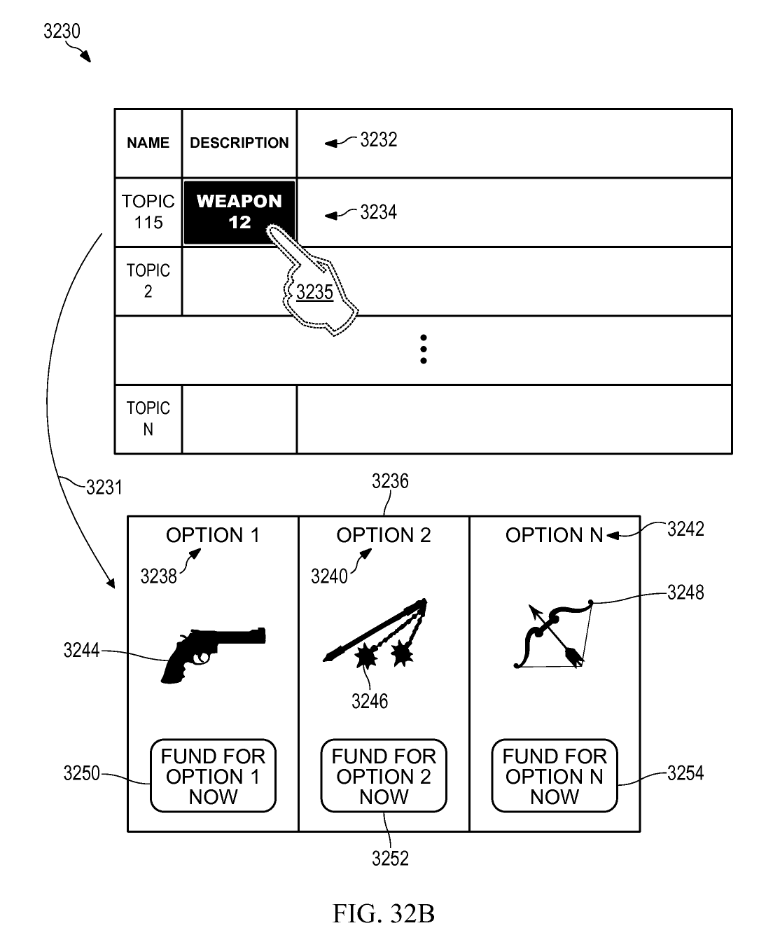

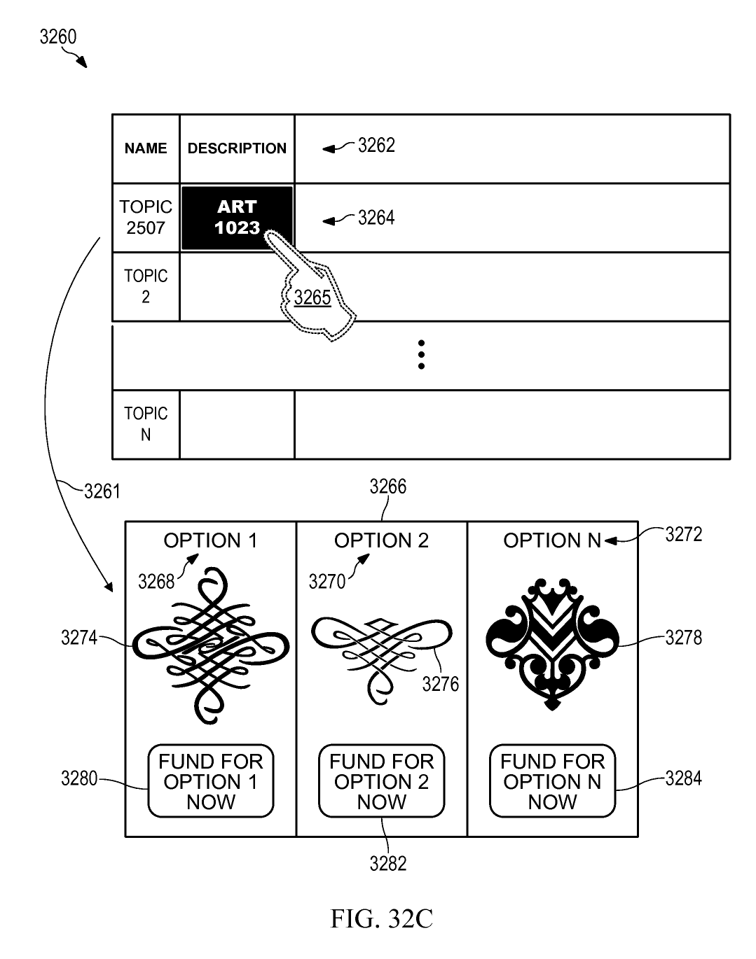

In FIG. 32A, another illustration of an influence procedure for a product is shown, according to one embodiment. A first funding image 3200 may include a project list box 3202 and a second project details 3204. After selecting the second project, a second project options screen 3206 is shown. Second project options screen 3206 may include a first option 3208, a second option 3210, and an Nth option 3212. First option 3208 may include a first icon 3214 which is a first character. Second option 3210 may include a second icon 3216 which is a second character. Nth option 3212 may include an Nth icon 3218 which is a third character. Further, a first funding button 3220 may be utilized to make a funding pledge for the first option. In addition, a second funding button 3222 may be utilized to make a funding pledge for the second option. Lastly, a third funding button 3224 may be utilized to make a funding pledge for the Nth option.

In FIG. 32B, another illustration of an influence procedure for a product is shown, according to one embodiment. A second funding image 3230 may include a project list box 3232 and a second project details 3234. After selecting the second project, a second project options screen 3236 is shown. Second project options screen 3236 may include a first weapon option 3238, a second weapon option 3240, and an Nth weapon option 3242. First weapon option 3238 may include a first weapon icon 3244 which is a fun. Second weapon option 3240 may include a second weapon icon 3246 which is a flail. Nth weapon option 3242 may include an Nth weapon icon 3248 which is a bow. Further, a first funding button 3250 may be utilized to make a funding pledge for the first option. In addition, a second funding button 3252 may be utilized to make a funding pledge for the second option. Lastly, a third funding button 3254 may be utilized to make a funding pledge for the Nth option.

In FIG. 32C, another illustration of a funding procedure for a product is shown, according to one embodiment. A third funding image 3260 may include a project list box 3262 and a first project details 3264. After selecting (reference numbers 3265 and 3261) the first project, a first project options screen 3266 is shown. First project options screen 3266 may include a first art option 3268, a second art option 3270, and an Nth art option 3272. First art option 3268 may include a first art icon 3274 with a first art configuration. Second art option 3270 may include a second art icon 3276 with a second art configuration. Nth art option 3272 may include an Nth art icon 3278 with an Nth art configuration. Further, a first funding button 3280 may be utilized to fund and/or pledge money for the first art option 3268. In addition, a second funding button 3282 may be utilized to fund and/or make a pledge for the second art option 3270. Lastly, a third funding button 3284 may be utilized to fund and/or make a pledge for the Nth art option 3272.

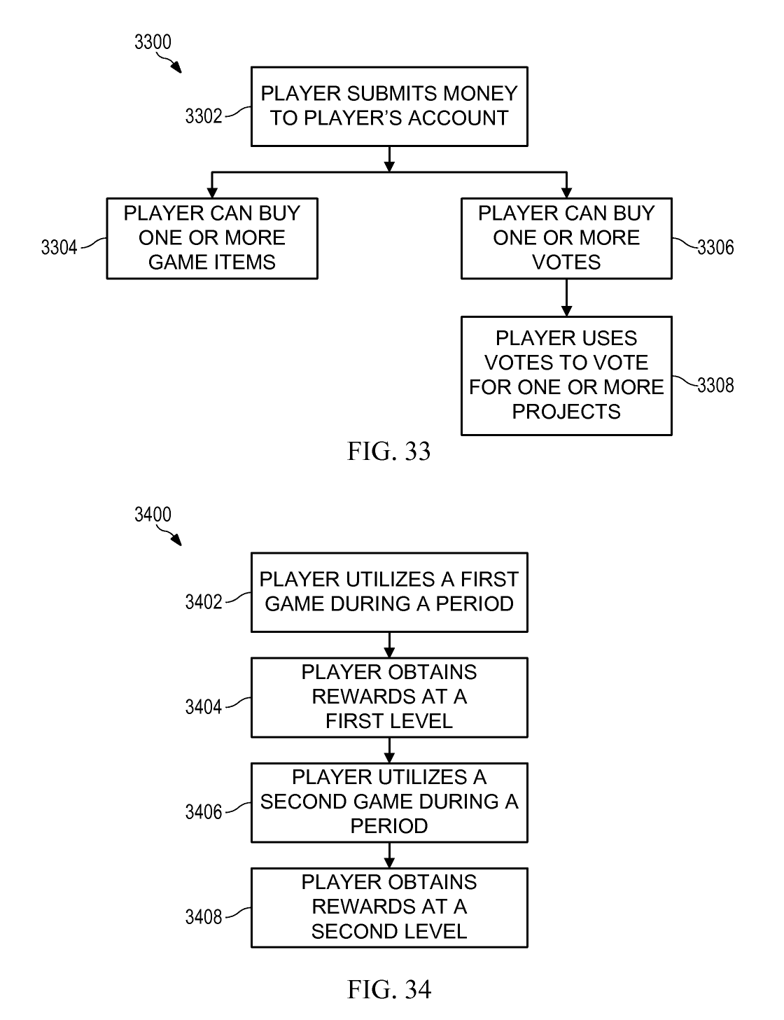

In FIG. 33, a flow diagram is shown, according to one embodiment. The method may include the player submitting money to the player's account (step 3302). The method may include the player buying one or more game items with the submitting money (step 3304). The method may include the player buying one or more votes with the submitting money (step 3306). The method may include the player utilizing one or more purchased votes to vote for one or more projects (step 3308). In addition, the method may include the player funding one or more projects with the submitted money. In one example, a player may submit $100.00 to his account to increase his account balance from 0 to $100.00. The player may utilize $50.00 of this balance to purchase one or more items (e.g., a game, a product, a service, and/or any combination thereof). The player may utilize $50.00 of this balance to purchase 500 votes which the player can utilize to vote for one or more projects.

In FIG. 34, a flow diagram is shown, according to one embodiment. The method may include the player utilizing a first game a first period (step 3402). The method may include the player obtaining rewards at a first level (step 3404). The method may include the player utilizing a second game during a second period (step 3406). The method may include the player obtaining rewards at a second level (step 3408). In one example, the first period and the second period are the same period. In another example, the first period and the second period are different periods. In another example, the first period and the second period have some overlapping time. In one example, when a player only plays a first game the player earns votes at a first rate (e.g., 1) but when the player plays both a first game and a second game, the player earns votes at a second rate (e.g., 2). In another example, when a person buys a first product, the person earns votes at a first rate (e.g., 1) but when the person buys both a first product and a second product, the person earns votes at a second rate (e.g., 3). This feature may help to cross sell one or more products.

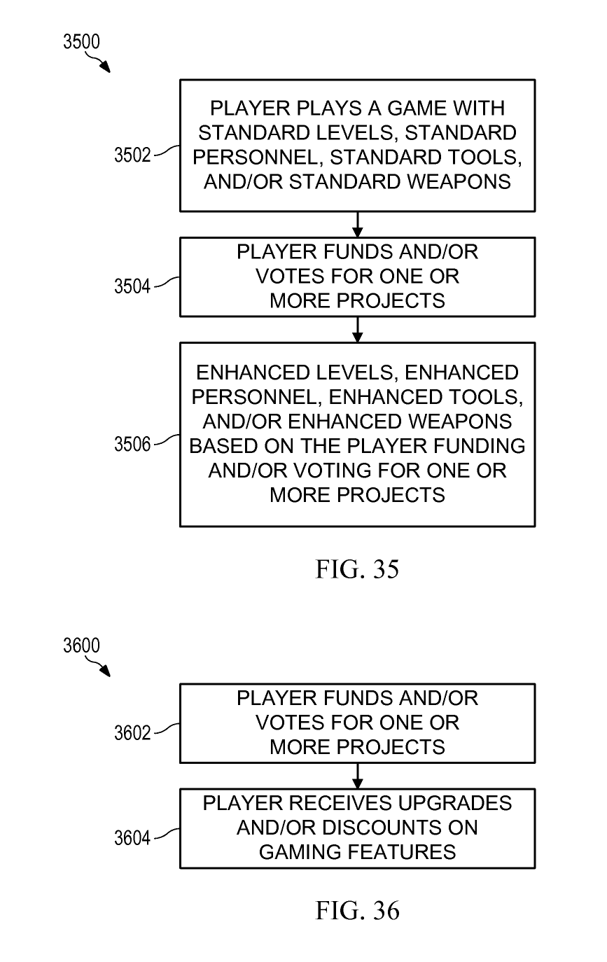

In FIG. 35, a flow diagram is shown, according to one embodiment. The method may include the player playing a game with standard levels, standard personnel, standard tools, and/or standard weapons (step 3502). The method may include the player funding and/or voting for one or more projects (step 3504). The method may include the system, device, and/or method enhancing the game levels, the player levels, personnel, tools, weapons, and/or any other feature based on the player funding and/or voting for one or more projects. In one example, a player may receive a first bonus game level based on the player funding and/or voting for one or more projects. In another example, a person may receive a free gift, rushed delivery, free delivery, and/or a discount on a purchase based on the player funding and/or voting for one or more projects.

In FIG. 36, a flow diagram is shown, according to one embodiment. The method may include the player funding and/or voting for one or more projects (step 3602). The method may include the player receiving upgrades and/or discounts on gaming features based on the player funding and/or voting for one or more projects.

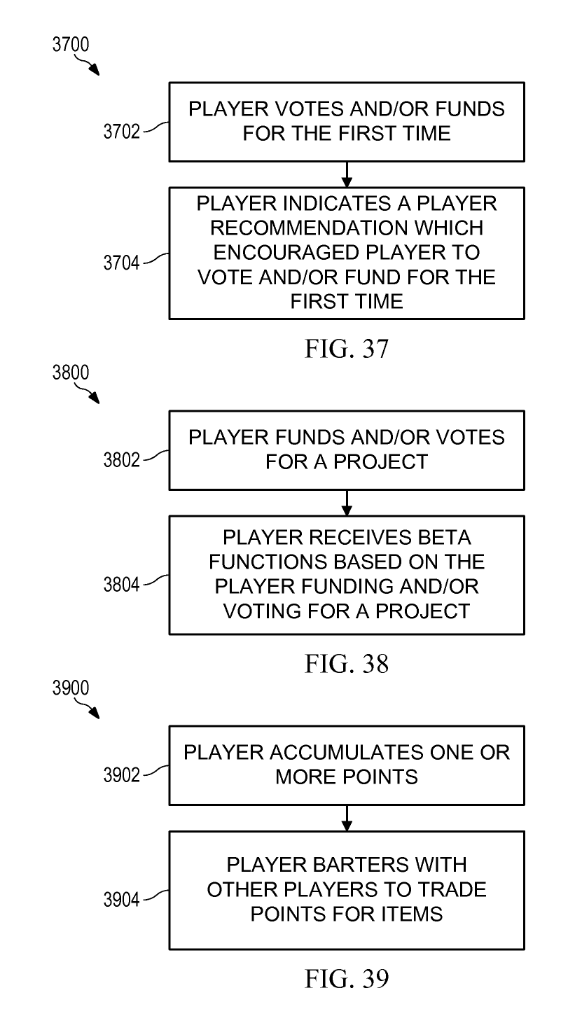

In FIG. 37, a flow diagram is shown, according to one embodiment. The method may include the player voting and/or funding for the first time (step 3702). This could also be voting and/or funding for the first time in a specific time period—in other words, not voting for the last 3 months and now voting may be the same as voting for the first time and/or may be treated differently than voting on a regular basis. The method may include the player indicating that another player recommended that this player vote and/or fund which encouraged the player to vote and/or fund a project for the first time (step 3704). In one example, the recommending player will receive a reward, a gift, a discount, project currency, virtual currency, real currency, additional votes, any item of value, and/or any combination thereof.

In FIG. 38, a flow diagram is shown, according to one embodiment. The method may include the player funding and/or voting for a project (step 3802). The method may include the player receiving a beta functionality based on the player funding and/or voting for a project (step 3804). In one example, a player which funds and/or votes for an approved project may receive a beta version of the game, product, service, and/or device to test out and provide additional feedback. In addition, the player may receive a discount on the purchase of the game, product, service, and/or device when it is fully released.

In FIG. 39, a flow diagram is shown, according to one embodiment. The method may include the player accumulating one or more points (step 3902). The method may include the player bartering with other players to trade the points for items (e.g., currency, tools, upgrades, etc.) (step 3904). In one example, a player may trade a gold pieces earned in a first game to a second player for a weapon and/or votes and/or virtual currency, and/or project currency, and/or points.

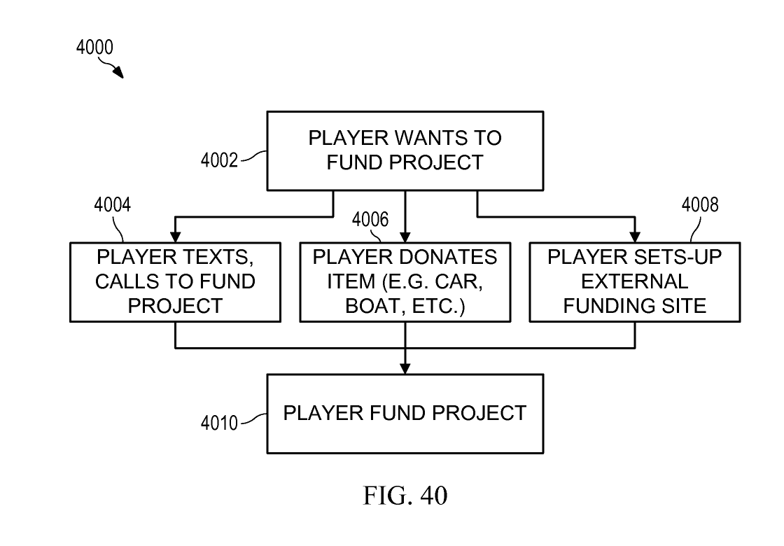

In FIG. 40, a flow diagram is shown, according to one embodiment. The method may include the player wanting to fund a project (step 4002). The method may include the player texts and/or calls to fund a project (step 4004). The method may include the player donating items (e.g., a car, a computer, a boat) to a funding source to fund a project (step 4006). The method may include the player setting up external funding site to fund a project (step 4008). The method may include the player funding the project (step 4010). In one example, a player may fund a project by placing a text and/or calling a number where part of the money generated by texting and/or calling is utilized to fund a project. In another example, the player may establish a funding site to generate donates and/or pledges which are utilized to fund a project.

If should be noted that any of the funding, voting, project road-mapping, and/or any other function described in FIGS. 18A to 40 can be utilized with the multiple platform gaming functionality described in FIGS. 1 to 17D.

In one embodiment, the system for voting on one or more projects may include one or more memory devices and one or more processors. The one or more processors may receive at least a first project; present the first project to a voting community; receive one or more votes relating to the first project from one or more members of the voting community; and/or determine a status of the first project based on the received votes.

In one example, the first project may have been submitted by an internal company source, a customer of a company, and/or a third party source. Further, the first project may have been determined and/or screened by comparing a first project details to one or more criteria. In addition, the one or more processors may generate a first project condition for the first project. Further, the first project condition may be that the first project is approved to move to a funding stage. In another example, the one or more processors may generate a second project condition for the first project. Further, the second project condition may be that the first project is approved to an implementation stage. In addition, the one or more processors may generate a third project condition for the first project. Further, the third project condition may be that the first project has been rejected. In another example, the one or more processors may generate a fourth project condition for the first project. In addition, the fourth project condition may be that the first project is still pending and/or active. In one example, the one or more processors may generate an action plan based on a first project approval. Further, the action plan may have a plurality of action items. In addition, the one or more processors may cause a display of details relating to the first project on one or more community boards.

In another embodiment, the method of voting on one or more projects may include: receiving via one or more processors at least a first project; presenting via the one or more processors the first project to a voting community; receiving via the one or more processors one or more votes relating to the first project from one or more members of the voting community; and/or determining via the one or more processors a status of the first project based on the received votes.

In another example, the first project may have been submitted by an internal company source, a customer of a company, and/or a third party source. Further, the first project may be determined and/or screened by comparing a first project details to one or more criteria. In addition, the method may further include generating a first project condition for the first project. In another example, the first project condition may be that the first project is approved to move to a funding stage. The method may include generating a second project condition for the first project.

In another embodiment, the system for funding on one or more projects may include one or more memory devices and one or more processors. The one or more processors may receive at least a first project; present the first project to a funding community; receive one or more funding pledges relating to the first project from one or more members of the funding community; and/or determine a status of the first project based on the received pledged funds.

In another example, the first project may be submitted by an internal company source, a customer of a company, and/or a third party source. In addition, the first project may be determined and/or screened by comparing a first project details to one or more criteria. Further, the one or more processors may generate a first project condition for the first project where the first project condition may be that the first project is approved to move to a implementation stage. In addition, the one or more processors may generate a second project condition for the first project where the second project condition may be that the first project is completed. In another example, the one or more processors may generate a third project condition for the first project where the third project condition may be that the first project has been rejected. In addition, the one or more processors may generate a fourth project condition for the first project where the fourth project condition may be that the first project is still pending and/or active. In another example, the one or more processors may generate an action plan based on a first project funding approval where the action plan has a plurality of action items. In addition, the one or more processors may cause a display of details relating to the first project on one or more community boards.

In another example, the method of funding on one or more projects may include: receiving via one or more processors at least a first project; presenting via the one or more processors the first project to a funding community; receiving via the one or more processors one or more funding pledges relating to the first project from one or more members of the funding community; and/or determining via the one or more processors a status of the first project based on the received funding pledges.

Further, the first project may be submitted by an internal company source, a customer of a company, and/or a third party source. In addition, the first project may be determined and/or screened by comparing a first project details to one or more criteria. In addition, the method may include generating a first project condition for the first project where the first project condition may be that the first project is approved to move to an implementation phase. In one example, the method may further include comprising generating a second project condition for the first project.

In another embodiment, the system, device, and/or method for funding one or more projects may include one or more processors configured to receive a first project characteristics, where the one or more processors are configured to communicate the first project characteristics to a plurality of entities to obtain funding for the first project where the funding is a predetermined dollar amount, the processors may be further configured to receive funding pledges from the plurality of entities which creates a first project pledging amount during a first period of time, and the processors further configured to determine a status of the first project based on a comparison of the total first project funding pledges versus the predetermined dollar amount and the processors configured to determine a first project approval status based on the first project funding pledges being greater than the predetermined dollar amount (e.g., fully funded and approved). In addition, the first project approval status may be denied based on the first project funding pledges being less than the predetermined dollar amount. Further, the project status may be active and/or pending if the first project funding pledges are less than the predetermined dollar amount but the funding period has not expired. In addition, once a project has been funded and/or approved, an action plan detailing the steps necessary to complete the product, device, service, and/or game may be created. Further, if the funding pledges excess the predetermined dollar amount, then new features may be added and/or excess funds may be returned to the pledgers. In addition, all non-funded projects may be achieved, reformulated, resubmitted, and/or combined with other projects.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples. While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed. Further, one or more options may be Internet based options. Therefore, all of the examples and/or embodiments may be utilized via an Internet based system.

1. A system for providing game play comprising:
a first gaming platform;
a second gaming platform; and
an interface module configured to allow an implementation of a game via the first gaming platform and the second gaming platform.

2. The system of claim 1, wherein the first gaming platform utilizes a first operating system and the second gaming platform utilizes a second operating system.

3. The system of claim 1, wherein the interface module is configured to allow a first player on the first gaming platform to communication with a second player on the second gaming platform.

4. The system of claim 1, wherein the interface module is configured to allow a first player on the first gaming platform to form a relationship with a second player on the second gaming platform.

5. The system of claim 1, wherein the interface module is configured to allow a first player on the first gaming platform to trade with a second player on the second gaming platform.

6. The system of claim 1, wherein the interface module is configured to allow a first player on the first gaming platform to form a party with a second player on the second gaming platform.

7. The system of claim 1, further comprising a third gaming platform where the interface module is configured to allow the implementation of the game via the first gaming platform, the second gaming platform, and the third gaming platform.

8. The system of claim 7, wherein the third gaming platform utilizes a third operating system.

9. The system of claim 7, wherein the interface module is configured to allow a first player on the first gaming platform to communication with a second player on the second gaming platform and a third player on the third gaming platform.

10. The system of claim 7, further comprising a fourth gaming platform where the interface module is configured to allow the implementation of the game via the first gaming platform, the second gaming platform, the third gaming platform, and the fourth gaming platform.

11. The system of claim 10, wherein the fourth gaming platform utilizes a fourth operating system.

12. The system of claim 10, wherein the interface module is configured to allow a first player on the first gaming platform to communication with a second player on the second gaming platform, a third player on the third gaming platform, and a fourth player on the fourth gaming platform.

13. The system of claim 10, wherein the first gaming system is a first console type, the second gaming system is a second console type, the third gaming system is a desktop computer, and the fourth gaming system is a mobile device.

14. The system of claim 10, wherein the interface module is configured to generate a master leaderboard for the first gaming platform, the second gaming platform, the third gaming platform, and the fourth gaming platform.

15. The system of claim 10, wherein the interface module is configured to generate at least one of a first gaming platform leaderboard, a second gaming platform leaderboard, a third gaming platform leaderboard, and a fourth platform leaderboard.

16. The system of claim 1, wherein the interface module is configured to allow a first player to stop game play on the first gaming platform at a first stage and start game play on the second gaming platform at the first stage.

17. The system of claim 1, wherein the interface module is configured to implement a match skills function.

18. The system of claim 17, wherein the match skills function allows a first player to search for other players with a skill level.

19. The system of claim 17, wherein the match skills function allows a first player to search for other players with a skill level range.

20. The system of claim 1, wherein the interface module is configured to implement an auto downloading function for at least one of the first gaming platform and the second gaming platform.

21. The system of claim 1, further comprising an influence platform where the influence platform is configured to allow community members to vote or fund one or more projects for one or more platforms.
